(19) United States
(12) Patent Application Publication
(10) Pub. No.: US 2012/0200018 A1
(43) Pub. Date: Aug. 9, 2012

(54) DEVICE, SYSTEM, AND METHOD OF INJECTED PADDING

(75) Inventors: Haggai Paz, Zoran (IL); Menahem Tzor, Karmiel (IL); Rimon Ben Dor, Carmiel Post (IL)

(73) Assignee: KETER PLASTIC LTD, HERZLIA (IL)

(21) Appl. No.: 13/393,576

(22) PCT Filed: Sep. 2, 2010
(86) PCT No.: PCT/IB10/53955

§ 371 Date: Apr. 25, 2012

Related U.S. Application Data
(60) Provisional application No. 61/272,231, filed on Sep. 3, 2009.

(51) Int. Cl. F16F 3/04; F16F 1/08; B29C 45/16; B29C 45/00; B29C 45/17

(52) U.S. Cl. 267/94; 264/328.1; 264/255; 267/166.1; 267/91

(57) ABSTRACT

Device, system, and method of injected padding. A seating assembly comprises: a support surface associated with an assembly base via at least partially two or more injection molded elastic elements; wherein said elastic elements are composed of a raw plastic material; wherein said two or more elastic elements are formed concurrently as part of a single injection molding.

### FIELD

Some embodiments are related to the field of injection molding.

### BACKGROUND

Various types of pillows, cushions, mattresses and other padded layers are used as intermediary layer between a person and a rigid surface. Such intermediary items are typically manufactured using a soft material, for example, sponge materials and/or woven textile. Optionally, a set of springs may be used, in order to provide additional support, as common in spring-based mattresses.

Unfortunately, the production of such intermediary items may be expensive and/or effort consuming, for example, due to the required weaving and other manufacturing operations. Furthermore, intermediary items or layers which incorporate textile and/or sponge, may provide a flexible and convenient user experience, but may be non-durable to environmental conditions, e.g., moisture, rain, snow, humidity, sunlight, or the like.

### SUMMARY

Some embodiments include, for example, devices, systems, and methods of injected padding.

In some embodiments, a seating assembly comprises: a support surface associated with an assembly base via at least partially two or more injection molded elastic elements, wherein said elastic elements are composed of a raw plastic material, wherein said two or more elastic elements are formed concurrently as part of a single injection molding.

In some embodiments, said two or more elastic elements comprise an array of one or more raw plastic materials.

In some embodiments, the seating assembly further comprises: stabilizing members connected to at least some of the elastic elements adapted to reduce angular disposition of said elastic elements upon application of pressure thereon.

In some embodiments, the stabilizing members comprise injected molding members.

In some embodiments, the elastic elements are interconnected by a flexible injected joint.

In some embodiments, a seating assembly comprises: a support surface associated with an assembly base via at least partially two or more injection molded elastic elements, wherein said elastic elements are composed of a raw plastic material, wherein said one or more elastic elements is formed substantially concurrently with the support surface.

In some embodiments, said elastic elements are threads of injected plastic material.

In some embodiments, said threads are intertwined.

In some embodiments, the seating assembly comprises: a wrapping comprised of one or more of the following: injection molding of one or more raw plastics, fabric, leather, fabric imitation.

In some embodiments, a seating assembly comprises: a support surface associated with an assembly base via at least partially two or more injection molded elastic elements, wherein said elastic elements are composed of a raw plastic material, wherein said one or more elastic elements are formed substantially concurrently with the base.

In some embodiments, said elastic element is generally shaped as a chopped frustum.

In some embodiments, the elastic element is at least partially nestable within another, substantially identical, elastic element.

In some embodiments, said elastic elements are threads of injected plastic material.

In some embodiments, said threads are intertwined.

In some embodiments, the seating assembly further comprises: a wrapping comprised of one or more of the following: injection molding of one or more raw plastics, fabric, leather, fabric imitation.

In some embodiments, an apparatus comprises: a spring formed by injected molding of one or more raw plastic materials.

In some embodiments, the spring is generally shaped as a chopped frustum, and the spring is able to eject from a manufacturing mold by utilizing an elasticity of the spring.

In some embodiments, the spring comprises two or more injected threads spiraling from a common injected base upwardly towards a spring apex.

In some embodiments, the one or more injected threads have a cross-section selected from the group consisting of: “L”-shaped cross-section; “U”-shaped cross section; “V”-shaped cross section.

In some embodiments, the spring comprises one or more injected members rising vertically from a common injected base upwardly towards a spring apex.

In some embodiments, the spring comprises a single injected thread spiraling from a circular injected base upwardly towards a circular spring apex.

In some embodiments, the spring is at least partially nestable within another, substantially identical, spring.

In some embodiments, the apparatus comprises a matrix of injected springs arranged in rows.

In some embodiments, the matrix of injected springs comprises a padding for a furniture article.

In some embodiments, a padding comprises: an array of flexible members formed of injection molding of one or more raw plastic materials.

In some embodiments, the flexible members comprise flexible injected prism-shaped protrusions rising from a common flexible injected tray.

In some embodiments, the padding further comprises: stabilizing members connected to at least some of the flexible members, to reduce angular disposition of said flexible members upon application of pressure thereon.

In some embodiments, the stabilizing members comprise injected molding members supporting the flexible members.

In some embodiments, the stabilizing members comprise another set of flexible members supporting said flexible members.

In some embodiments, the stabilizing members comprise another set of flexible members attached back-to-back with said flexible members, facing opposite directions.

In some embodiments, the flexible members comprise flexible injected curve-shaped members forming a sinusoidal pattern.

In some embodiments, at least two adjacent flexible members are interconnected by a flexible injected joint.

In some embodiments, the padding comprise: another array of flexible members facing and interlocking said array of flexible members.

In some embodiments, the padding further comprises: a padding layer comprises one or more flexible threads of injected raw plastic material, wherein the one or more threads are intertwined.

In some embodiments, the padding comprises: a flexible cover; a rigid base; a locking element to lock said array between the flexible cover and the rigid base.

In some embodiments, the flexible cover is formed by injection molding of one or more raw plastic materials.

In some embodiments, the flexible cover is fibrous and comprises fibers formed by injection molding of one or more raw plastic materials.

In some embodiments, a method comprises: injection molding of a raw plastic material, to produce an article comprising a fabric-like surface and a plurality of flexible pins protruding therefrom; wherein the injection molding is performed by utilizing a generally cylindrical mold having a channel engraved on its external surface, into said channel the raw plastic material is injected; wherein the integrated article is able to eject from the mold, at least partially, by utilizing an elasticity property of said article to temporarily expend and overcome one or more undercuts of the mold.

In some embodiments, the method comprises: connecting the apexes of said pins to a common element, to eliminate side movement of said pins upon application of pressure thereon.

In some embodiments, the common element comprises an element selected from the group consisting of: a perforated foil; a net; a perforated surface.

In some embodiments, a method comprises: injection molding of a raw plastic material to produce a padding article which comprises a relatively flexible cover portion, an intermediary layer able to absorb pressure, and a relatively rigid base portion.

In some embodiments, the injection molding comprises a single injection molding process.

In some embodiments, the injection molding comprises a double injection molding process, which comprises: (a) injecting the base portion; (b) placing the intermediary layer on the base portion; (c) compressing the intermediary layer; (d) injecting the cover portion together with welding edges of the padding article; (e) allowing the intermediary layer, trapped between the base portion welded to the cover portion, to gradually decompressed.

In some embodiments, the method comprises, after step (b) and before step (c): masking the intermediary layer to block entry of injected plastic material into cavities of the intermediary layer.

In some embodiments, the intermediary layer comprises Polyurethane foam.

In some embodiments, the method comprises: producing by injection molding a surface having fabric-like texture.

In some embodiments, the fabric-like texture is fibrous.

In some embodiments, the method comprises: producing by injection molding a surface having fabric-like texture with a fabric-like imprinted item thereon.

In some embodiments, a method comprises: producing a padded article in an injection molding process which utilizes Polyurethane foam, wherein a welding line of the padded article is produced concurrently with the injection molding and by the injection molding.

In some embodiments, the injection molding process is to produce an inwardly-folding edge of the padded article.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic illustration of an injected plastic spring, in accordance with some demonstrative embodiments.

FIG. 2 is a schematic illustration of an injected plastic spring, in accordance with some demonstrative embodiments.

FIG. 3 is a schematic top-view illustration of an injected plastic spring, in accordance with some demonstrative embodiments.

FIG. 4A is a schematic top-view illustration of an injected plastic spring, in accordance with some demonstrative embodiments.

FIG. 4B is a schematic illustration of three cross-sections of a joint, in accordance with some demonstrative embodiments.

FIGS. 4C and 4D are schematic illustrations of representations of forces applied on a spring, in accordance with some demonstrative embodiments.

FIG. 5 is a schematic top-view illustration of an injected plastic spring, in accordance with some demonstrative embodiments.

FIG. 6 is a schematic illustration of an injected plastic spring, in accordance with some demonstrative embodiments.

FIG. 7 is a schematic illustration of an injected plastic spring, in accordance with some demonstrative embodiments.

FIG. 8A is a schematic illustration of an injected plastic spring, in accordance with some demonstrative embodiments.

FIG. 8B is a schematic illustration of six cross-sections of a leg or supporting member of a spring, in accordance with some demonstrative embodiments.

FIG. 8C is a schematic illustration of three states in a process of ejecting an injection molding part (e.g., a spring, or a leg or member of a spring, or a net of spring) from a mold or a template, in accordance with some demonstrative embodiments.

FIG. 9A is a schematic illustration of an injected plastic spring, in accordance with some demonstrative embodiments.

FIG. 9B is a schematic illustration of an injected plastic spring, in accordance with some demonstrative embodiments.

FIG. 10 is a schematic illustration of an injected plastic spring, in accordance with some demonstrative embodiments.

FIG. 11 is a schematic illustration of an injected plastic spring, in accordance with some demonstrative embodiments.

FIG. 12 is a schematic illustration of an injected plastic spring, in accordance with some demonstrative embodiments.

FIG. 13 is a schematic illustration of an injected plastic spring, in accordance with some demonstrative embodiments.

FIG. 14A is a schematic illustration of an injected plastic spring, in accordance with some demonstrative embodiments.

FIGS. 14B and 14C are schematic top-view illustrations of springs demonstrating repetition of legs or other supporting members, in accordance with some demonstrative embodiments.

FIG. 14D is a schematic side-view illustration of a supporting member of a spring, in accordance with some demonstrative embodiments.

FIG. 15 is a schematic illustration of an injected plastic net, in accordance with some demonstrative embodiments.

FIG. 16 is a schematic illustration of an injected plastic net, in accordance with some demonstrative embodiments.

FIG. 16B is a schematic illustration of expansion of springs along an X-axis and a Y-axis, in accordance with some demonstrative embodiments.

FIG. 16C is a schematic illustration of a joint connecting two adjacent springs, in accordance with some demonstrative embodiments.

FIG. 16D is a schematic illustration of a ball joint, in accordance with some demonstrative embodiments.

FIG. 16E is a schematic illustration of an oval joint, in accordance with some demonstrative embodiments.

FIG. 16F is a schematic illustration of a hinge joint, in accordance with some demonstrative embodiments.

FIG. 17 is a schematic top-view illustration of an injected plastic net, in accordance with some demonstrative embodiments.

FIG. 18 is a schematic top-view illustration of an injected plastic net, in accordance with some demonstrative embodiments.

FIG. 19A is a schematic illustration of an injected plastic spring, in accordance with some demonstrative embodiments.

FIG. 19B is a schematic illustration of dimensions associated with sections, in accordance with some demonstrative embodiments.

FIG. 20A is a schematic illustration of an injected plastic spring, in accordance with some demonstrative embodiments.

FIG. 20B is a schematic illustration of a top view of an apex of a spring, in accordance with some demonstrative embodiments.

FIG. 20C is a schematic illustration of a side view of a spring, in accordance with some demonstrative embodiments.

FIG. 21 is a schematic illustration of an injected plastic spring, in accordance with some demonstrative embodiments.

FIG. 22A is a schematic illustration of an injected plastic spring, in accordance with some demonstrative embodiments.

FIG. 22B is a schematic illustration of a side-view of a supporting member, in accordance with some demonstrative embodiments.

FIG. 23 is a schematic illustration of an injected plastic spring, in accordance with some demonstrative embodiments.

FIG. 24 is a schematic illustration of two injected plastic springs, in accordance with some demonstrative embodiments.

FIG. 25 is a schematic illustration of a padding, in accordance with some demonstrative embodiments.

FIG. 26 is a schematic illustration of another view of a padding, in accordance with some demonstrative embodiments.

FIG. 27 is a schematic illustration of four demonstrative positions of a set of injection molding springs, in accordance with some demonstrative embodiments.

FIG. 28A is a schematic illustration of a padding, in accordance with some demonstrative embodiments.

FIG. 28B is a schematic illustration of a top view of padding, demonstrating edge formulation which follows a non-linear edge, in accordance with some demonstrative embodiments.

FIG. 29 is a schematic illustration of a padding and a chair, in accordance with some demonstrative embodiments.

FIG. 30 is a schematic illustration of a furniture article, in accordance with some demonstrative embodiments.

FIG. 31 is a schematic illustration of a portion of a furniture article, in accordance with some demonstrative embodiments.

FIG. 32 is a schematic illustration of side views of three padding units, in accordance with some demonstrative embodiments.

FIG. 33 is a schematic illustration of perspective views of three padding units, in accordance with some demonstrative embodiments.

FIG. 34 is a schematic illustration of a padding and a plastic chair, in accordance with some demonstrative embodiments.

FIG. 35 is a schematic illustration of a padding and a wooden chair, in accordance with some demonstrative embodiments.

FIG. 36 is a schematic illustration of an armchair, in accordance with some demonstrative embodiments.

FIG. 37 is a schematic illustration of a sofa, in accordance with some demonstrative embodiments.

FIG. 38 is a schematic illustration of a sunbed (or sun bed or tan bed), in accordance with some demonstrative embodiments.

FIG. 39 is a schematic side-view illustration of a padding, in accordance with some demonstrative embodiments.

FIG. 40 is a schematic side-view illustration of a padding, in accordance with some demonstrative embodiments.

FIG. 41 is a schematic side-view illustration of a padding, in accordance with some demonstrative embodiments.

FIG. 42 is a schematic side-view illustration of a padding, in accordance with some demonstrative embodiments.

FIG. 43 is a schematic side-view illustration of a padding, in accordance with some demonstrative embodiments.

FIG. 44 is a schematic side-view illustration of a padding, in accordance with some demonstrative embodiments.

FIG. 45A is a schematic side-view illustration of a padding, in accordance with some demonstrative embodiments.

FIG. 45B is a schematic illustration of an external joint or external welding arrangement, in accordance with some demonstrative embodiments.

FIG. 45C is a schematic illustration of an internal joint or internal welding arrangement, in accordance with some demonstrative embodiments.

FIG. 46 is a schematic exploded bottom-view illustration of a padding, in accordance with some demonstrative embodiments.

FIG. 47 is a schematic exploded top-view illustration of a padding, in accordance with some demonstrative embodiments.

FIG. 48 is a schematic exploded illustration of a padding, in accordance with some demonstrative embodiments.

FIG. 49 is a schematic exploded illustration of a padding, in accordance with some demonstrative embodiments.

FIG. 50 is a schematic exploded illustration of a padding, in accordance with some demonstrative embodiments.

FIG. 51 is a schematic exploded illustration of a padding, in accordance with some demonstrative embodiments.

FIG. 52 is a schematic exploded illustration of a padding, in accordance with some demonstrative embodiments.

FIG. 53 is a schematic exploded illustration of a padding, in accordance with some demonstrative embodiments.

FIG. 54 is a schematic exploded illustration of a padding, in accordance with some demonstrative embodiments.

FIG. 55 is a schematic exploded illustration of a padding, in accordance with some demonstrative embodiments.

FIG. 56 is a schematic exploded illustration of a padding, in accordance with some demonstrative embodiments.

FIGS. 57-59 are schematic illustrations of a padding, in accordance with some demonstrative embodiments.

FIG. 60 is a schematic exploded illustration of a padding, in accordance with some demonstrative embodiments.

FIG. 61 is a schematic side-view illustration of a portion of a padding, in accordance with some demonstrative embodiments.

FIG. 62 is a schematic side-view illustration of a portion of a padding, in accordance with some demonstrative embodiments.

FIG. 63 is a schematic side-view illustration of a portion of a padding, in accordance with some demonstrative embodiments.

FIG. 64 is a schematic side-view illustration of a portion of a padding, in accordance with some demonstrative embodiments.

FIG. 65 is a schematic perspective illustration of a portion of padding, in accordance with some demonstrative embodiments.

FIGS. 66-68 are schematic side-view illustrations of a set of injection molding springs, in accordance with some demonstrative embodiments.

FIG. 69 is a schematic side-view illustration of a portion of a padding, in accordance with some demonstrative embodiments.

FIG. 70 is a schematic side-view illustration of a portion of a padding, in accordance with some demonstrative embodiments.

FIG. 71 is a schematic perspective illustration of a padding, in accordance with some demonstrative embodiments.

FIGS. 72 and 73 are schematic side-view illustrations of a padding, in accordance with some demonstrative embodiments.

FIGS. 74 and 75 are schematic side-view illustrations of a padding, in accordance with some demonstrative embodiments.

FIGS. 76 and 77 are schematic side-view illustrations of a padding, in accordance with some demonstrative embodiments.

FIG. 78 is a schematic illustration of a padding, in accordance with some demonstrative embodiments.

FIG. 79 is a schematic illustration of a padding, in accordance with some demonstrative embodiments.

FIG. 80 is a schematic side-view illustration of a padding, in accordance with some demonstrative embodiments.

FIG. 81 is a schematic exploded illustration of a padding, in accordance with some demonstrative embodiments.

FIGS. 82-86A are schematic illustrations of connection mechanisms, in accordance with some demonstrative embodiments.

FIG. 86B is a schematic illustration of padding having a welt line, in accordance with some embodiments.

FIGS. 86C and 86D are schematic illustrations of external portions of a padding, in accordance with some embodiments.

FIG. 87 is a schematic illustration of a portion of a padding, in accordance with some demonstrative embodiments.

FIG. 88 is a schematic illustration of a portion of a padding, in accordance with some demonstrative embodiments.

FIG. 89 is a schematic illustration of an application of pressure onto a padding layer, in accordance with some demonstrative embodiments.

FIG. 90 is a schematic illustration of an enlarged portion of a padding layer, in accordance with some demonstrative embodiments.

FIG. 91 is a schematic illustration of an injected plastic spring, in accordance with some demonstrative embodiments.

FIG. 92 is a schematic illustration of an injected plastic spring, in accordance with some demonstrative embodiments.

FIG. 93 is a schematic illustration of four stages in the manufacturing of an injected plastic padding, in accordance with some demonstrative embodiments.

FIG. 94A is a schematic illustration of a portion of a spring net, in accordance with some demonstrative embodiments.

FIG. 94B is a schematic illustration of a side-view of an assembly of two spring-nets positioned face-to-face, in accordance with some demonstrative embodiments.

FIG. 94C is a schematic illustration of a side-view of an assembly of two spring nets, utilizing a spring net, in accordance with some demonstrative embodiments.

FIGS. 94D-94G are schematic illustrations of nets for locking and/or centralizing purposes, in accordance with some demonstrative embodiments.

FIG. 95 is a schematic illustration of a spring net, in accordance with some demonstrative embodiments.

FIG. 96 is a schematic illustration of a spring net, in accordance with some demonstrative embodiments.

FIG. 97 is a schematic illustration of a spring net, in accordance with some demonstrative embodiments.

FIG. 98 is a schematic illustration of a diagram representing the rotation, mirroring and/or criss-cross pattern of springs in a spring net, in accordance with some demonstrative embodiments.

FIG. 99A is a schematic illustration of a spring, in accordance with some demonstrative embodiments.

FIG. 99B is a schematic illustration of a spring, in accordance with some demonstrative embodiments

FIG. 100 is a schematic illustration of a storage stool (or storage chest, or storage box) in a closed position, in accordance with some demonstrative embodiments.

FIG. 101A is a schematic illustration of a storage stool (or storage chest, or storage box) in an open position, in accordance with some demonstrative embodiments.

FIG. 101B is a schematic illustration of an injected, soft-padding, cover of a storage stool, in accordance with some demonstrative embodiments.

FIG. 101C is a schematic illustration of a cross section of the cover on top of padding, in accordance with some demonstrative embodiments.

FIG. 102 is a schematic illustration of an injection molding spring wrapped around a generally conical mold, in accordance with some demonstrative embodiments.

FIGS. 103A and 103B are schematic illustrations of two states of an injection molding spring and a generally conical mold, in accordance with some demonstrative embodiments.

FIG. 104 is a schematic illustration of a net of springs wrapped around a mold of multiple conical pins having slits or channels milled or grooved thereon, in accordance with some embodiments.

FIG. 105 is a schematic illustration of a net of injected molding springs connected to an injected molding fabric-imitation, in accordance with some embodiments.

FIGS. 106A-106C are schematic illustrations demonstrating three states in a process of ejecting a spring (or a spring net) from a mold, in accordance with some demonstrative embodiments.

FIG. 107 is a schematic illustration of a spring, in accordance with some demonstrative embodiments.

FIG. 108 is a schematic illustration of a spring, in accordance with some demonstrative embodiments.

FIG. 109 is a schematic illustration of a spring, in accordance with some demonstrative embodiments.

FIGS. 110-116 are schematic illustrations of springs, in accordance with some demonstrative embodiments.

FIG. 117 is a schematic illustration of an injection molding spring wrapped around a conical pin or mold, in accordance with some demonstrative embodiments.

FIG. 118 is a schematic illustration of an injection molding spring, without the conical mold or template, in accordance with some demonstrative embodiments.

FIG. 119 is a schematic illustration of an injected molding spring, shaped as a net of a basketball hoop, in accordance with some embodiments.

FIG. 120 is a schematic illustration of a collapsible mold, in accordance with some embodiments.

FIG. 121 is a schematic illustration of a bridge-like structure formed by injection molding of raw plastic material(s), in accordance with some demonstrative embodiments.

FIG. 122 is a schematic illustration of a multi-level spring formed by injection molding of raw plastic material(s), in accordance with some demonstrative embodiments.

FIG. 123 is a schematic illustration of a support structure formed by injection molding of raw plastic material(s), in accordance with some demonstrative embodiments.

FIG. 124 is a schematic illustration of a support structure formed by injection molding of raw plastic material(s), in accordance with some demonstrative embodiments.

FIG. 125 is a schematic illustration of a support structure formed by injection molding of raw plastic material(s), in accordance with some demonstrative embodiments.

FIG. 126 is a schematic illustration of a side-view of a support structure relative to a conical pin which may be used as a mold, in accordance with some demonstrative embodiments.

FIG. 127 is a schematic illustration of three alternate sections of a leg or supporting member, in accordance with some embodiments.

FIG. 128 is a schematic illustration of a multi-level leg, in accordance with some demonstrative embodiments.

FIG. 129 is a schematic illustration of a top-view of a support structure, in accordance with some demonstrative embodiments.

FIGS. 130A and 130B are schematic illustrations of a perspective view and a top view, respectively, of a set of springs, in accordance with some embodiments.

FIG. 131 is a schematic illustration of a set of springs in which spring orientation is modified among springs, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Although portions of the discussion herein, and/or portions of the Figures, may relate to a pressure vector directed downwards (namely, vertically from top to bottom), it is clarified that such pressure vector is only demonstrative, and some embodiments may be used in conjunction with other types of pressure vectors, for example, a horizontal pressure vector (e.g., as a back-rest of a chair), a diagonal pressure vector (e.g., as a back-rest of a porch bed), a non-vertical pressure vector, or the like.

Although portions of the discussion herein may relate, for demonstrative purposes, to various levels of “softness” which may be achieved, some embodiments may be utilized in order to achieve various levels of “rigidness” or “rigidity” in a similar manner. Some embodiments may be directed to a generally-soft or a relatively soft product (e.g., a soft cushion); whereas other embodiments may be directed to a less-soft product or a more rigid product, for example, a rigid or relatively-rigid chair having a fiber touch or a textile-like touch or a fabric-like touch (e.g., by increasing wall thickness and/or the amount of additive and/or nonwoven foil, as discussed herein). In some embodiments, rigidity or rigidness may be modified or adapted, similar to the modification or adaptation of softness levels.

It is clarified that Figures which show images, photographs and/or drawings which include items that appear to be fabric or textile, actually depict non-fabric and non-textile; actually depict non-woven materials and elements; actually depict injection-based materials and elements, injected materials and elements, units formed of plastic and/or polypropylene (PP) and/or thermoplastic elastomer (TPE) and/or thermoplastic polymer(s); and actually depict injected, non-woven, fabric-like and textile-like materials and elements.

Some embodiments include systems, devices, methods and processes of injected or injection-based items or materials, which are durable yet, may resemble fabric, textile, or cloth. Such items or materials may be non-woven, and may be used in a variety of applications, for example, in the context of padding, lining, upholstery, stuffing, pillows or cushions, covers, as panels or top panel or side panel for boxes, as panels or top panel or side panel for storage boxes, as covers for indoor furniture or outdoor furniture, as part of indoor furniture or outdoor furniture, or the like.

Some embodiments include intermediary layers and/or items which may provide the ergonomic resistance required as a reaction to the pressure of a human body, as well as a user-friendly feeling of softness and gentleness. Some embodiments may provide sponge-less layers and items, as well as non-woven products and items, which in turn may be based on injection technology. The resulting products and layers may have characteristics that are different from a sponge layer or product, namely, they are not necessarily soft (or, they are less soft than a sponge), and they do not rapidly return to their original position or form after an applied pressure is removed.

In some embodiments, the process may include injection which includes a foam (e.g., polyurethane sponge) locked internally to semi-rigid elements; for example, some embodiments may include a polypropylene layer, having above it a sponge and on top of it another soft layer which may be fabric-like. Some embodiments may lock the sponge while injecting on it, such that a stitching line is one material which may be “glued” to its surrounding and to the inner filling between the layers. Some embodiments may avoid a result in which, when injecting on polyurethane foam, the injected material tends to enter the small air bubbles inside the sponge (namely, the gaps of air) and to fill them with plastic. For example, some embodiments may utilize an additional layer to block the plastic (such as, another plastic film, e.g., cellophane) by wrapping the sponge before injecting on it.

Some embodiments may utilize one or more materials, for example: Sponge, which may include Polyurethane foam with different degrees of stiffness. Stiffness may be controlled by the ratio between the type and volume mixture of polymer and the amount of gas or air within the internal gaps. Together with a fabric cover, it generates a combination which is soft to touch and comfortable to seat or lean on. PU foam may be manufactured by chemical reaction of polymer, when the outcome is a block containing about 80% of its volume air. The polymer is randomly constructed, resulting non-consistent chains. The flexibility of the chains allows pointed pressure to deform the polymer chains without affecting the rest of the surface. This makes it a soft and adaptable support to different parts of human body, regardless of their shape. When coating the PU foam with fabric, a stretching and softening quality is added to the sponge, making it more appealing to human eye and touch.

Some embodiments may use sponge, due to the benefits of injected external padding; namely, the external surface of the padding is weather resistant, and therefore a coating is achieved that serves the products better. The sponge is therefore protected better, unexposed to humidity and sun. This coating with injected “Fabric Like” material may help to achieve longer product lifecycle; and for itself the coating may be recycled, since it is made of recyclable materials. The sponge may be used again, and/or less PU foam may be consumed due to the extension of its lifecycle. Therefore, even though PU by itself may be less environment-friendly, the specific utilization of PU in some embodiments may eliminate or reduce the environmental implications which may be associated with some uses of PU.

Similarly, other materials which may be used in some embodiments, which are not recyclable, may be treated as disposable. For example, Fabric may be disposable. Therefore, some embodiments may support the environment and recycling, but may only eliminate the environmental effects of the specific technologies which are used.

Some embodiments may include products which are formed, substantially exclusively, of injected materials and/or injection-based materials. Other embodiments may include products which are formed of a combination of injected materials and/or injection-based materials, together with other, non-injected materials, elements, or units. Such elements may include, for example, fabric, textile, woven materials, non-injected nonwoven materials (e.g., based on extrusion), padded constructive elements, padding elements, sponges, wood, metal(s), fibers, foams, stitched elements, elements which may provide softness and/or rigidness properties, elements which may provide coloring and/or imprinting, stitching lines, curvature-providing elements, supporting elements, or the like.

Some embodiments provide nest-able and/or stack-able products and/or components, allowing efficient nesting and/or stacking of multiple units, one unit entering partially or almost entirely within another unit. This may allow significant reduction in storage space and/or shipping space required for multiple units, as well as reduction in storage costs and/or shipping costs, particularly relative to sponge-based products or units, or relative to foamed or foam-based products or units. In some embodiments, the efficient shipping of more products may eliminate or reduce indirect environmental problem rising for the need of more PU factories and/or more shipping pollutions.

Some embodiments include a multi-part product, for example, a triple-part product which may include, for example, a base unit, a cover unit, and a spring mechanism between the base unit and the cover unit.

The term “cover unit” as used herein may relate to an outer surface which comes in contact to human body; or, it may relate to the seating element and/or the back element which hides the suspension system. Some embodiments may distinguish the cover because it has the final touch with the human body, and not necessarily because it covers something within or underneath it. Some embodiments may utilize a single injected part to perform some or all functions, for example, outer texture and/or fabric imitation, and lower portion supported with “springs on fabric” which utilizes the same material for both (or other) purposes.

In some embodiments, the base unit may include, for example, a base, a basis, or other foundation, which may be an injection-based or injected layer. In some embodiments, the base unit may be implemented as an injected net of springs, or as a net of injected springs.

In some embodiments, the cover unit may include a cover, a lid, or other top unit, which may be injected or injection-based, and optionally may include, or may be produced from, recyclable materials and/or thermoplastic materials; while still providing a user-friendly feeling of softness and gentleness, and while providing a resemblance to natural materials.

In some embodiments, the spring mechanism may be injected or injection-based, and optionally may include, or may be produced from, recyclable materials and/or thermoplastic materials.

In some embodiments, utilization of injected materials or units, or injection-based materials or units, may provide durability and/or resistance to various environmental conditions, for example, weather conditions, rain, snow, wind, hail, moisture, humidity, sunshine, dryness, ultra-violet (UV) light or radiation, or the like. In some embodiments, the materials used may be materials which substantially do not absorb water or liquids, and/or materials which do not cause the user to sweat upon lengthy sitting thereon. In some embodiments, the materials used and/or the products produced may be, partially or entirely, water-resistant and/or may not soak water or liquid (e.g., in contrast with sponge or expanded polyurethane (PU)), non-aggregating and non-accumulating liquid drops (e.g., water drops, rain drops), liquid-resistant, fire-resistant, non-toxic upon burning, non-absorbing bad odors, stain-resistant, easy to clean, easy to wipe or dust, quick-drying, and/or wrinkle-free.

In some embodiments, a padded product may include multiple elements or multiple features, for example, six features.

First, a fabric-like or textile-like texture may be on the top external portion of the padded product, providing the user with feeling of softness resembling that of fabric or textile, and optionally having coloring and/or imprinting similar to those found on fabrics or on textile products.

Second, an optional shock absorber layer may provide initial shock absorption, and may provide softness upon light pressure by the user. In some embodiments, for example, a combination of two types of spring nets may be used for shock absorbing: one layer (e.g., a top layer) which may be very soft, by having springs of higher resolution, thereby providing a flexible touch to the user who examines the material as well as a soft feeling upon sitting; and another layer (e.g., a bottom layer) which may be less soft or less flexible, utilizing a lower-resolution spring net, thereby providing ergonomic functions as well as support and resistance to the whole body pressure. In contrast with conventional polyurethane foam, which may be either too soft or too rigid when used as a single layer, some embodiments may utilize a double-layer shock absorbent which provides ergonomic features, support and resistance, as well as soft and user-friendly feeling upon hand touch or sitting.

Third, an intermediate layer, mattress-like or sponge-like, optionally injection-based and/or spring-based, provides the main support to external forces and pressures, and fits the lower (rigid) surface. The; intermediate layer may have particular resolution, for example, high resolution allowing the intermediate layer to respond consistently across the entire area to strong pressures and to weak pressures.

Fourth, a stitching or connection method; in some embodiments (e.g., if the product is a padded seat or a cushion), the stitching is of two fabric-like textures which trap the intermediate layer therein; in other embodiments (e.g., if the product is a padded panel of a storage box), the texture may be affixed to a rigid frame or surface using bonding, gluing, pins, or other methods. In some embodiments, components of adjacent or non-adjacent layers may be connected or stitched or welded; for example, a first layer may be welded or stitched to a third layer without necessarily being connected to a second, intermediate, layer, or by utilizing holes or apertures or tunnels within the intermediate layer.

Fifth, a rigid or relatively rigid base unit supports the intermediate layer; and may have one plane (e.g., as in a storage box) or multiple planes (e.g., the seat and/or the back may be padded with springs, for example, in a chair, in a sun-tanning bed, or the like).

Sixth, an optional locking mechanism to lock the fabric-like texture to the mattress-like padding or intermediate layer (e.g., injection spring-based) in order to substantially prevent or mitigate their movement relative to each other.

In some embodiments, the manufactured product or layer may be placed on top of a rigid surface, for example, a box, a panel, a chair, a stool, a foot-rest, a sun-bed, a bed, a sofa, an armchair, a bench, a padded bench, a chest, a toy-chest, a storage chest, an ottoman, a storage ottoman, an indoor furniture unit, an outdoor furniture unit, balcony furniture, porch furniture, garden furniture, beach furniture, furniture intended for use on decks or near swimming pools, car seats, vehicle seats, vehicular seats, airplane seats, boat seats, bicycle seats, motorbike seats, padded handles, padded portable storage elements (e.g., a toolbox or a container which allow a user to sit thereon), padded folding chairs (e.g., typically used in a picnic or at seashore or in a garden or yard), padded tools, padded stools or padded storage stool (e.g., for various indoor purposes, for seating and/or tying shoe laces), ladder tops (e.g., optionally allowing a person to work while sitting thereon, for example, to paint ceilings), toilet tops, picture frames, photograph frames, bathtubs, upper or lower portions of a bathtub, carpets, mats, small carpets or mats (e.g., doormats, bathroom mats, restroom mats), ski equipment, ski sledge or snow sledge, airborne gliders, seats intended for use in transportation, or the like. In other embodiments, the manufactured product or layer may be an integrated part or unit which is positioned on top of, or in proximity to, such rigid surface.

In some embodiments, the base unit may include a net of springs which is manufactured using a single injection. The net of springs may be adapted to support the cover unit. The characteristics of the springs, for example, their height, strength, number, density or concentration or resolution (e.g., number of springs per square foot), and/or angular positioning, may be adapted in order to support the pressure obtained from a human body, and in order to provide a user-friendly feeling of general softness while providing adequate support. In some embodiments, the support provided by the springs may be differential and/or varying, for example, in order to provide additional support in areas in which increased body pressure is expected (e.g., a central portion of a bed, or lower back support in a chair which may be ergonomic or orthopedic support to different body pressures), or in order to provide decreased support in areas in which decreased body pressure is expected (e.g., edge areas of a bed). In some embodiments, the level of flexibility or rigidness of the connections among the springs may further be adapted in order to complement an unsmooth rigid surface (e.g., non-padded balcony or patio chairs, or non-padded porch chairs). In some embodiments, the support may be adapted to various types of human pressure, e.g., due to sitting, lying down, leaning, or the like. In some embodiments, the springs may be adapted to provide only minimal support for human pressure, and may be adapted to provide a user-friendly feeling of softness, for example, when used in the context of a panel or a wall of a storage box or a tool-box or a

In some embodiments, the base unit includes multiple, adjacent springs. Each spring may have a pre-defined or particular cone shape or pyramid shape, having a pre-defined or particular cone angle or pyramid angle (e.g., the angle between: a surface of the relatively-wider root or basis of the spring; and a line connecting the edge of that root with the top point or the relatively-narrowest point of the spring). The angle may be adapted or set, in the manufacturing process, in order to allow efficient nesting and/or stacking of multiple units, thereby reducing shipping volumes and storage volumes, as well as shipping costs and storage costs.

In some embodiments, the springs may be designed and adapted to allow efficient and/or simple extraction or removal of the manufactured unit from a manufacturing template or a production line.

In some embodiments, the spatial resolution of the springs, or the density of the springs, or the number of springs per square foot, may be adapted in order to accommodate one or more pressure-points or pressure-areas of a human body which is intended to press on the manufactured unit. The spatial resolution may be calculated or set by taking into account the angle and/or the height of the spring, as well as other spring parameters.

Some embodiments may take into account two or more types of pressures which may be operating on the same spring; for example, a first pressure from the top (e.g., finger pressure) combined with a second pressure from the bottom surface (e.g., the shape of a seat chair) and/or a third pressure from the back (e.g., the shape of the back of an already “padded” chair). The spring may be formed and designed to be sufficiently to withstand different pressures from various directions without losing its ability to support the pressure(s) and return to its original shape after the pressure(s) are removed.

In some embodiments, the springs may be formed of polypropylene (PP) or other suitable thermoplastic polymer or recyclable materials. In some embodiments, the product or significant portions of the product (e.g., a pad, a padding, a seat, a back, a mattress, a cushion, or the like) may be recycled and/or reproduced into another product or into a substantially similar or identical product plastic product. For example, the product may be formed of material(s) which are designed to be recycled and/or re-grinded; in contrast with polyurethane, which may not be recycled into a new pad. For example, the product may be formed of polypropylene (PP) or thermoplastic elastomer (TPE), which are recyclable and durable, and optionally suitable additive(s), which may be used again and again in other plastic products or in the same product.

In some embodiments, the level of flexibility or rigidness of the material may be preset in order to provide the suitable support to the human body, as well as the user experience upon touching or using the product by sitting, lying, or otherwise having contact with the product. In some embodiments, a relatively small amount of materials (e.g., polypropylene) may be used in order to form a sufficiently-supportive panel, wall, padding or product.

In some embodiments, utilization of materials such as polypropylene may allow recycling of the product or portions thereof, but may cause some of the springs to be semi-rigid and thus to locally collapse upon long-term usage and strain. Such collapse may be avoided or mitigated using adequate design of the spring, with a relatively small amount of material, to absorb local strains without collapsing.

In some embodiments, the cover unit provides the user with a feeling of softness, and is able to imitate or emulate a padding formed of textile, leather, felt, linen, flax, or other natural materials or materials which are typically processed separately from an injected product. In some embodiments, the cover unit may be self-supportive and may support itself without collapsing, yet the cover unit may receive additional support from the base unit. In some embodiments, the utilization of a stable structure having a relatively soft cover may allow the product to provide a user-experience of softness without filling the interior of the product with sponge. In some embodiments, the texture of the external side or the top side of the cover unit may emulate or imitate characteristics of natural materials, for example, leather or woven textile. The cover unit may be formed of one or more suitable materials, for example, fibers, foam, foamed materials, or other materials which provide the user with a feeling of softness.

In some embodiments, a mechanical locking mechanism may be used to lock between the cover unit and the base unit, and to avoid relative movement between the top portion of the cover unit and the top portion of the springs. The locking mechanism may be adapted to provide to the springs a particular degree of freedom of movement (e.g., very limited, or relatively wide), thereby allowing to produce a product having a particular level of flexibility or rigidness, further taking into account other characteristics of the springs (e.g., spatial resolution) in order to achieve a particular resistance to pressure.

In some embodiments, another mechanical locking mechanism may be used in order to lock the cover unit to the body of the final product, thereby allowing assembly of a disassembled product which was shipped in a disassembled form to a retailer, a distributor or an end-user (thereby saving shipping costs and/or storage costs due to nesting and stacking of multiple units).

In some embodiments, various types of locking mechanisms may be used, for example, a male-into-female locking mechanism, a “mushroom” snapping or locking mechanism which utilizes a mushroom-shaped snap or protrusion having a pillar and a protruding dome, or the like. In some embodiments, additional locking elements may be used, for example, formed of a pillar having a mushroom-type snap at one end (e.g., at the bottom edge which protrudes into the product) and having a torus or strip or other suitable-shaped obstacle or locking element at the other end (e.g., at the top edge which protrudes outward from the product). Other suitable locking mechanisms may be used.

In some embodiments, the cover unit and the base unit may be designed to allow efficient extraction from a manufacturing template, for example, using a slope, an incline or a slant of at least 3 degrees. A greater degree of slanting may allow improved nesting capability. Some embodiments may utilize a draft angle having a higher value (e.g., in degrees), in order to allow improved nesting and/or more efficient ejection or extraction of the formed unit from the steel template, or in order to allow a safer and less-damaging extraction process of the unit from the steel template or the mold.

In some embodiments, the base unit may be adapted to fit onto a variety of surfaces, which may be rigid or generally rigid (e.g., furniture) but which may not necessarily be planar or entirely horizontal (e.g., a sun-tanning bed which may have vertical surfaces as well as slanted surfaces for the head or the feet).

In some embodiments, geometric design may be used to achieve injection-based walls, panel, side-walls, side-panels, top-walls, top-panels, and other types of walls or panels which may have varying elasticity.

In some embodiments, a fiber-based texture imitating woven fabric or imitating woven textile may be used, for example, in conjunction with a top-wall, a top-panel, a top surface of a product, or other suitable product areas. The texture may imitate, or may include, warp and woof threads, or other suitable horizontal and vertical patterns or grids, in order to imitate woven textile as well as softness upon human touch, elasticity, and strength. In some embodiments, the texture may be produced using one or more suitable equations or formulas, for example, a “softness formula” shown herein and utilizing multiple parameters (e.g., seven or eight parameters). In some embodiments, one or more of the parameters may be substantially constant or fixed, and one or more parameters may be modified, in order to achieve various levels of softness. For example, in some embodiments, a parameter corresponding to an expected human pressure may be substantially constant (e.g., set to a fixed maximal force of approximately 2.5 kilograms over an area of one centimeter squared. In some embodiments, changing the materials used, and/or adding or removing a foaming material, may allow modification of the softness or rigidness of the produced texture. In some embodiments, various fibers and/or elastic materials may be added or used (e.g., thermoplastic elastomer or thermoplastic elastomeric (TPE), thermoplastic rubber, a mix of polymers, mix or plastic and rubber, or the like) in order modify the softness or rigidness of the produced texture. In some embodiments, a higher value of the “softness” parameter, calculated using a softness formula, corresponds to a greater level of softness and corresponds to a greater level of imitation of textile or fabric. In some embodiments, a parameter corresponding to nominal wall thickness may correspond to the total weight of the material in the manufactured padding; and a smaller value of this parameter (which, in injection molding, may be from approximately 0.1 millimeter to approximately 10 millimeters) may correspond to a smaller weight of the material in the padding and thus to a lower cost of manufacturing. Other suitable values may be used, and other suitable parameters may be used and/or modified.

In some embodiments, fibers are used in order to increase the level of imitation or emulation of textile or fabric, to increase the user's feeling of touching a textile-like or fabric-like material or padding, and to reduce the padding's similarity (e.g., upon touching) to plastic or rubber. In some embodiments, the fibers may be positioned within the padding (e.g., during the injection process) according to a random or pseudo-random pattern, or according to a pre-defined or a generally pre-defined pattern. In some embodiments, some of the fibers may partially project or may partially stick-out or protrude of the surface of the injected material, and/or some of the fibers may penetrate or may enter the material or the textile-like texture regions. In some embodiments, the fibers may be reinforced or bonded by olephinic materials or olefinic materials, polypropylene, or thermoplastic material(s) which may be used for bonding; and such bonding may prevent the fibers from being extracted or removed or pulled-out from the produced texture.

In some embodiments, foaming may be used, utilizing a bubble-producing blowing agent, in conjunction with an expansion molding process in order to increase the thickness of the wall while substantially maintaining its weight, or while almost not increasing its weight. The addition of bubbles into the material may further increase the elasticity of the material, and/or the response of the materials to a human pressure (e.g., finger pressure). In some embodiments, the injection may be used to increase the sponge-like feeling of the produced texture, in accordance with the quantity of the blowing agent used. In some embodiments, the level of softness of the produced texture may be in proportion to the multiple of the nominal wall thickness parameter (denoted W) by the expansion ration (denoted E).

In some embodiments, the produced texture may utilize a textile-like or fabric-like sheet or bolt, optionally including a printing thereon. In some embodiments, the number or quantity of fibers or natural fibers used may be reduced by selectively concentrating such fibers to be positioned at the portion of the product or padding which is intended to be in contact with a human body (e.g., a top or external or near-external portion of padding). For example, injection may be performed substantially directly on the non-woven texture; and optionally, printing may be performed (e.g., of colors, patterns, a logo, a writing, a leather-like printing, or the like). In some embodiments, the fibers of the non-woven material may be provided as sheets or bolts or foils (e.g., having a sheet thickness ranging from approximately 0.01 millimeter to approximately 2 millimeters), which may be accurately cut into a particular shape and size in order to accommodate a template prior to the injection. In some embodiments, subsequent to the injection, some or most of the fibers are bonded to the plastic material, whereas some or few of the fibers are loose or semi-loose or partially-loose and thus may imitate or emulate the feeling of a woven fabric upon human contact with the external area (e.g., a top area of a padding). In some embodiments, the sheets of non-woven materials may include natural fibers (e.g., viscose) and/or synthetic fibers (e.g., polypropylene, and/or polyester which may not melt into the polypropylene, and/or may have different melting temperature, and/or may not combine with the other material(s) and therefore may maintain some or all of its original properties). In some embodiments, the non-woven, randomly-condensed fibers may result in a texture which may resemble, emulated or imitate textile or fabric.

The term “pin” as used herein may include, for example, a cylinder; a bobble; a protrusion; an indentation; a “boss” or a “bossing element”; an element or shape which comes out of, or goes into, a surface or an area; a rib; a cone or conus; a trimmed cone or conus; a pyramid; a trimmed pyramid; a dome; a sphere; a ball; a tetrahedron; a trimmed tetrahedron; a prism; a bobble or a bump or a raised bump; or other suitable shapes or three-dimensional figures. In some embodiments, pins may be separate from a pad or a padding or a surface or other area from which they protrude or come out of whereas in some embodiments, multiple pins may be used to form a layer or pad or padding, e.g., an independent layer of pins, a layer of filled pins, a layer of semi-filled or partially-filled pins, a layer of empty pins, or the like. In some embodiments, the pins discussed herein may be used, for example, as a shock absorbing layer or pad, in addition the flexible or fabric-like or textile-like layer(s) or other layers (e.g., the cover unit or cover member) which may surround or trap the pins or be adjacent to the pins.

Some embodiments may utilize a spherical pin, and/or may be able to control the shape of a sphere interior, even though it is a locked shape which is not common to injection molding. For example, for manufacturing a sphere (or a ball), turning a boss into a sphere may utilize blowing gas into it or performing other process. A ball may have ejection problems, so it may not be a part of a suspension system of a “spring on fabric”; but it may be a “filler” suspension element.

In some embodiments, multiple pins may be used and/or may be included in one or more regions or areas or portions of the produced texture. Each pin may have a closed or open geometrical structure which may include or store material(s) having one or more properties different from the properties of the formed texture. For example, the pins may store air, gas, liquid, fluid, rigid material(s), flexible material(s), or other suitable materials, which may occupy some or all of the storage capacity of each pin. In some embodiments, such pin-stored material(s), upon compression, may provide particular level of softness or rigidness to the pin-populated areas, for example, in the top surface of a padding. In some embodiments, such pins may absorb or support, or may help to absorb or support, some or all of the human pressure applied onto the formed padding or product. In some embodiments, pins may be formed to have particular shapes, e.g., as bubbles or tubes, may locally absorb pressure, and may prevent or reduced movement of a top surface of a padding upon local application of pressure or force.

In some embodiments, particularly in conjunction with products having a closed-box structure or having a base-and-cover structure, pins may be included in a top member or a cover member, as well as in a bottom member or a base member. In some embodiments, such pins may interconnect or meet within the product, and may thus create an array or alignment which may absorb or support pressure applied from an external source (e.g., a human body pressing from the top downwards). Such alignment or array of pins may be separated from other layers or units of the product, or may be trapped or confined within a particular layer of the product (e.g., as a padding layer). Pairing of pins, or of sets of pins, may be performed using one or more suitable methods, for example, insertion, affixation, gluing, bonding, placement, using a locking mechanism, welding, soldering, using an insertion mechanism, or the like.

In some embodiments, implementations of the closed-box or almost-closed-box structure may have pre-designed control over air flow. Air may make noise while passing through holes; and thus noise elimination may be used, especially when air pressure is accumulated due to random mass on the “closed box” shape. Optionally, the air flow or air pressure may be used as an alternative suspension system (e.g., as a closed loop or adjustable air flow mechanism which uses a bi-directional or single directional vent).

In some embodiments, a top surface or a top cover may be connected to springs using pins or tacks in order to provide local elasticity or stretching, or in order to prevent or mitigate movement or migration of softness properties from side to side. Other suitable mechanisms or elements may be used, for example, the “pasta-like” elements or “spaghetti-like” elements or other long thin cylindrical elements, or layer(s) or groups or sets thereof, as discussed herein.

Pins (or other suitable elements) may be used in order to strengthen the connection between elements of the product, improve or increase the absorption or support for pressure, to improve or allow locking of the product (e.g., padding) to another product or surface (e.g., mattress), and/or to absorb or support local pressure applied locally to particular points or areas (e.g., by transferring the absorbed pressure or forces from pin to pin, or from a top pin to a bottom pin).

In some embodiments, one or more ribs may be used in order to provide support and/or rigidness to the formed texture or product, for example, at a bottom area of a top surface of padding. The rigidness-providing ribs may enforce and/or strengthen the top surface, particularly in response to a locally applied force or pressure, as well as in order to assist in providing a particular shape to the product (e.g., a padding resembling a platform or a bed or a mattress). In some embodiments, rigidness-providing ribs may optionally be used in conjunction with pins (or without such pins), in order to assist in supporting and/or stabilizing the top surface; and such ribs, their structure, position and height may be designed by taking into account the position, structure and height of such pins. In some embodiments, gas may be used in order to empty the material(s) from closed pins (e.g., bubbles), and some or all of the ribs may be used as routes, paths or tracks for flow of such gas.

In some embodiments, ribs may be used not necessarily for providing rigidness or reinforcement, but rather, as weaker ribs to support or form a soft or relatively-softer or “weaker” pad or padding, e.g., using a single-part unit (a spring-less unit).

In some embodiments, a particular border, boundary, stitching or other connection element may be used to connect the top member of the product with the bottom member of the product. The connection method may vary, for example, to accommodate various materials from which the product may be formed, to accommodate an external shape or design of the product, and/or to accommodate the required functionality of the product (e.g., including properties of softness or rigidness).

In some of the connection methods described or shown herein, arrows may indicate the direction of the connection between the top member and the bottom member; and the direction of the arrow may indicate the direction of the connection. Some embodiments may utilize, for example, a visible connection or stitch, a substantially invisible or undetectable connection or stitch, a stair-shaped connection, a one-to-one connection, a stitch hidden under a covering element or layer, weld lines which may be hidden or covered or partially-hidden using stitches shapes, a stitch or connection located approximately in the center of the product, or the like. The connection may include, for example, a snapping mechanism in which one member “snaps” and locks into another member; a male-into-female connection mechanism; tacks; pins; brooches; joints; soldering; welding; bonding; gluing; combined injection; collapsible mold or collapsible core; or other suitable methods of affixation or connection. In some embodiments, stitching may be used for connection or attachment purposes, e.g., similar to welding; additionally or alternatively, stitching may be used for other purposes, e.g., imitating the shape, texture, properties or behavior of actual stitches on fabrics or fabric padding. In some embodiments, the above-mentioned weld lines may be implemented as imitation of actual stitches on fabric, thereby camouflaging their functionality as welding mechanism, affixation mechanism, or the like. In some embodiments, stitching techniques may be used in order to connect rounded elements (e.g., a padded seat having rounded corners) with rigid elements, or in order to provide rounded elements (e.g., rounded corners or rounded areas) with rigid elements).

Some embodiments may utilize “welt stitching” or other suitable stitching which may be used for visual and functional reinforcement, e.g., typically used in some cushions and/or in some leather products. In some embodiments, the welt stitching may have a “bold” appearance, and may be used for both additional reinforcement as well as design purposes (e.g., optionally adding a metal insert or a gas channel).

In some embodiments, the springs may be formed as a set or array of cylinders, cones, pyramids, or other suitable shapes, for example, similar to an upside-down cup. Optionally, the spring may include an angle or a draft (e.g., on top of the spring's narrower end), to facilitate the extraction of the injected spring from a template or from a production line. In order to prevent or mitigate irreversible strains on the spring, which may be formed of polypropylene or other olefinic material(s), one or more structural elements may be used, for example, radius-shaped elements, releasing elements, or the like.

It is noted that the demonstrated shapes and structures may be significant, in order to allow the polypropylene spring or the olefinic material spring to operate and to return to it uncompressed position once the application of force or pressure ends. Unlike elastic silicone springs, which may easily assume their original uncompressed position, a spring made of polypropylene or olefinic material may be required to be produced in accordance with one of the particular demonstrative structures demonstrated or shown herein, so that the spring will be able to decompress into its uncompressed position upon removal of the applied force or pressure. Additionally, the connection between or among adjacent springs should be structured in order to allow the set, array or grid of springs to flexibly accommodate and form-fit onto a non-planar surface (e.g., a tanning bed, a porch bed, a beach bed or a pool bed having diagonal or non-horizontal areas as well as horizontal areas).

In some embodiments, a product or a padding may include, in addition to springs or instead of springs, random or pseudo-random or semi-random injection-based filling. For example, spaghetti-shaped or pasta-shaped elements may be produced using injection molding, in order to fill (partially or entirely) one or more cavities within the padding or the product. In some embodiments, a cover unit is also injected, and therefore may be inserted or sunk into a template in order to be filled with such filling elements. In some embodiments, injection of a cover unit (or a surface) as well as injection of the filling elements may be performed in a single process, in a linear process, in a parallel process, in a sequential process, in a continuous process, or the like. In some embodiments, filling elements may be injected into a substantially open space or cavity, optionally in conjunction with movement (e.g., downwards or sideways). In some embodiments, a cooling or curing process may be used in order to cool the injected filling elements, and suitable processes may be used in order to achieve a particular shape (e.g., through bonding of multiple filling elements) or a particular level of softness or rigidness for the multiple filling elements. In some embodiments, springs may be injected into, and glued or bonded to, an injected cover member or base member. Other suitable methods may be used.

Some embodiments may utilize the concept of a pressure direction vector and the reflective (opposite) pressure that stands against it; such that a force (pressure) is being absorbed through several layers of absorbers; a reflective (Passive force) is a sum of all absorbers rejecting this pressure. Some elements may absorb pressure(s) from all sides, or mainly from two opposite sides.

In some embodiments, injection nozzle(s) may be adapted, shaped and/or positioned in order to allow production of pasta-shaped or spaghetti-shaped injected elements, as well as delivery of such elements to a desired location in the process, e.g., manifold transporting of the injected materials from a single injection point and then spreading them in a random or pseudo-random or pre-defined shape or pattern.

In some embodiments, after first formulation the random or semi-random shapes may be cooled by pressure control of a cooling agent. After the first formulation, the coolant is used to freeze the shape in the mold space, and may then be sucked to leave the shape dry. Additional drying and/or cooling may be added after the product is ejected from the mold, for example, by using fans and/or chemical cleaners to remove traces of the cooling agent.

In some embodiments, the shape may be predetermined by the hole shape, which may provide the overall velocity and rotational (centrifugal) movement of the material. Using one or more cooling techniques, the spaghetti-shaped injected elements may be positioned accurately in order to obtain a particular general shape, as well as to save material and to keep the elastic properties when pressed (e.g., the material may be pressed and return to its position or form without generating visual creep or dent or bow or deformation). In some embodiments, the spaghetti-shaped injected elements may be used as filling inside a predetermined cover or container, or may fill a cavity or multiple cavities of mold space. In some embodiments, filling time, or controlled shaping, or material properties may be used and modified in order to determine the overall flexibility or rigidness of the product.

Some embodiments may include shaping and controlling for cycle time and material reduction without necessarily pre-designing the injected spring. For example, the “curling” of the injected spring, or the shaping of the spring's curl, is not necessarily achieved by precise spring design, but rather, using a curl or spaghetti-like trend of injection. In some embodiments, this may allow a simplified mold and/or higher-resolution padding, for example, due to elimination of draft angles. The filling may be based mainly on time, and may not be “thin walled” technology. In some embodiments, due to a generally circular shape of an outing or the injection nozzle, a spaghetti-like product may be injected and formed; in other embodiments, other suitable nozzles may be used, in order to produce various other types of formations which may be extruded from the injector or the nozzle. Accordingly, the utilization of the term “spaghetti-like” is only for demonstrative purposes, and other suitable formations may be used in accordance with some embodiments.

In some embodiments, material properties may determine whether the curls will attach the space, or will be a separate part of it. For example, polypropylene may have fewer tendencies to glue to the filling area, but may tend to melt more and may become more uniform; whereas TPE may have fewer tendencies to melt into a full part, and may preserve the original curl shape, but may be more likely to bond to itself or to other materials.

In some embodiments, spaghetti-shaped injected elements may be used in order to randomly or pseudo-randomly fill a cavity or a particular volume of the product, for example, a top member or a cover unit. Optionally, the item or container intended to be filled may be placed within the template, and the injection may fill it with the injected elements, e.g., PP and/or TPE and/or PE, separated or mixed together where engaging elastomers is chemically possible (e.g., not all materials can mix or bond together; some sorts of TPE can chemically bond to PP, but may not bond to PE). In some embodiments, the injected elements may become cured, semi-cured, rigid or semi-rigid prior to touching the container into which they are injected; and thus the injected elements may have some glue-like properties by may not flatten, and may remain stable and become sponge-like.

In other embodiments, the spaghetti-like injected elements may be injected into the cavity of the steel template, and not into the container itself. As a result, a pad or padding or mattress-like layer may be formed, having the form or shape of the steel template. The resulting pad may be placed, as an intermediary layer, between a cover member and a base member (e.g., of a cushion, pillow, padding product, or the like); may be covered with a textile-like or fabric-like layer; and may be between such layer and a relatively-rigid layer or unit (e.g., a base member onto which the flexible layer is bonded or connected).

In some embodiments, spaghetti-like injected elements may be used instead of using injection-based springs, thereby providing a resulting layer having properties that are less controllable, more random or pseudo-random, optionally providing more filling (relative to springs), yet not providing the nesting capability of injected springs.

Some embodiments may allow reduction in the number of stages or steps in a manufacturing process; or replacement of a multi-stage production process with a reduced-stages production process or even a single-stage production process. In some embodiments, a multiple-stage production process (e.g., producing and/or cutting a sponge layer or an intermediate layer; producing and/or cutting a textile or fabric cover or layer or wrapping; stitching the textile or fabric to, or around, the intermediate layer; and/or other stages) may be replaced with an injection-based process and/or a single-stage process, in which some or all of the elements of the products are injected or are injection-based, including the textile-like or fabric-like cover or elements, the intermediate layer, the injection-based springs, the injection-based spaghetti-like elements, or the like; and some embodiments may thus allow improved and more efficient combination of soft elements with rigid elements. Some embodiments may allow production, within a single process and/or using a common production line, elements having various levels of softness and/or rigidity, for example, soft elements, rigid elements, or the like. Some embodiments may thus allow reduction in the number or size of production units; reduction in the complexity of producing the product; reduction of production costs; and/or reduction of the time required for producing the product.

Other suitable operations or sets of operations may be used in accordance with some embodiments. Some operations or sets of operations may be repeated, for example, substantially continuously, for a pre-defined number of iterations, or until one or more conditions are met. In some embodiments, some operations may be performed in parallel, in sequence, or in other suitable orders of execution.

Some embodiments may be utilized in conjunction with furniture, products and/or items that are formed of rattan or rattan-like materials, or that include elements or components that are formed of rattan or rattan-like materials. In some embodiments, fabric-like materials which are described herein may be utilized in combination with methods of rattan weaving or rattan-like weaving, optionally by utilizing softeners (e.g., TPE added to PP). Some embodiments may be used, for example, in conjunction with rigid constructs or products (e.g., outdoor furniture or garden furniture), which are typically formed as a construct wrapped in textile or fabric, but may be modified or adapted according to some embodiments to include elements or rigid constructs which are wrapped or covered (entirely or partially) with injection-based textile-like or fabric-like material(s). Some embodiments may be used in conjunction with other suitable combinations of elements, constructs and/or materials.

The terms “rigid” or “entirely rigid” as used herein may include, for example, a property of being rigid relative to other materials, e.g., from a common family of materials or from a group of similar materials; for example, being rigid relative to items formed of PP material(s), being rigid relative to items formed of olephinic material(s), being rigid relative to items formed of materials belonging to one or more groups of raw plastic materials, or the like.

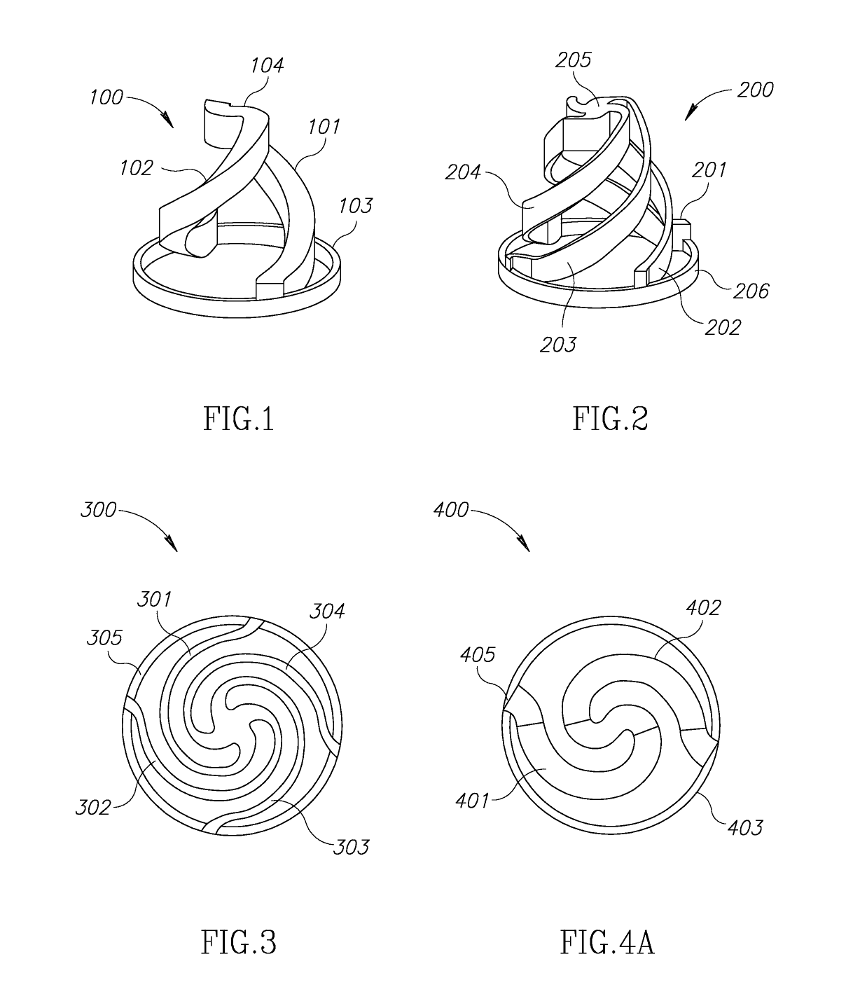

Reference is made to FIG. 1, which is a schematic illustration of an injected plastic spring 100 in accordance with some demonstrative embodiments. Spring 100 may be formed of plastic material(s), and may be produced by injection molding of raw plastic material(s). Spring 100 may be flexible and not entirely rigid, such that spring 100 may compress, partially or entirely, upon application of force or pressure. In some embodiments, multiple stress reactions may operate on the suspension spring, for example: lateral bending; vertical bending; torsion bending.

Spring 100 may include, for example, a first helix 101 and a second helix 102, to thereby form a dual-helix spring or a double-helix spring made of plastic material(s). The first helix 101 and the second helix 102 may be connected to each other at the top of spring 100, optionally by utilizing a top 104 or apex or vertex or other point or surface located at the top of spring 100. The first helix 101 and the second helix 102 may be connected to each other also at the base 103 of spring 100. For example, base 103 may include a plastic member shaped as a circle, an oval, or other suitable shapes. Spring 100 may be formed such that the two helixes 101-102 spiral, or rotate spirally, or converge to meet, as they extend upwards from opposite sides of the base 103 towards the top 104. In some embodiments, the two helixes 101-102 may be substantially identical to each other, e.g., in shape, weight, size, material, cross-section, or other characteristics. In some embodiments, spring 100 may be substantially symmetrical. In some embodiments, spring 100 and its two helixes 101-102 may have a form which may resemble a cone or pyramid or clipped-pyramid or clipped-cone or frustum or conical frustum or pyramidal frustum; for example, the two helixes 101-102 may gradually taper smoothly from the circular base 103 towards the top 104. The top may be referred to as “joint” of two or more helix-shaped springs; the joint enables the vertical bending force to generate the two additional stresses (absorbing or rejection stresses) by adding lateral and torsion bending; this may be achieved by joining two or more helix-shaped springs or members which are facing toward one another. In some embodiments, the space available between the bottom diameter of base 103 to the top diameter (e.g., the top 104), which may be a cone-shaped space, is used in order to control the absorbing; the thicker the legs or supporting members, the more stiff or rigid the spring is; the greater the number of legs or members, the more stiff or rigid the spring is. In some embodiments, each helix 101-102 may follow a cylindrical or conical spine, or may be formed within a spiral or cylindrical grooving or indention or elongated recess which may spiral around a conical mold or pin or template.

Reference is made to FIG. 2, which is a schematic illustration of an injected plastic spring 200 in accordance with some demonstrative embodiments. Spring 200 may be formed of plastic material(s), and may be produced by injection molding of raw plastic material(s). Spring 200 may be flexible and not entirely rigid, such that spring 200 may compress, partially or entirely, upon application of force or pressure. Spring 200 may include, for example, four helixes 201-204 which spiral and converge from a common circular base 206 towards an apex 205, thereby forming a quad-helix spring or a quadruple-helix spring made of plastic material(s).

Reference is made to FIG. 3, which is a schematic top-view illustration of an injected plastic spring 300 in accordance with some demonstrative embodiments. Spring 300 may be formed of plastic material(s), and may be produced by injection molding of raw plastic material(s). Spring 300 may include, for example, four helixes 301-304 which spiral and converge from a common circular base 305 towards an apex, thereby forming a quad-helix spring or a quadruple-helix spring made of plastic material(s).

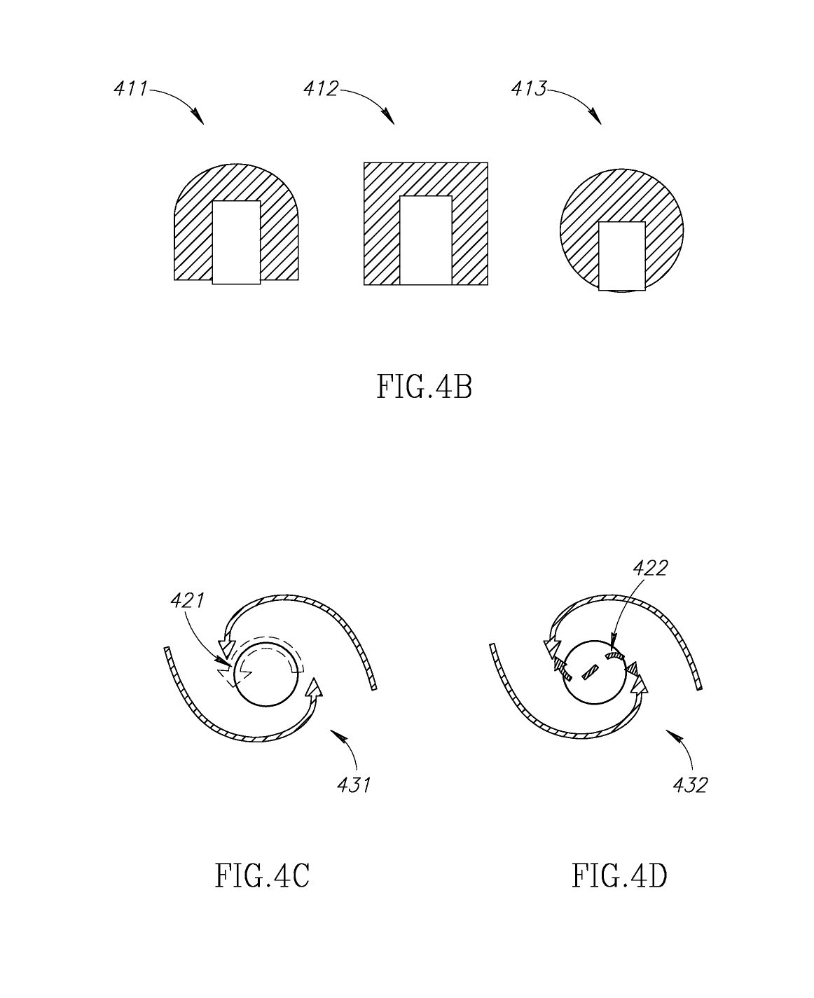

Reference is made to FIG. 4A, which is a schematic top-view illustration of an injected plastic spring 400 in accordance with some demonstrative embodiments. Spring 400 may be formed of plastic material(s), and may be produced by injection molding of raw plastic material(s). Spring 400 may include, for example, two helixes 401-402 which spiral and converge from a common circular base 403 towards a vertex, thereby forming a double-helix spring or a dual-helix spring made of plastic material(s). Optionally, each helix 401-402 may have a particular cross-section, such that a helix cross-section taken at connection point or at a joint 405 may be, for example, rectangular, circular, ball-shaped, “U”-shaped, or the like. The based joint 405 may be designed and formed according to the required spring spatial behavior; for example, if the spring needs to move from side to side, then the base joint may be more flexible; whereas, if the spring should stand vertically oriented, then the base joint 405 may be formed more stiff or rigid. In some embodiments, the base joint 405 may have a “U” shape; whereas a more flexible hinge may have a ball shape, and a stiffer implementation may utilize a rectangular shape.

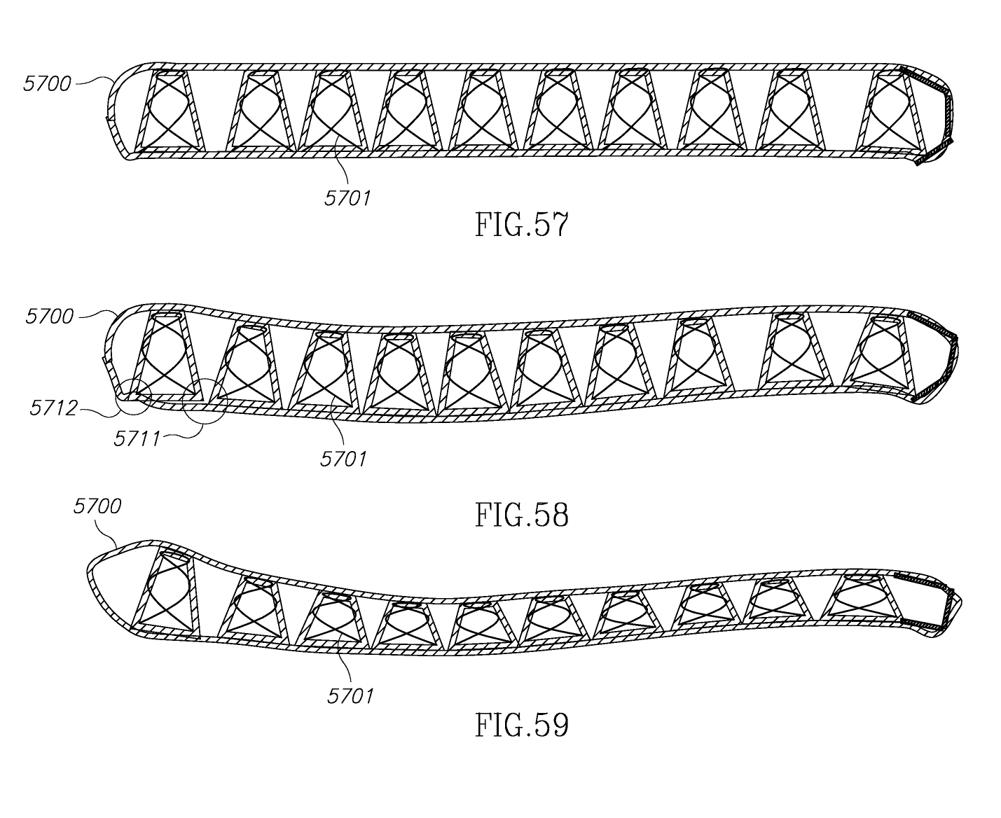

Reference is made to FIG. 4B, which is a schematic illustration of three cross-sections 411-413 of the joint 405 of FIG. 4A, in accordance with some demonstrative embodiments. As demonstrated, the cross-section of the joint may be, for example, generally U-shaped, generally rectangular, generally circular, or the like. Other suitable shapes may be used. In some embodiments, the cross-section of the base joint 405 may be set to allow control of the overall movement of the spring 400. Additionally or alternatively, as demonstrated in FIG. 57 herein, the base joints may control the spatial movement of each spring.

Reference is made to FIGS. 4C and 4D, which are schematic illustrations of representations of forces 431-432 applied on a spring, in accordance with some embodiments. For example, element 421 indicates force driven from the pressure on the spring. In order to control the amount of rotation, or resistance to rotation, the connection between the legs of the spring may be designed according to the desired function, ranging from an “I” shaped connection, to an “S” shaped connection (shown as element 422) which generates opposite force to eliminate the rotation effect of the spring. Other suitable connection shapes or structures may be used.

In some embodiments, controlling the rotational force driven from pressure on the spring may be done by designing the joint or the top portion. For example, changing the shape or size or dimensions or location or other properties of the joint, may control the amount of rotation and/or the amount of resistance to this rotation. Such design allows fine-tuning the spring to a specific behavior under pressure(s). For example, to utilize the torsion resistance of the spring and avoid the rotational behavior, an “S”-shaped Joint may be used. To achieve a more flexible spring an “I”-shaped Joint may be used. Between these shapes, there may be various refinements to make each spring individually, thereby allowing better control over the full behavior of the padding absorbers.

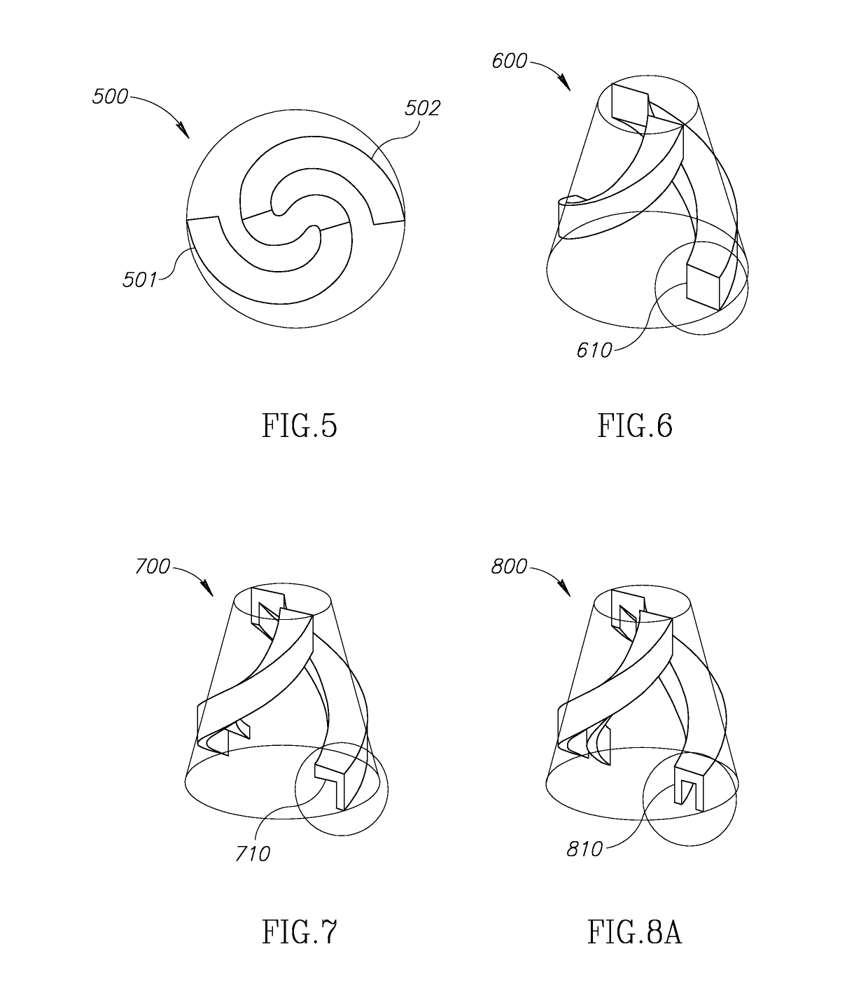

Reference is made to FIG. 5, which is a schematic top-view illustration of an injected plastic spring 500 in accordance with some demonstrative embodiments. Spring 500 may be formed of plastic material(s), and may be produced by injection molding of raw plastic material(s). Spring 500 may include, for example, two helixes 501-502 which spiral and converge from a common plane (but without being connected by a circular base at their bottom ends) towards a vertex, thereby forming a double-helix spring or a dual-helix spring made of plastic material(s). It is noted that this Figure shows, for demonstrative purposes, an external circle indicating a top-view of a conical mold, which is not part of the spring itself.

Reference is made to FIG. 6, which is a schematic illustration of an injected plastic spring 600 in accordance with some demonstrative embodiments. Spring 600 may be formed of plastic material(s), and may be produced by injection molding of raw plastic material(s). Spring 500 may include, for example, two helixes; each helix having a cross-section 610 which may be square-shaped. It is noted that this Figure shows, for demonstrative purposes, an external cone indicating a conical mold, which is not part of the spring itself.

Reference is made to FIG. 7, which is a schematic illustration of an injected plastic spring 700 in accordance with some demonstrative embodiments. Spring 700 may be formed of plastic material(s), and may be produced by injection molding of raw plastic material(s). Spring 500 may include, for example, two helixes; each helix having a cross-section 710 which may be “L”-shaped. It is noted that this Figure shows, for demonstrative purposes, an external cone indicating a conical mold, which is not part of the spring itself.

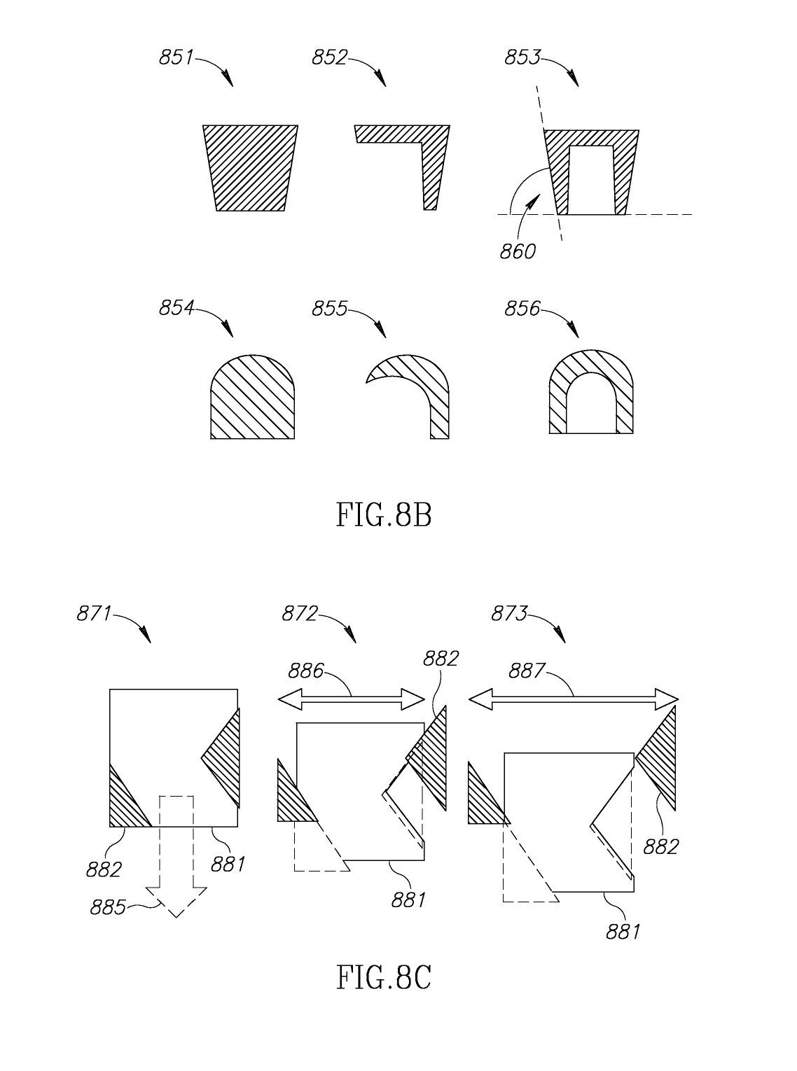

Reference is made to FIG. 8A, which is a schematic illustration of an injected plastic spring 600 in accordance with some demonstrative embodiments. Spring 800 may be formed of plastic material(s), and may be produced by injection molding of raw plastic material(s). Spring 500 may include, for example, two helixes; each helix having a cross-section 810 which may be “U”-shaped or “V”-shaped or “n”-shaped. It is noted that this Figure shows, for demonstrative purposes, an external cone indicating a conical mold, which is not part of the spring itself.

In some embodiments, the cross section of a first helix may be different from a cross section of another helix of the same spring. In some embodiments, multiple helixes of a single spring may have multiple shapes or sizes of cross-sections, or may have the same cross-section.

The cross sections 610, 710 and 810 discussed above may demonstrate the ability to fine-tune the spring behavior in order to add or remove resistance to pressure and diverting from torsial to horizontal or vertical resistance; as well as combining spatial bending or inertia changes, for each spring individually or for a cluster of springs depending on the required suspension for the area.

Other suitable shapes of cross-sections may be used, for example, a cross section shaped as a “greater than” (>) or as a “smaller than” (<) or as a single parentheses symbol such as “(“or”)”. Such shapes of cross-sections may be suitable due to spring flexibility; and even though it may have a negative draft angel, it may still be able to “jump” or eject out of the mold due to the elasticity of the spring shape.

Reference is made to FIG. 8B, which is a schematic illustration of six cross-sections 851-856 of a leg or supporting member of a spring, in accordance with some demonstrative embodiments. Each cross-section may represent a different level of flexibility of the leg or spring associated therewith. As indicated by arrow 860, some embodiments may utilize draft angle, for ejection of the formed product from the mold; whereas other embodiments may utilize a negative draft angle, while using the flexibility or elasticity of the formed product for overcoming undercuts and ejection from the mold.

Reference is made to FIG. 8C, which is a schematic illustration of three states 871-873 in a process of ejecting an injection molding part 882 (e.g., a spring, or a leg or member of a spring, or a net of spring) from a mold 881 or a template, in accordance with some demonstrative embodiments. Arrow 885 indicates a vertical movement or pull or ejection of the mold 881. Arrows 886-887 indicate the temporary expansion or opening of the part 882 which allows it to eject from the mold 881 by overcoming undercuts or negative draft angles using the flexibility and elasticity of the material and the formed part 882. After the ejection, the part 882 may return, instantly or gradually, to its original non-expanded state.

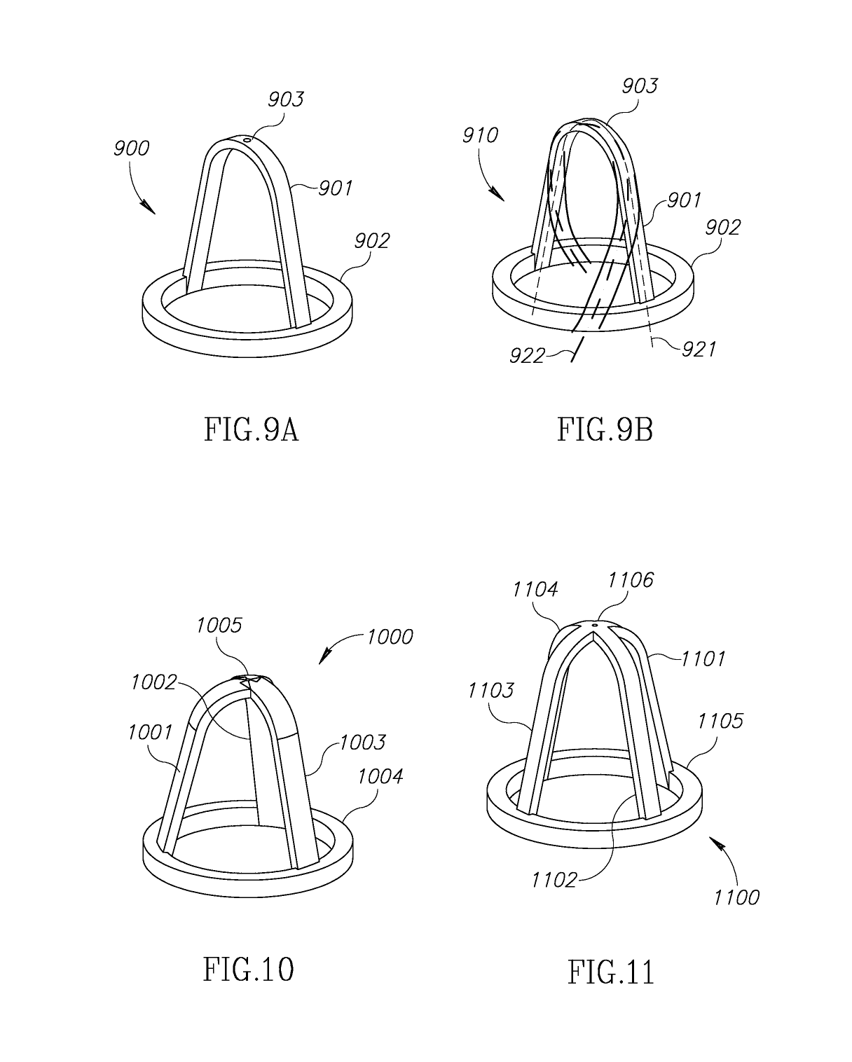

Reference is made to FIG. 9A, which is a schematic illustration of an injected plastic spring 900 in accordance with some demonstrative embodiments. Spring 900 may be formed of plastic material(s), and may be produced by injection molding of raw plastic material(s). Spring 900 may be flexible and not entirely rigid, such that spring 900 may compress, partially or entirely, upon application of force or pressure. Spring 900 may include, for example, a single or several curve-shape members 901 or supporting elements or legs, which may rise from a circular base 902 towards an apex 903. For example, member 901 may be formed as an upside-down “U”-shaped component, or as an “n”-shaped component. The curved member 910 may include portions that are straight, close to the bottom part of member 910; and portions that are entirely curved, close to the apex 903. In some embodiments, the single curve-shaped member 910 may be formed of two substantially identical half-curves or half-members, each half-member connecting an opposite point of the circular base 902 to the common apex 903.

Reference is made to FIG. 9B, which is a schematic illustration of an injected plastic spring 910 in accordance with some demonstrative embodiments. Spring 910 may be generally similar to spring 900 of FIG. 9A, except that the member 902 may be twisted or bent sideways near its connection with the base of the spring 910. For example, instead of following a curve 921, the member(s) 901 may follow a twisted curve 922 or other suitable shape.

In some embodiments, designing different spine to pin legs enables to control the resistance of the legs to pressure. The more diagonal the leg is, the more flexible the spring is to pressure vector. The more vertical the leg is, the more can it withstand higher pressure without bending. Fine-tuning or modifying the leg angle provides better control of spring behavior to different pressures. In some embodiments, the angle or slope in which the curve rises may define the resistance of this leg against an opposite pressure. This slope enables control of overall spring pressure absorbing. In some embodiments, the twist or bending of part of the supporting leg, near the base area, may allow the spring to absorb vertical pressure and/or diagonal pressure.

Reference is made to FIG. 10, which is a schematic illustration of an injected plastic spring 1000 in accordance with some demonstrative embodiments. Spring 1000 may be formed of plastic material(s), and may be produced by injection molding of raw plastic material(s). Spring 1000 may be flexible and not entirely rigid, such that spring 1000 may compress, partially or entirely, upon application of force or pressure. Spring 1000 may include, for example, three members 1001-1003 which may rise from a circular base 1004 towards an apex 1005. Each one of members 1001-1003 may include portions that are straight, close to the bottom part of such member; and portions that are entirely curved, close to the apex 1005. In some embodiments, the three members 1001-1003 may connect to the circular base 1004 at circumferential intervals of approximately 120 degrees. In some embodiments, spring 1000 and its members 1001-1003 may have a form which may resemble a cone or pyramid or clipped-pyramid or clipped-cone or frustum or conical frustum or pyramidal frustum.

Reference is made to FIG. 11, which is a schematic illustration of an injected plastic spring 1100 in accordance with some demonstrative embodiments. Spring 1100 may be formed of plastic material(s), and may be produced by injection molding of raw plastic material(s). Spring 1100 may be flexible and not entirely rigid, such that spring 1100 may compress, partially or entirely, upon application of force or pressure. Spring 1100 may include, for example, four members 1101-1104 which may rise from a circular base 1105 towards an apex 1106. Each one of members 1101-1104 may include portions that are straight, close to the bottom part of such member; and portions that are entirely curved, close to the apex 1106. In some embodiments, the four members 1101-1104 may connect to the circular base 1105 at circumferential intervals of approximately 90 degrees. In some embodiments, spring 1100 and its members 1101-1104 may have a form which may resemble a cone or pyramid or clipped-pyramid or clipped-cone or frustum or conical frustum or pyramidal frustum.

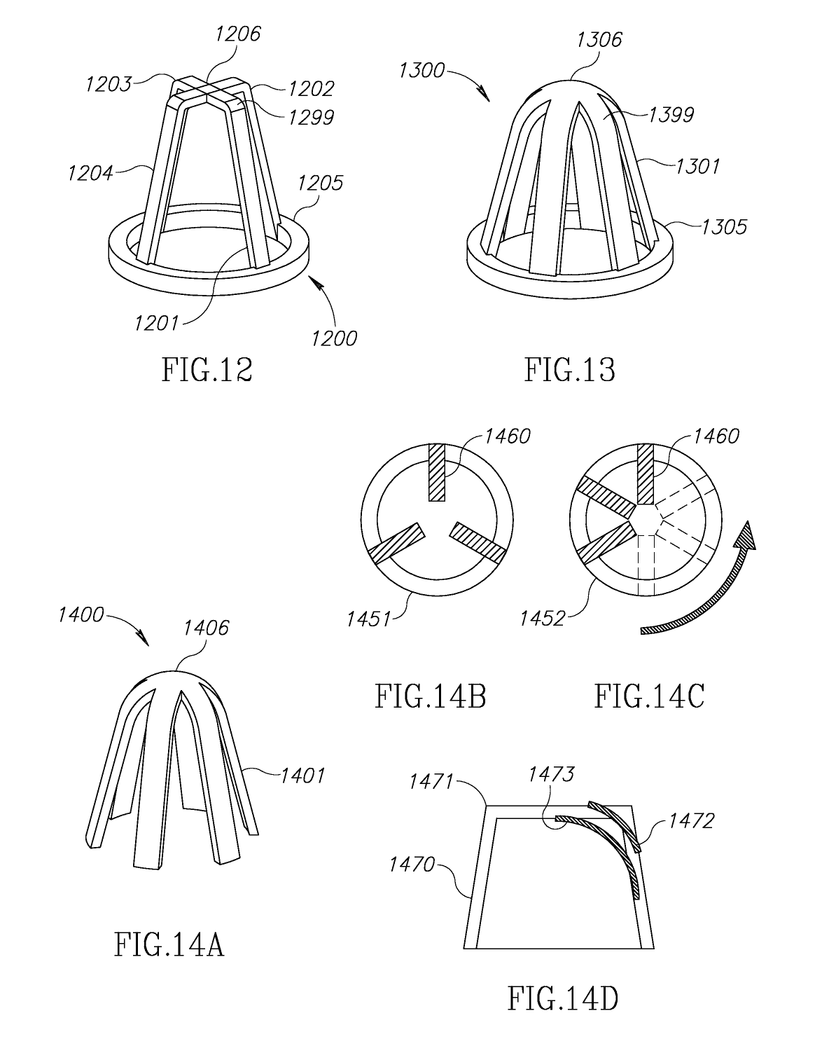

Reference is made to FIG. 12, which is a schematic illustration of an injected plastic spring 1200 in accordance with some demonstrative embodiments. Spring 1200 may be formed of plastic material(s), and may be produced by injection molding of raw plastic material(s). Spring 1200 may be flexible and not entirely rigid, such that spring 1200 may compress, partially or entirely, upon application of force or pressure. Spring 1200 may include, for example, four members 1201-1204 which may rise from a circular base 1205 towards an apex 1206. Each one of members 1201-1204 may be, for example, “L”-shaped, or “J”-shaped. In some embodiments, the four members 1201-1204 may connect to the circular base 1205 at circumferential intervals of approximately 90 degrees. In some embodiments, spring 1200 and its members 1201-1204 may have a form which may resemble a cone or pyramid or clipped-pyramid or clipped-cone or frustum or conical frustum or pyramidal frustum.

Reference is made to FIG. 13, which is a schematic illustration of an injected plastic spring 1300 in accordance with some demonstrative embodiments. Spring 1300 may be formed of plastic material(s), and may be produced by injection molding of raw plastic material(s). Spring 1300 may be flexible and not entirely rigid, such that spring 1300 may compress, partially or entirely, upon application of force or pressure. Spring 1300 may include, for example, six members, one of which is denoted 1301, which may rise from a circular base 1305 towards an apex 1306. Each one of the six members 1301 may be, for example, “L”-shaped, or “J”-shaped. In some embodiments, the six members 1301 may connect to the circular base 1305 at circumferential intervals of approximately 60 degrees. In some embodiments, spring 1300 and its six members 1301 may have a form which may resemble a cone or pyramid or clipped-pyramid or clipped-cone or frustum or conical frustum or pyramidal frustum.

Elements 1299 and 1399 in FIGS. 12 and 13, respectively, indicate the blending joint of legs towards the spring top. In some embodiments, the smaller the size or the radius of the blend, the stiffer the joint is. A stiffer joint is less sensitive to pressure. Setting the joint stiffness allows fine-tuning of the spring unit stiffness, namely, control over upper joint stiffness of the spring as well as the spring tendency for spatial movement.

Reference is made to FIG. 14A, which is a schematic illustration of an injected plastic spring 1400 in accordance with some demonstrative embodiments. Spring 1400 may be formed of plastic material(s), and may be produced by injection molding of raw plastic material(s). Spring 1400 may be flexible and not entirely rigid, such that spring 1400 may compress, partially or entirely, upon application of force or pressure. Spring 1400 may include, for example, six members, one of which is denoted 1401, which may rise from a common plane (but without being connected by a circular base) towards an apex 1406. Each one of the six members 1401 may be, for example, “L”-shaped, or “J”-shaped. In some embodiments, the six members 1401 may be positioned, relative to a common plane at their base, at circumferential intervals of approximately 60 degrees. In some embodiments, spring 1400 and its eight members 1401 may have a form which may resemble a cone or pyramid or clipped-pyramid or clipped-cone or frustum or conical frustum or pyramidal frustum.

Reference is made to FIGS. 14B and 14C, which are schematic top-view illustrations of springs 1451-1452 demonstrating repetition of legs 1460 or other supporting members, in accordance with some demonstrative embodiments. Some embodiments may utilize symmetrical repetition of curve shaped elements (or legs, or supporting members, or helixes) per spring unit, thereby allowing control over spring unit behavior. For example, the more legs or supporting members in a spring, the greater resistance of the spring. In some embodiments and Odd number of legs may provide less tendency of the overall spring unit to bend toward a certain direction. In some embodiments, and Even number of legs may provide the spring unit with higher tendency to bend toward a certain direction (e.g., with the X and Y vectors as hinges). In some embodiments, the repetition of the legs increases the spring resolution and sensitivity to local pressure. The greater the number of legs per spring, the more homogenized is the spring behavior. Spring with fewer legs may tend to move and jump sideways. In some embodiments, a spring may have one or more legs having a first shape, and one or more legs having a second, different, shape. In some embodiments, a set of springs may have, for example, one or more legs having a first shape, and one or more legs having a second, different, shape. In some embodiments, a set of springs may include a first spring having a first number of legs, and also a second spring having a second, different, number of legs.

Reference is made to FIG. 14D, which is a schematic side-view illustration of a supporting member 1470 of a spring, in accordance with some demonstrative embodiments. As shown, instead of having a sharp or square-type corner 1471, the supporting member 1470 may have a curved or smooth or bended or radial corner region 1472 or 1473. Some embodiments may thus utilize blending joint of legs to the spring (pin) top. In some embodiments, the smaller the blend (e.g., the curve in regions 1472 or 1473), the stiffer the joint is, and the stiffer the supporting member 1470 is, and the stiffer the entire spring is. In some embodiments, a stiffer joint may be less sensitive to pressure, and may generate a controlled stress in order to fine-tune spring behavior to pointed pressure (local). Other suitable types or shapes of blending, or joints, may be used.

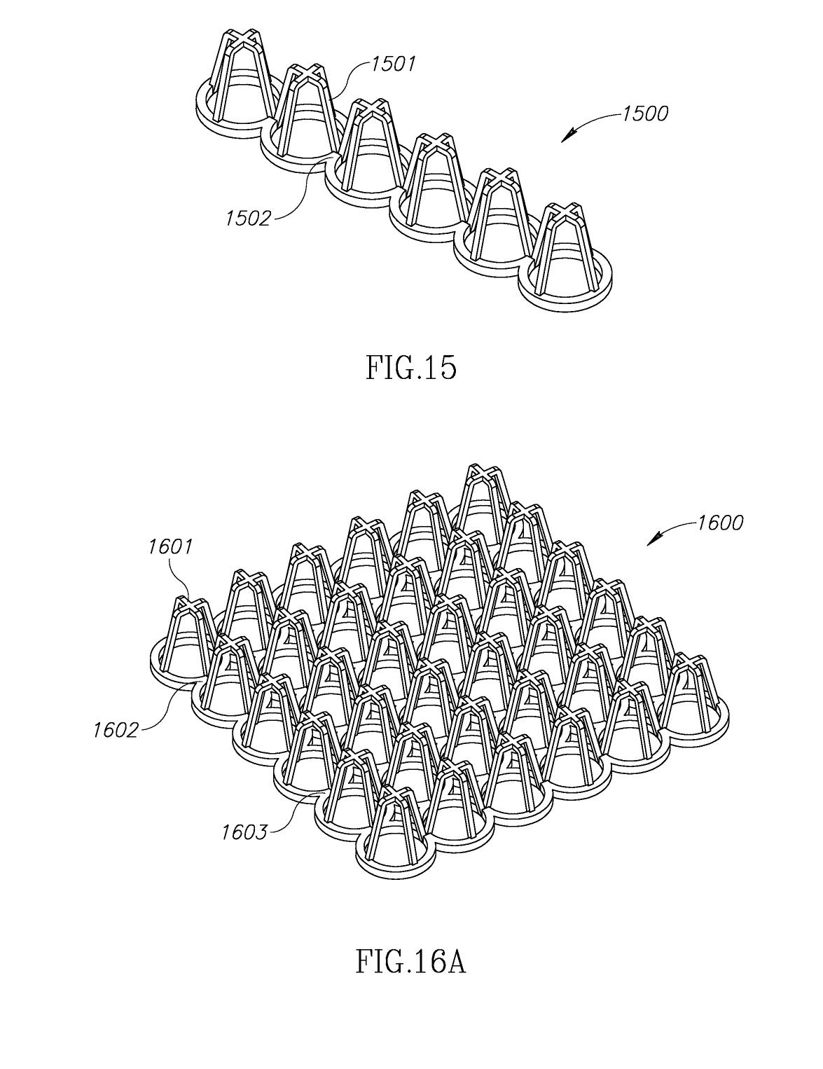

Reference is made to FIG. 15, which is a schematic illustration of an injected plastic net 1500 in accordance with some demonstrative embodiments. Net 1500 may be formed of plastic material(s), and may be produced by injection molding of raw plastic material(s). Net 1500 may be flexible and not entirely rigid, such that net 1500 (or portions thereof) may compress, partially or entirely, upon application of force or pressure. Net 1500 may include multiple springs 1501, each spring 1501 formed of injected plastic material(s). The net 1500 of multiple springs 1501 may be manufactured as a single component; or, as multiple springs 1501 which may be placed next to each other, assembled or glued or otherwise joined together at joining points 1502. For demonstrative purposes, net 1500 is shown as a row of six adjacent interconnected springs 1501; other suitable shapes, or number of springs may be used.

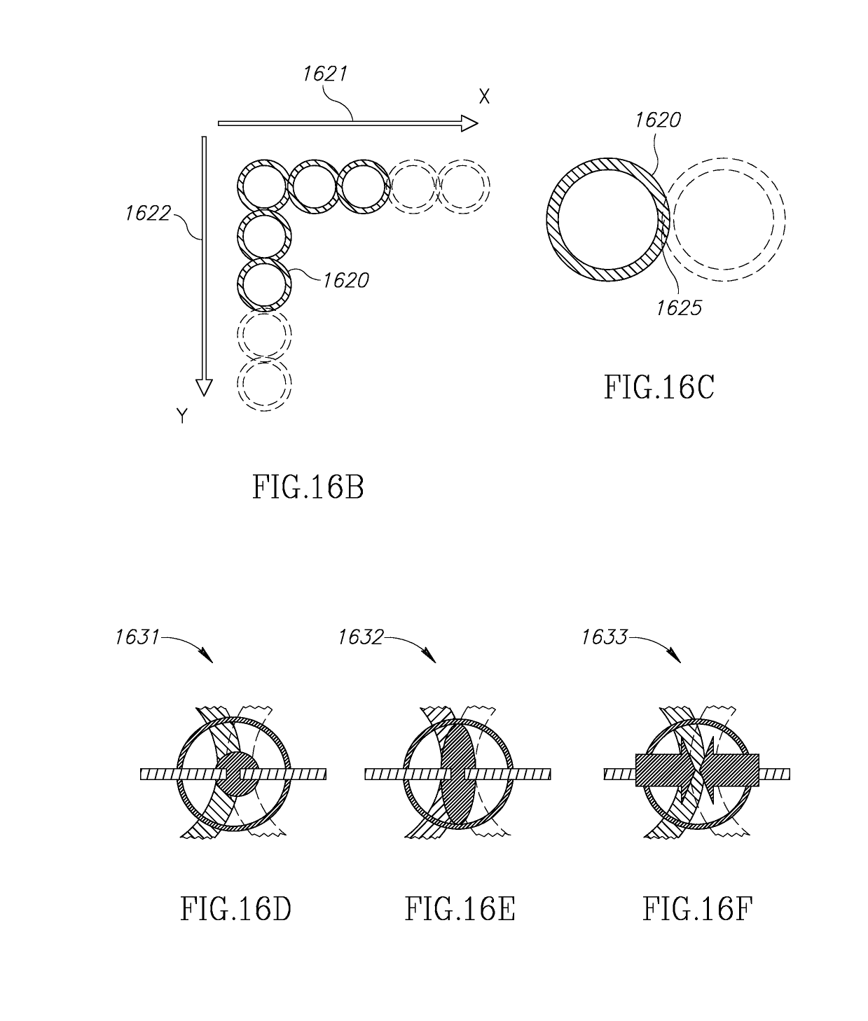

Reference is made to FIG. 16, which is a schematic illustration of an injected plastic net 1600 in accordance with some demonstrative embodiments. Net 1600 may be formed of plastic material(s), and may be produced by injection molding of raw plastic material(s). Net 1600 may be flexible and not entirely rigid, such that net 1600 (or portions thereof) may compress, partially or entirely, upon application of force or pressure. Net 1600 may include multiple springs 1601, each spring 1601 formed of injected plastic material(s). The net 1600 of multiple springs 1601 may be manufactured as a single component; or, as multiple springs 1601 which may be placed next to each other, assembled or glued or otherwise joined together at joining points 1602. For demonstrative purposes, net 1600 is shown as a square of six columns by six rows, such that each column has six adjacent interconnected springs 1601 and each row has six adjacent interconnected springs 1601; other suitable shapes, dimensions, or number of springs may be used.

In some embodiments, a net of springs may include a combination of springs having different sizes, shapes, dimensions, flexibility parameters, or other characteristics.

The net 1600 may include joints, such as joint 1603, to allow connection or repetition of springs, and repetition along an X-axis and/or a Y-axis, thereby combining multiple springs into a net. The behavior or characteristics of such joints makes the net 1600 more sensitive or less sensitive to surface curvature; and allows fine-tuning to surface curvature. In some embodiments, such net 1600 may be modularly designed, so it may cover large or virtually infinite surface. When utilizing a separate joint, such joint can be used to tie springs between them and/or to add spring nets one to another. The springs diameter and height is also modularly designed so it can form virtually infinite height and/or resolution. In some embodiments, repetition of springs in X and Y directions allows generating a springs net. The joints among springs may be formed to better react to surface pressure. Joints may be stiff or flexible, depending on the flexibility required from the full net of springs. A joint may be, for example, ball shaped, oval shaped, hinge shaped, or the like. In this regard, reference is made to FIG. 16B, which is a schematic illustration of expansion of springs 1620 along an X-axis 1621 and a Y-axis 1622; to FIG. 16C, which is a schematic illustration of a joint 1625 connecting two adjacent springs 1620; to FIG. 16D, which is a schematic illustration of a ball joint 1631; to FIG. 16E, which is a schematic illustration of an oval joint 1632; and to FIG. 16F, which is a schematic illustration of a hinge joint 1633; all in accordance with some demonstrative embodiments.

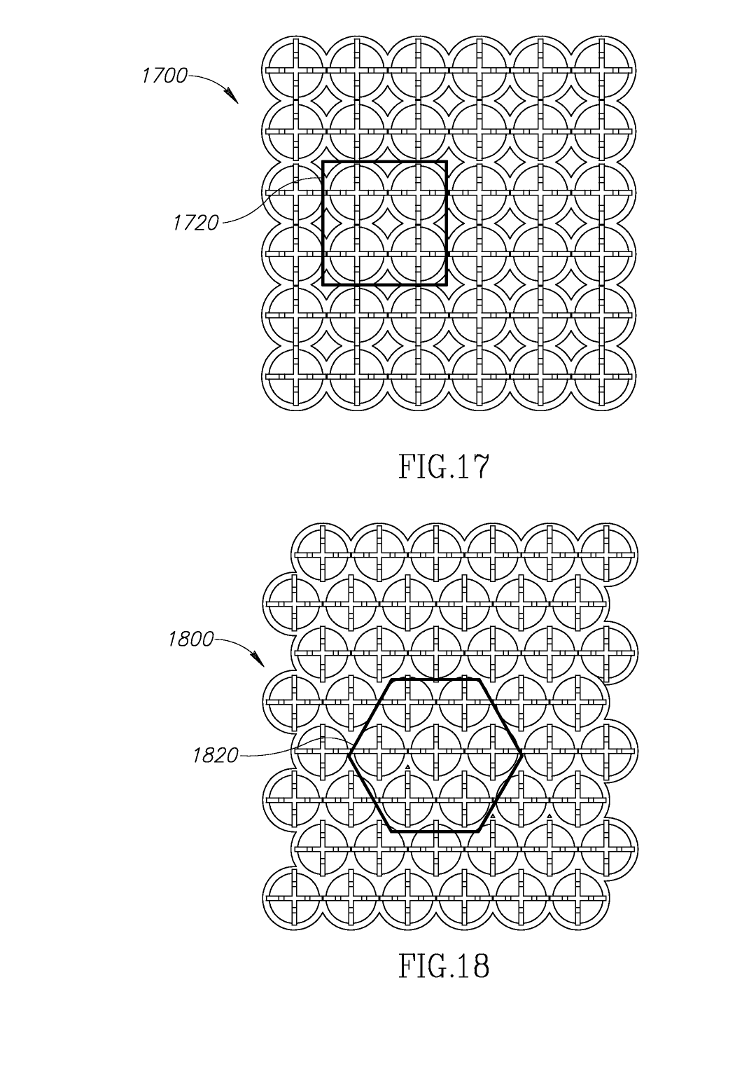

Reference is made to FIG. 17, which is a schematic top-view illustration of an injected plastic net 1700 in accordance with some demonstrative embodiments. As demonstrated, the net 1700 may include six rows of springs; each row including six springs positioned one next to the other, such that a group of four adjacent springs has a shaper of a square 1720 (e.g., an X-Y grid net) of two springs by two springs.

Reference is made to FIG. 18, which is a schematic top-view illustration of an injected plastic net 1800 in accordance with some demonstrative embodiments. As demonstrated, the net 1800 may include eight rows of springs; each row including six springs positioned one next to the other, such that a group of six adjacent springs has a shaper of a hexagon 1820 (e.g., a honeycomb net) of two springs over three springs over two springs. This may be achieved, for example, by shifting horizontally each row by a distance of half-a-spring relative to the row above it. It is noted that the X-Y grid net, and the honeycomb net, are presented for demonstrative purposes only; and other formations or structures may be used in accordance with some embodiments, for example, triangular structures, pentagon structures, or the like. In some embodiments, different types and shapes of springs (e.g., a triangular spring and a hexagon spring) may be assembled or combined to form a homogenous spring net, similar to multiple pieces forming a unified puzzle.

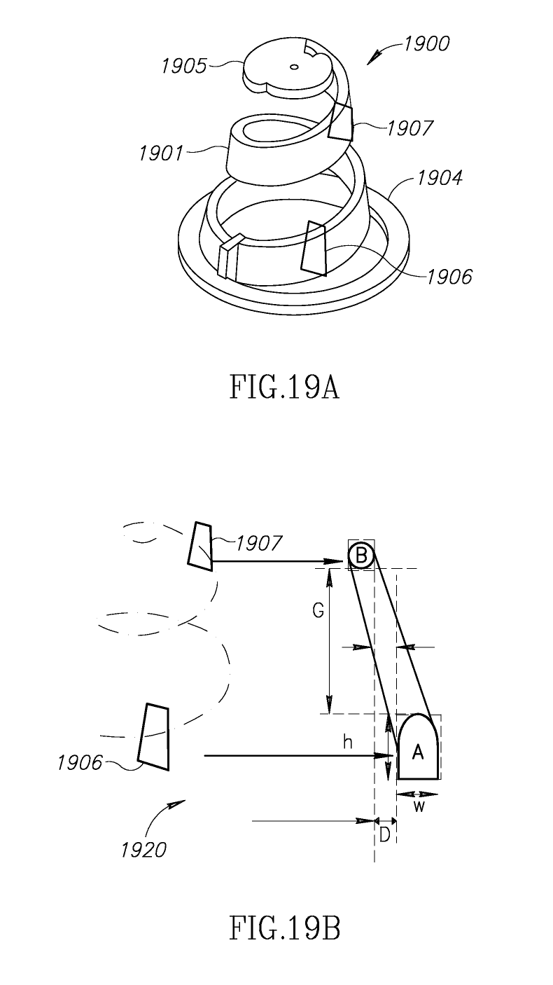

Reference is made to FIG. 19A, which is a schematic illustration of an injected plastic spring 1900 in accordance with some demonstrative embodiments. Spring 1900 may be formed of plastic material(s), and may be produced by injection molding of raw plastic material(s). Spring 1900 may be flexible and not entirely rigid, such that spring 1900 may compress, partially or entirely, upon application of force or pressure. Spring 1900 may include, for example, a single spiral helix 1901 made of plastic material(s). The single helix 1901 may spirally rise from a circular base 1904 towards an apex 1905 or other point or surface located at the top of spring 1900. For example, base 1904 may include a plastic member shaped as a circle, an oval, or other suitable shapes. In some embodiments, spring 1900 and its helix 1901 may have a form which may resemble a cone or pyramid or clipped-pyramid or clipped-cone or frustum or conical frustum or pyramidal frustum; for example, the helix 1901 may gradually taper smoothly from the circular base 1904 towards the apex 1905.

Sections 1906 and 1907 demonstrate the possible manipulating of spring behavior to different pressures types, which may be achieved by changing bottom and/or top sections the spring. Sections 1906 and 1907 may have different sizes and/or shapes, different height, different width, or different other properties. In some embodiments, thickness and/or interior resolution of each spring may be controlled, allowing fine-tuning each spring to adapt to the required resistance, for example, linearly or exponentially (e.g., soft in the beginning of the movement, and stiff in the end of the movement). In this regard, reference is also made to FIG. 19B, which is a schematic illustration of dimensions associated with the sections 1906 and 1907, in accordance with some demonstrative embodiments. For example, Section A and Section B may have different shapes and/or sizes; the arrow denoted “w” indicates section width; the arrow denoted “h” denotes section height; the arrows denoted “D” (density) and “G” indicate means for controlling thickness and interior resolution of each spring, thereby allowing fine-tuning of each spring to adopt to the required resistance, either linearly or exponentially (e.g., soft in the beginning of the movement and stiff or rigid in the end of the movement). Other suitable shapes or proportions may be used.

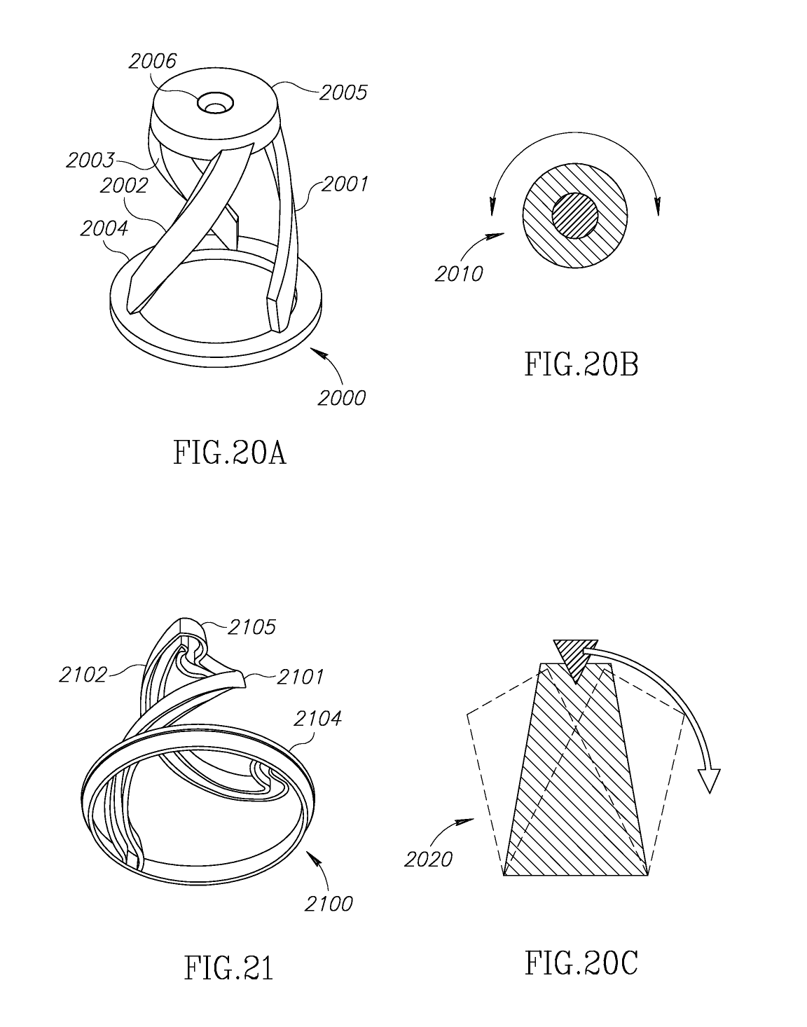

Reference is made to FIG. 20A, which is a schematic illustration of an injected plastic spring 2000 in accordance with some demonstrative embodiments. Spring 2000 may be formed of plastic material(s), and may be produced by injection molding of raw plastic material(s). Spring 2000 may be flexible and not entirely rigid, such that spring 2000 may compress, partially or entirely, upon application of force or pressure. Spring 2000 may include, for example, three spiral helixes 2001-2003 made of plastic material(s). The three helixes 2001-2003 may spirally rise from a circular base 2004 towards an apex 2005 or other point or surface or plate (e.g., circular plate) located at the top of spring 2000. For example, base 2004 may include a plastic member shaped as a circle, an oval, or other suitable shapes. In some embodiments, the triple-helix spring 2000 and its helixes 2001-2003 may have a form which may resemble a cone or pyramid or clipped-pyramid or clipped-cone or frustum or conical frustum or pyramidal frustum; for example, the helixes 2001-2003 may gradually taper smoothly from the circular base 2004 towards the apex 2005.

In some embodiments, the apex 2005 of top area of spring 2000 may include a centralization member 2006, which may be a point or a circular area, or a recess or crater, or a circular hole. The centralization member 2006 may provide hinge and fix rotation movement; when viewed from the top, the centralization member 2006 may centralize the rotational movement generated by pressure on the spring 2000; when viewed from the side, the centralization member 2006 may reduce or eliminate tilt by keeping the spring 2000 substantially centralized. Reference is also made to FIG. 20B, which is a schematic illustration of a top view of an apex 2010 of a spring; as well as to FIG. 20C, which is a schematic illustration of a side view of a spring 2020; both in accordance with some demonstrative embodiments. As demonstrated, in order to provide hinge and fix rotation movement, a centralization point may be used, similar to member 2006 of FIG. 20A. In some embodiments, FIG. 20B demonstrates centralizing of rotational movement generated by pressure on the spring; whereas FIG. 20C demonstrates eliminating or reducing of tilt by maintaining the spring centralized.

Reference is made to FIG. 21, which is a schematic illustration of an injected plastic spring 2100 in accordance with some demonstrative embodiments. Spring 2100 may be formed of plastic material(s), and may be produced by injection molding of raw plastic material(s). Spring 2100 may be flexible and not entirely rigid, such that spring 2100 may compress, partially or entirely, upon application of force or pressure. Spring 2100 may include, for example, two spiral helixes 2101-2102 made of plastic material(s). The two helixes 2101-2102 may spirally rise from a circular base 2104 towards an apex 2105 or other point or surface or plate (e.g., circular plate) located at the top of spring 2100. For example, base 2104 may include a plastic member shaped as a circle, an oval, or other suitable shapes. In some embodiments, the dual-helix spring 2100 and its helixes 2101-2102 may have a form which may resemble a cone or pyramid or clipped-pyramid or clipped-cone or frustum or conical frustum or pyramidal frustum; for example, the helixes 2101-2102 may gradually taper smoothly from the circular base 2104 towards the apex 2105. In some embodiments, stress concentration in the areas indicated by numerals 2101 and/or 2102 may be eliminated or reduced, for example, by local grooving of that area.

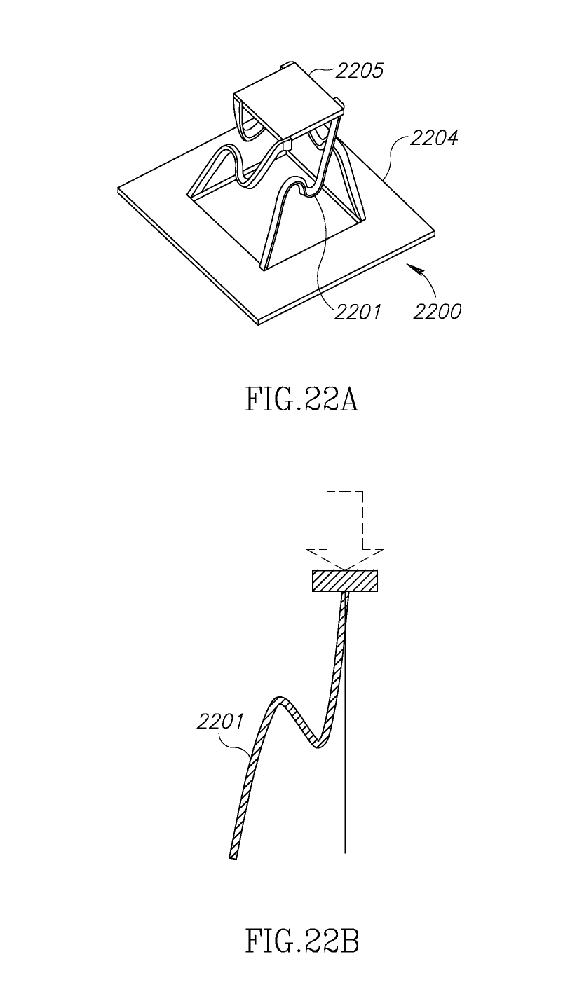

Reference is made to FIG. 22A, which is a schematic illustration of an injected plastic spring 2200 in accordance with some demonstrative embodiments. Spring 2200 may be formed of plastic material(s), and may be produced by injection molding of raw plastic material(s). Spring 2200 may be flexible and not entirely rigid, such that spring 2200 may compress, partially or entirely, upon application of force or pressure. Spring 2200 may include, for example, four fur supporting members 2201 or flexible sticks made of plastic material(s), for example, “Z”-shaped members, “S”-shaped members, “N”-shaped members, “5”-shaped members, “2”-shaped members, or the like. The four supporting members 2201 may rise or may spirally rise from a base 2204 towards an apex 2205 or other point or surface or plate (e.g., circular plate or square plate or rectangular plate) located at the top of spring 2200. For example, base 2204 may include a plastic member shaped as a circle, an oval, a square, a rectangle, or other suitable shapes. In some embodiments, the spring 2200 and its four supporting members 2204 may have a form which may resemble a cone or pyramid or clipped-pyramid or clipped-cone or frustum or conical frustum or pyramidal frustum; for example, the four supporting members 2204 may gradually taper smoothly from the base 2204 towards the apex 2205.

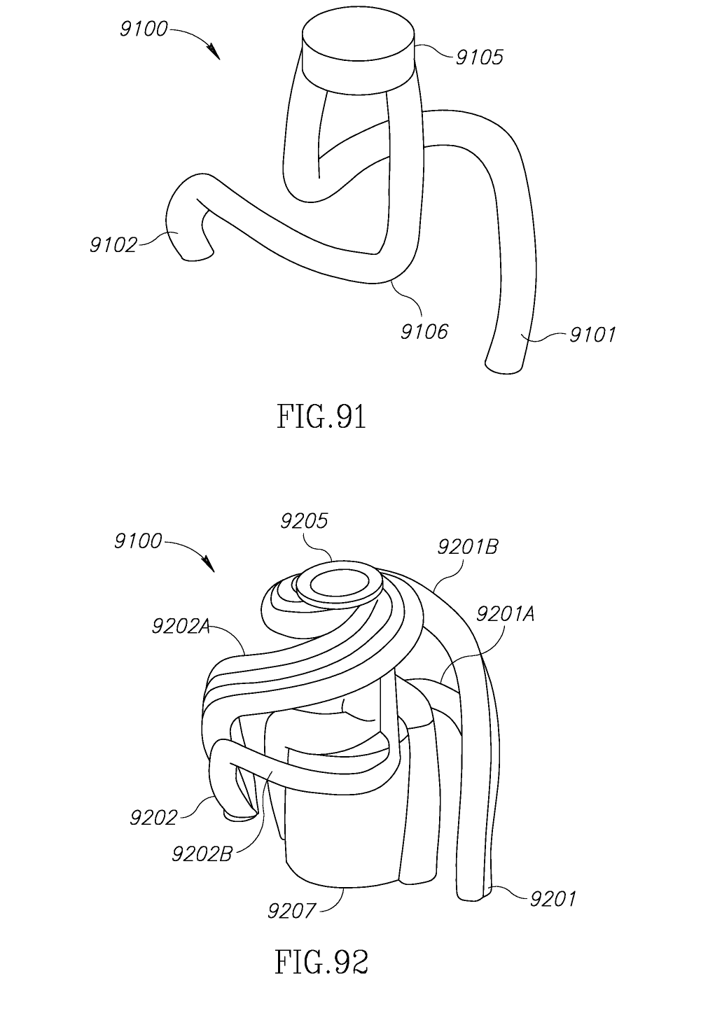

As demonstrated by supporting member 2201, each such supporting member (or spring leg) may be broken or twisted using one or several stress-absorbing joints. The shape or structure of such internal absorber of each leg may help fine-tuning the spring reaction to pressure, for example, starting as soft and gradually becoming more and more stiff or rigid. Similar stress-releasing joints are further demonstrated, for example, by element 9106 of FIG. 91. Such joints may serves the purpose of fine-tuning the surface reaction to different pressure types; for example, the hand touch will feel “soft” in the initial contact with the surface, and while seating the second absorber comes into action and handles the higher pressure and the need to absorb it. Reference is also made to FIG. 22B, which is a schematic illustration of a side-view of the supporting member 2201, relative to a vertically-applied force indicated by the arrow pointing downward.

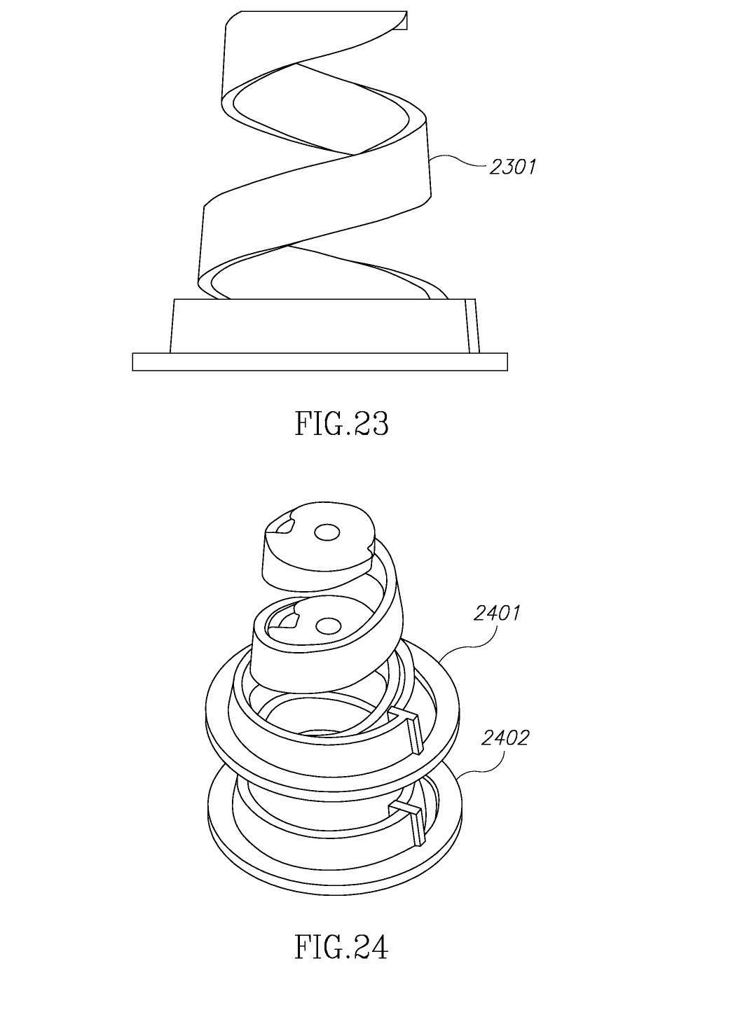

Reference is made to FIG. 23, which is a schematic illustration of an injected plastic spring 2301 in accordance with some demonstrative embodiments. Spring 2301 may be formed of plastic material(s), and may be produced by injection molding of raw plastic material(s). Spring 2301 may be flexible and not entirely rigid, such that spring 2301 may compress, partially or entirely, upon application of force or pressure. Spring 2301 may be, for example, a single-helix spring.

Reference is made to FIG. 24, which is a schematic illustration of two injected plastic springs 2401-2402 in accordance with some demonstrative embodiments. Each one of springs 2401-2402 may be substantially identical to spring 2301 of FIG. 23. Spring 2401 may be substantially identical to spring 2402. Springs 2401-2402 may be nested within each other, such that springs 2401-2402 share a partially-overlapping spatial area or volume, or such that spring 2402 is at least partially located or inserted within spring 2401 (or vice versa). In some embodiments, for example, springs 2401-2402 may be nested in order to reduce the volume required for storing, transporting, shipping, or otherwise handling springs 2401-2402. In some embodiments, similar nesting may be utilized in conjunction with other types or shapes of springs, or nets of springs.

This structure demonstrates the nesting; which may be achieved in substantially any conical spring design in some embodiments, regardless of the number of legs or supporting members which are combined in the process (the term “leg” referring to a supporting member or other connection between the base of the spring and the top of the spring). The leg cross section may be rectangle or circular, or it may be formed with any other suitable section as long as it serves as a connection between the top and bottom of the spring.

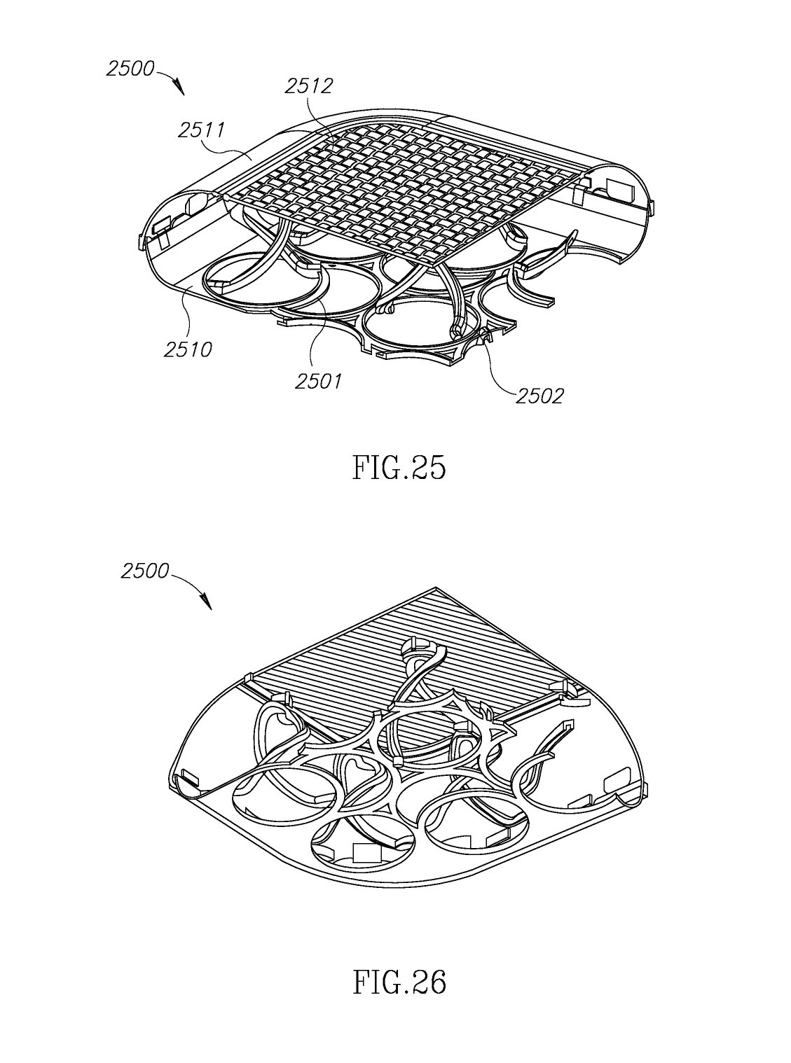

Reference is made to FIG. 25, which is a schematic illustration of a padding 2500 in accordance with some demonstrative embodiments; as well as to FIG. 26, which is a schematic illustration of another view of padding 2500 in accordance with some demonstrative embodiments. Padding 2500 may be formed, entirely or partially, of plastic material(s), and may be produced entirely or partially by injection molding of raw plastic material(s). Padding 2500 may be flexible and not entirely rigid, such that padding 2500 (or portions thereof) may compress, partially or entirely, upon application of force or pressure. Padding 2500 may include multiple springs, for example, denoted as springs 2501-2502, such that each spring may be formed of injected plastic material(s). The padding 2500 of multiple springs 2501-2502 may be manufactured as a single component; or, as multiple springs 2501-2502 which may be placed next to each other, assembled or glued or otherwise joined together, optionally joined with a tray or surface 2510. A top portion 2511 of padding 2500 may optionally include a region 2512 which may include fabric or fabric-less or fabric-like materials which are made by injection molding of plastic material(s), or rattan or rattan-like materials which are made by injection molding of plastic material(s).

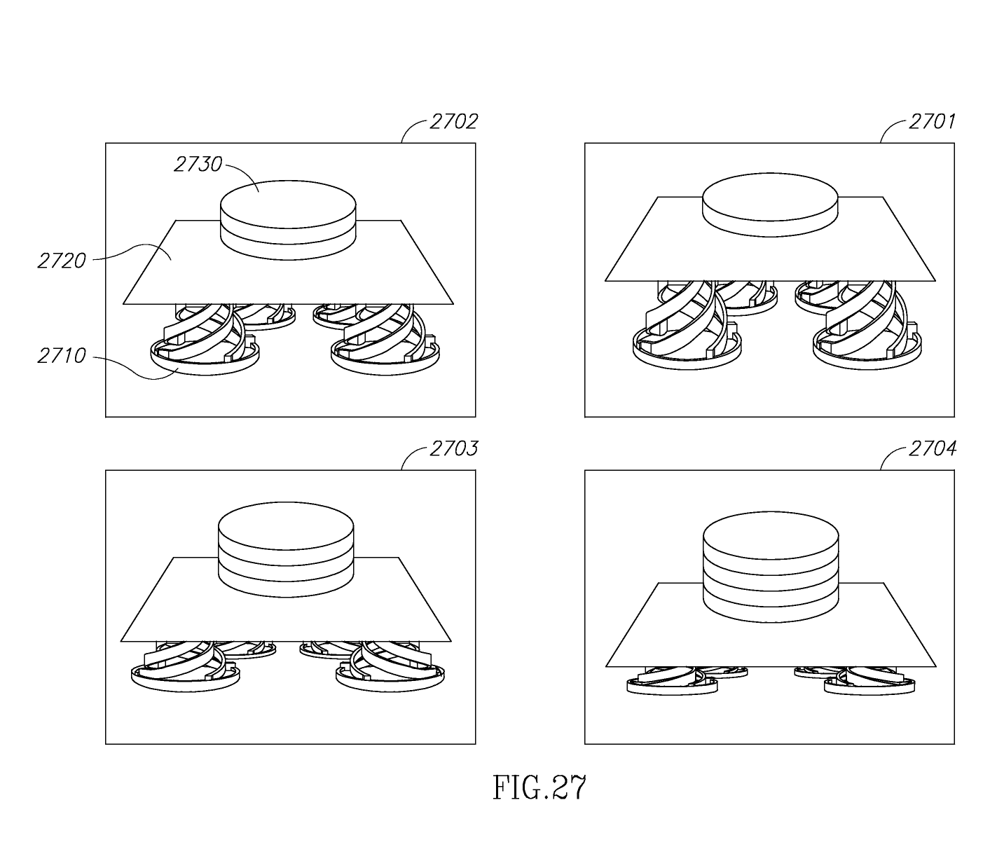

Reference is made to FIG. 27, which is a schematic illustration of four demonstrative positions 2701-2704 of a set of injection molding springs 2710 in accordance with some demonstrative embodiments. In each one of the four positions 2701-2704, a set of springs 2710 (for example, a set of four springs arranged as two rows by two columns, optionally interconnected or joined) is covered by a thin plane 2720 on which a set of weights 2730 is placed in order to apply pressure or force downward, thereby emulating or simulating pressure by a human body or finger or hand or other body organ, or by an inanimate object. In position 2701, the set of weights 2730 includes a single weight, and the set of springs 2710 supports the set of weights 2730 with substantially no compression or with only minimal compression. In position 2702, the set of weights 2730 includes two weights, and the set of springs 2710 supports the set of weights 2730 with noticeable compression (e.g., compression of approximately 33 or 40 or 50 percent). In position 2703, the set of weights 2730 includes three weights, and the set of springs 2710 supports the set of weights 2730 with significant compression (e.g., compression of approximately 60 or 66 or 75 percent). In position 2704, the set of weights 2730 includes four weights, and the set of springs 2710 supports the set of weights 2730 with substantially full compression (e.g., compression of approximately 85 or 90 percent). These positions 2701-2704 are for demonstrative purposes only, and other suitable weights and compression ratios may be used. In some embodiments, gradual control over the reaction of the spring(s) to pressure(s) may be achieved, for example, by setting or modifying the density or crowdedness of springs, the number of legs, the shapes of legs, the section of legs, or the like.

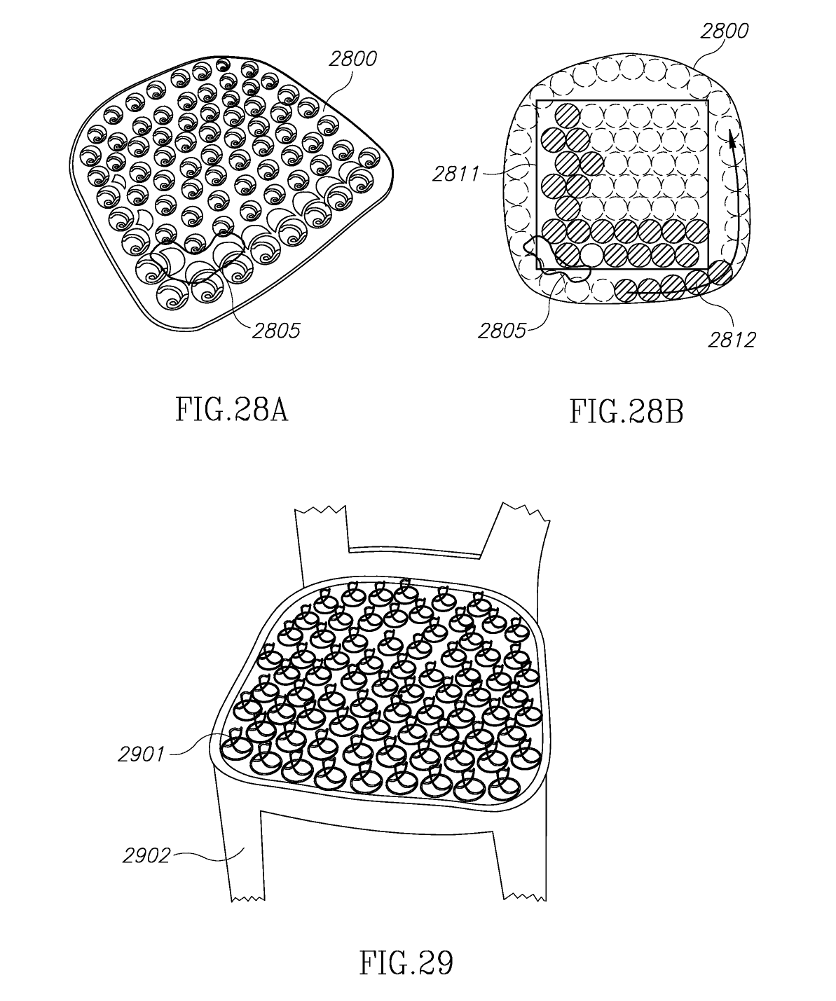

Reference is made to FIG. 28A, which is a schematic illustration of a padding 2800 in accordance with some demonstrative embodiments. Padding 2800 may be formed, entirely or partially, of plastic material(s), and may be produced entirely or partially by injection molding of raw plastic material(s). Padding 2800 may be flexible and not entirely rigid, such that padding 2800 (or portions thereof) may compress, partially or entirely or locally, upon application of force or pressure. Padding 2800 may include multiple springs, such that each spring may be formed of injected plastic material(s). The springs of padding 2800 may be formed an interconnected springs, or may be formed as separate springs and then may be interconnected or assembled or joined. Padding 2800 may be used, for example, as padding or seat or cushion of a chair or other furniture.

In some embodiments, the interconnection of springs into a net or padding may be based on linear or non-linear spring spread. In some embodiments, a net or padding may follow an X-Y grid pattern or a honeycomb pattern; or may utilize edge formulation to follow a non-linear (e.g., curved) edge of an area (e.g., an oval seat, or a seat having rounded corner areas). In some embodiments, the connection between different spring spreads may be designed to fine-tune surface behavior to overall padding needs whether it is to adopt surface curvature which are not flat, or adopting the human body shape. Region 2805 in FIG. 28A demonstrates the utilization of non-circular springs or connectors, for example, moon-shaped or semi-circular. Reference is also made to FIG. 28B, which is a schematic illustration of a top view of padding 2800, demonstrating edge formulation which follows a non-linear edge, in accordance with some demonstrative embodiments. Also demonstrated is the connection, in region 2805, between spring spread of a first type 2811 and spring spread of a second type 2812; the connection may fine-tune surface behavior to overall padding needs, to adopt surface curvature which are not flat, or for adopting the human body shape. In this regard, reference is also made to areas 5711 and 5712 of FIG. 58, demonstrating a side-view of the surface reaction to different pressure situations; for example, area 5712 demonstrates the edge formulation, whereas area 5711 demonstrates the connection between different spring spreads.

Reference is made to FIG. 29, which is a schematic illustration of a padding 2901 and a chair 2902 in accordance with some demonstrative embodiments. Padding 2901 may be similar or identical to padding 2800 of FIG. 28. Padding 2901 may be placed on chair 2902 (or on any other object designed to seat on or lean on), or may be integrated or embedded or glued or connected to chair 2902 or to other suitable furniture.

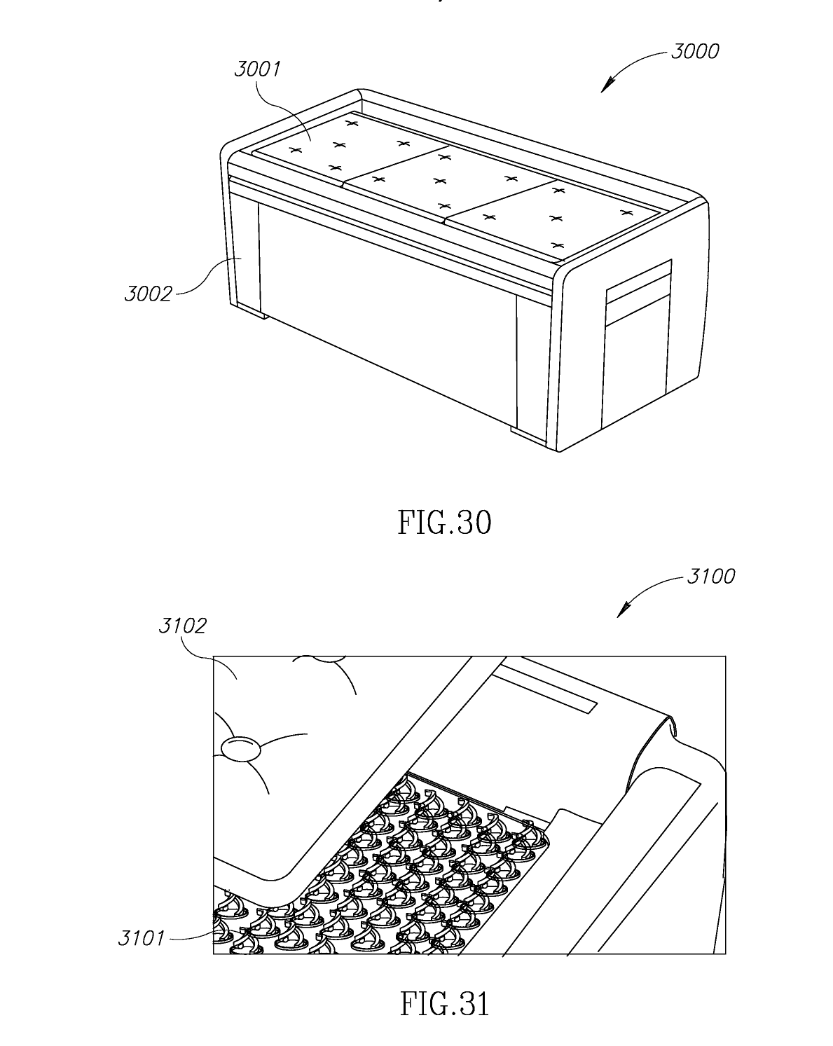

Reference is made to FIG. 30, which is a schematic illustration of a furniture article 3000 in accordance with some demonstrative embodiments. Furniture article 3000 may include, for example, a top member 3001 which may include therein a set of injection molding springs; and a bottom member 3002 which may include a platform, a base, a support member, or a hollow container or box. In some embodiments, the top member 3001 may be removable or may rotate on an axis in order to open the bottom member 3002 for storage.

Reference is made to FIG. 31, which is a schematic illustration of a portion 3100 of the furniture article 3000 in accordance with some demonstrative embodiments. As shown, a top member 3102 may include, or may cover, a layer of injection molding springs 3101 arranged as a net of springs, providing support, resistance and flexibility to the top member 3102 which may be in touch with a person's body or organ.

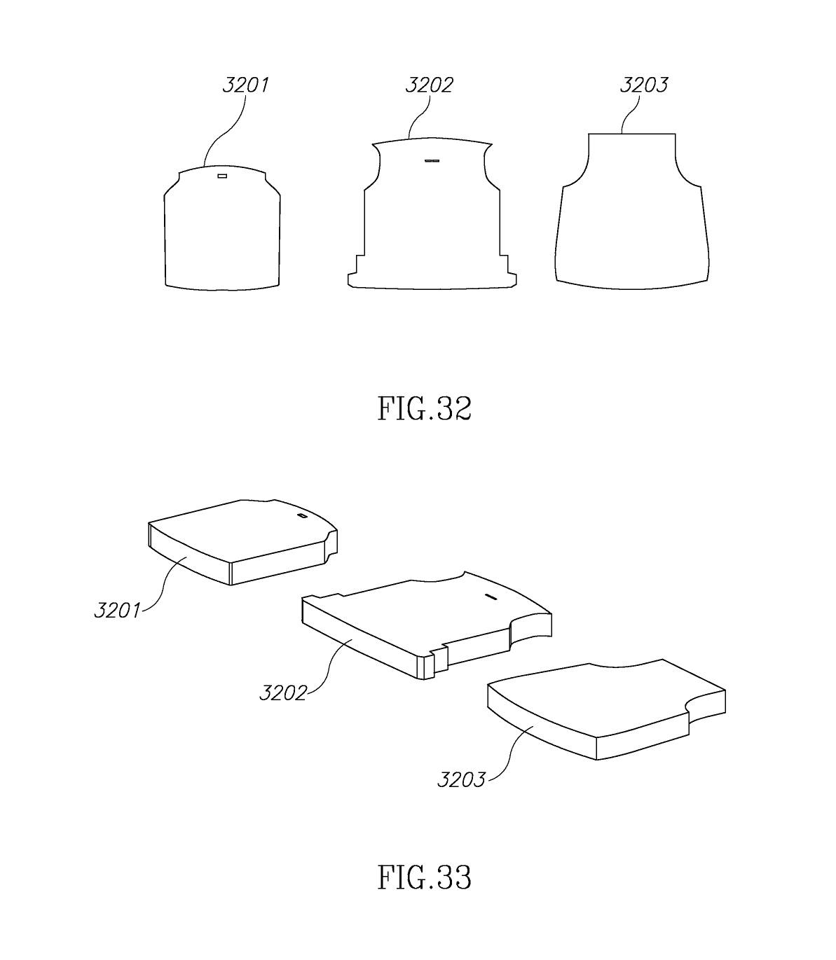

Reference is made to FIG. 32, which is a schematic illustration of side views of three padding units 3201-3203 in accordance with some demonstrative embodiments; as well as to FIG. 33, which is a schematic illustration of perspective views of three padding units 3201-3203 in accordance with some demonstrative embodiments. Each one of padding units 3201-3203 may include therein a set of springs made of injected molding of plastic material(s). Each one of padding unit 3201-3203 may have a contour, shape and/or dimensions adapted to fit or accommodate a corresponding furniture, for example, a chair, a seat, a sofa, a couch, or the like. In some embodiments, each one of padding units 3201-3203 may be implemented as springs-on-fabric-imitation, or a separate net, or springs on a base member.

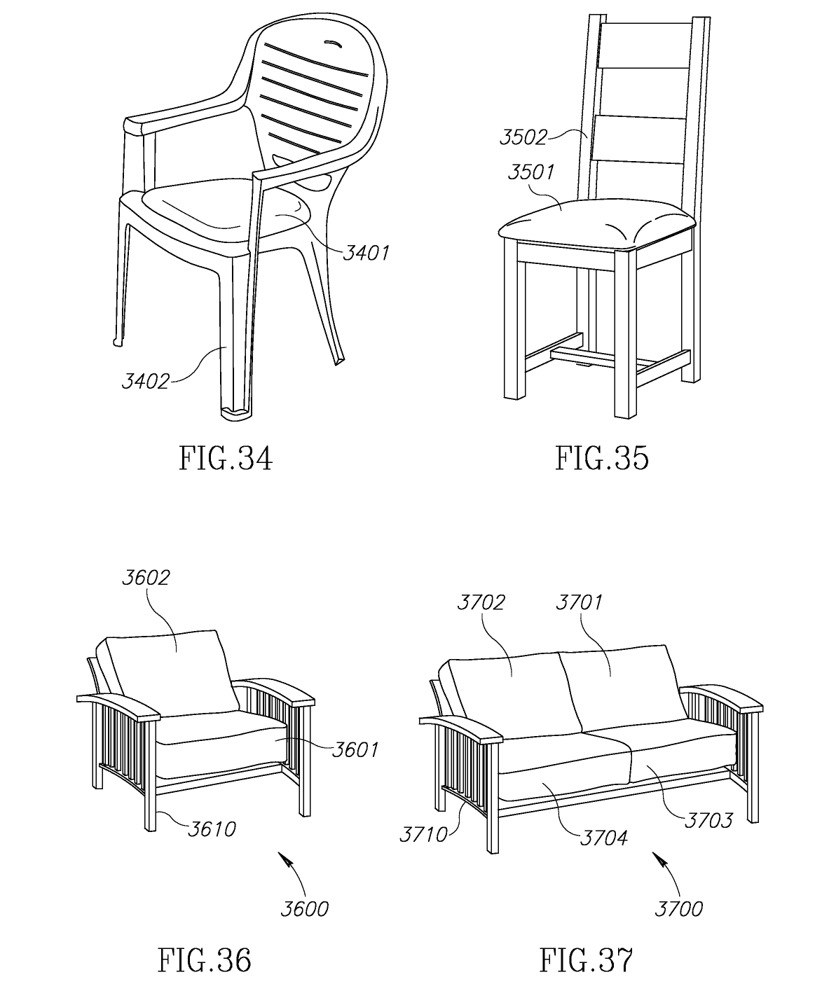

Reference is made to FIG. 34, which is a schematic illustration of a padding 3401 and a plastic chair 3402 in accordance with some demonstrative embodiments. Padding 3401 may include a net of springs formed by injection molding of plastic material(s). Padding 3401 may be placed on chair 3402, or may be integrated or embedded or glued or connected to chair 3402 or to other suitable furniture.

Reference is made to FIG. 35, which is a schematic illustration of a padding 3501 and a wooden chair 3502 in accordance with some demonstrative embodiments. Padding 3501 may include a net of springs formed by injection molding of plastic material(s). Padding 3501 may be placed on chair 3402, or may be integrated or embedded or glued or connected to chair 3502 or to other suitable furniture.

Reference is made to FIG. 36, which is a schematic illustration of an armchair 3600 in accordance with some demonstrative embodiments. Armchair 3600 may include, for example, a frame 3610 which may be formed of wood, plastic, metal, or other suitable materials. Armchair 3600 may further include, for example, a first padding member 3601 positioned horizontally to support a seating person; and a second padding member 3602 positioned vertically or diagonally or slanted to support the back and/or the head of a seating person. Each one of padding members 3601-3602 may include springs, or nets of springs, that are formed by injection molding of plastic material(s). In some embodiments, one of the padding members 3601-3602 may be more flexible or more supportive than the other padding members 3601-3602; for example, in some embodiments, the padding member 3601 directed for seating thereon may be more flexible than the padding member 3602, which may be more rigid or less flexible in order to provide support to the back of the seating person.

Reference is made to FIG. 37, which is a schematic illustration of a sofa 3700 in accordance with some demonstrative embodiments. Sofa 3600 may include, for example, a frame 3710 which may be formed of wood, plastic, metal, or other suitable materials. Sofa 3700 may further include, for example, a first set of padding members 3703-3704 positioned horizontally to support a seating person; and a second set of padding members 3701-3702 positioned vertically or diagonally or slanted to support the back and/or the head of a seating person. Each one of padding members 3701-3704 may include springs, or nets of springs, that are formed by injection molding of plastic material(s). In some embodiments, one or more of the padding members 3701-3704 may be more flexible or more supportive than the other one or more of the padding members 3701-3704; for example, in some embodiments, the padding member 3703 directed for seating thereon may be more flexible than the padding member 3703, which may be more rigid or less flexible in order to provide support to the back of the seating person.

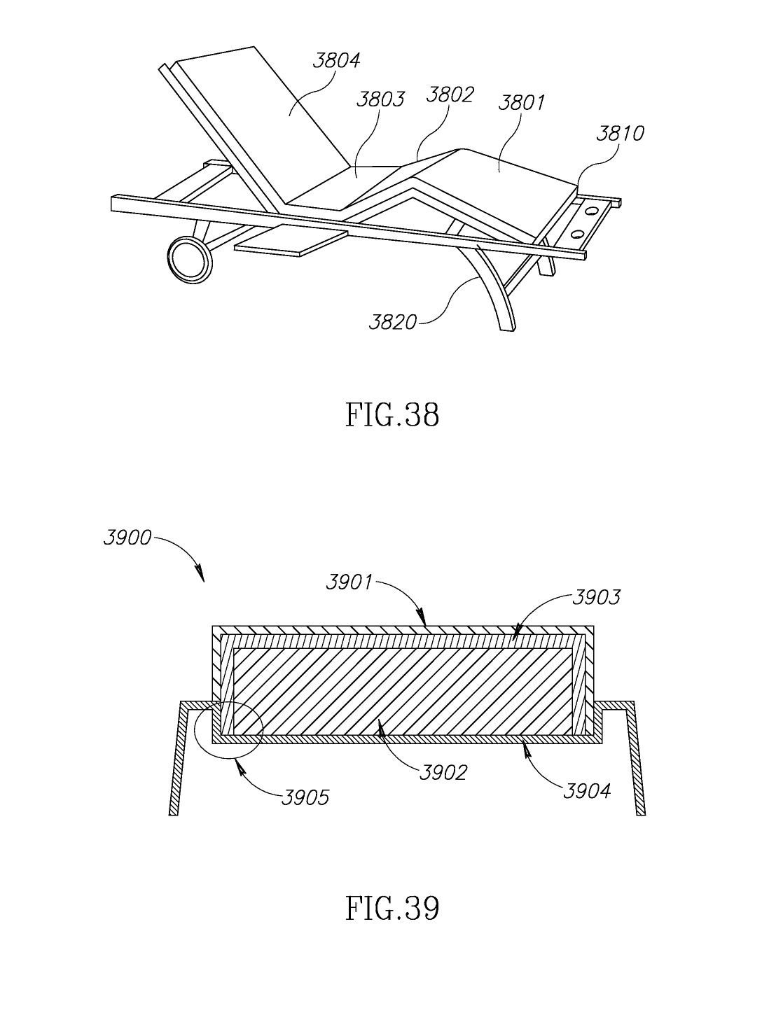

Reference is made to FIG. 38, which is a schematic illustration of a sunbed 3800 (or sun bed or tan bed) in accordance with some demonstrative embodiments. Sunbed 3800 may be or may include, for example, a beach bed, a poolside bed, a lounge bed, a deck bed, a “chaise longue”, a sun-tanning bed, a tanning bed, or the like. Sunbed 3800 may include, for example, a frame 3820 which may be formed of wood, plastic, metal, or other suitable materials. Sunbed 3800 may further include, for example, a padding member 3810 positioned to support the body of a lying person. The padding member 3810 may include multiple units padding units 3801-3804, each one optionally having a particular size and shape, each one adapted to support a different part of the body resting thereon (e.g., head, back, shoulders, legs, feet, etc); each one optionally having a different level of softness or flexibility or rigidness or support. Each one of padding units 3801-3804 may include springs, or nets of springs, that are formed by injection molding of plastic material(s). In some embodiments, one or more of the padding units 3801-3804 may be more flexible or more supportive than the other one or more of the padding units 3801-3804; for example, in some embodiments, the padding unit 3803 may be more flexible than the padding unit 3804 which may be more rigid or less flexible in order to provide support to the back of the lying person.

Reference is made to FIG. 39, which is a schematic side-view illustration of a padding 3900 in accordance with some demonstrative embodiments. Padding 3900 may be, for example, a part of a furniture article. Padding 3900 may include, for example: a covering fabric 3901 which may provide color and/or texture to the external side of padding 3900; a padding layer 3902 which may include multiple springs, or one or more nets of springs, such that the springs are formed by injected molding of plastic material(s); a shock absorbing layer 3903 to eliminate or reduce a feeling of “resolution” or movement or shaking which might be associated with springs; a base 3904, which may be rigid or flexible or rigid-flex and may provide support to the layers above it or adjacent to it. An area denoted 3905 (or, in some embodiments, an area which may be larger than area 3905 and which may extend upwards in this Figure) indicates that a particular type of weaving or stitching or sewing may be used in order to connect together and/or conceal some or all of the layers of padding 3900. The base 3904 may support one or more other layers, for example, from the bottom and partially from the right and left sides. The covering fabric 3901 may include fabric, or non-fabric material(s), or fabric-like material(s), or rattan-like materials, or one or more layers formed of injection molding of plastic material(s).

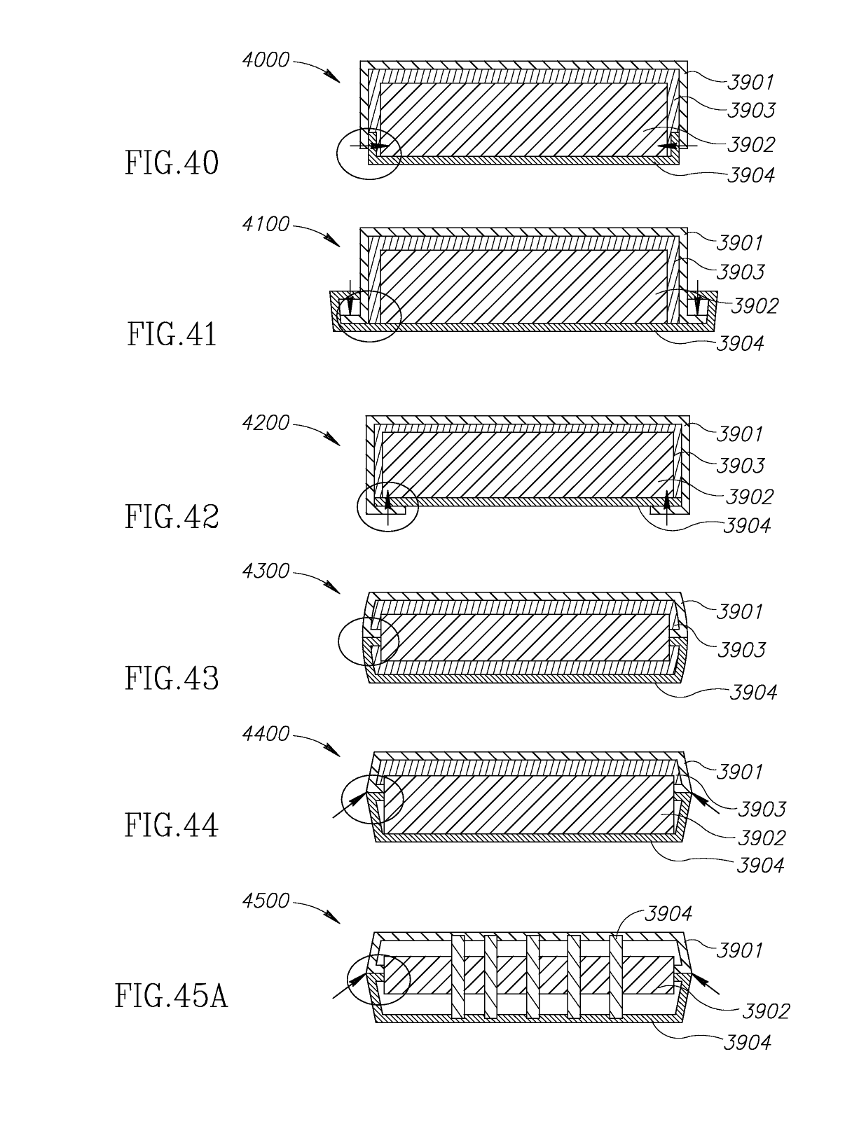

Reference is made to FIG. 40, which is a schematic side-view illustration of a padding 4000 in accordance with some demonstrative embodiments. Padding 4000 may be, for example, a part of a furniture article. Padding 4000 may include, for example: covering fabric 3901, padding layer 3902, shock absorbing layer 3903, and base 3904. In some embodiments, for example, base 3904 may be partially inserted between the covering fabric 3901 and the padding layer 3902.

Reference is made to FIG. 41, which is a schematic side-view illustration of a padding 4100 in accordance with some demonstrative embodiments. Padding 4100 may be, for example, a part of a furniture article. Padding 4100 may include, for example: covering fabric 3901, padding layer 3902, shock absorbing layer 3903, and base 3904. In some embodiments, for example, base 3904 may be partially bend outwardly to trap or cover a portion of the covering fabric 3901.

Reference is made to FIG. 42, which is a schematic side-view illustration of a padding 4200 in accordance with some demonstrative embodiments. Padding 4200 may be, for example, a part of a furniture article. Padding 4200 may include, for example: covering fabric 3901, padding layer 3902, shock absorbing layer 3903, and base 3904. In some embodiments, for example, the covering fabric 3901 may be partially bend outwardly to trap or cover a portion of the base 3904.

Reference is made to FIG. 43, which is a schematic side-view illustration of a padding 4300 in accordance with some demonstrative embodiments. Padding 4300 may be, for example, a part of a furniture article. Padding 4300 may include, for example: covering fabric 3901, padding layer 3902, and shock absorbing layer 3903. In some embodiments, for example, the covering fabric 3901 may entirely encapsulate the shock absorbing layer 3903, which in turn may entirely encapsulate the padding layer 3902.

Reference is made to FIG. 44, which is a schematic side-view illustration of a padding 4400 in accordance with some demonstrative embodiments. Padding 4400 may be, for example, a part of a furniture article. Padding 4400 may include, for example: covering fabric 3901, padding layer 3902, shock absorbing layer 3903, and base 3904. In some embodiments, for example, the covering fabric 3901 may cover the top of padding 4400 and approximately the top half of the side panels of padding 4400; whereas the base may cover the bottom of padding 4400 and approximately the bottom half of the side panels of padding 4400.

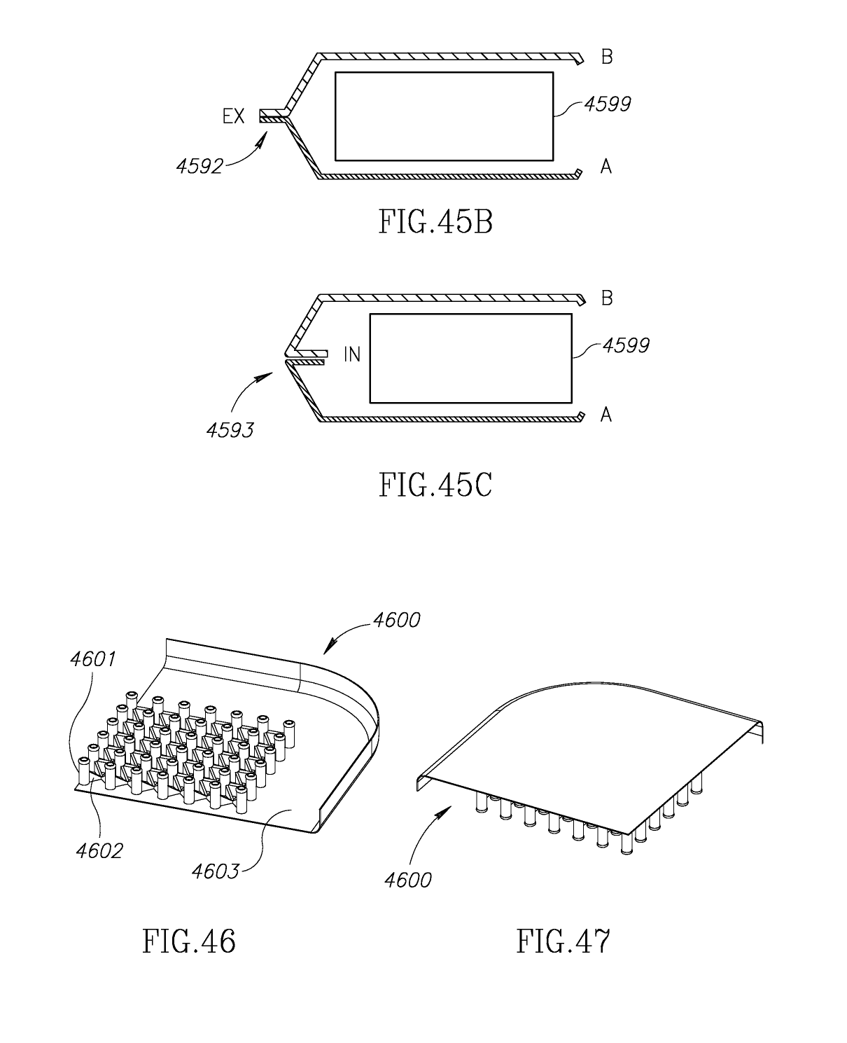

Reference is made to FIG. 45A, which is a schematic side-view illustration of a padding 4500 in accordance with some demonstrative embodiments. Padding 4500 may be, for example, a part of a furniture article. Padding 4500 may include, for example: covering fabric 3901, padding layer 3902, and base 3904. Padding 4500 may be similar to padding 4300, but instead of utilizing the shock absorbing layer 3903 (or in addition to it), one or more other shock absorbing members 3906 may be used.

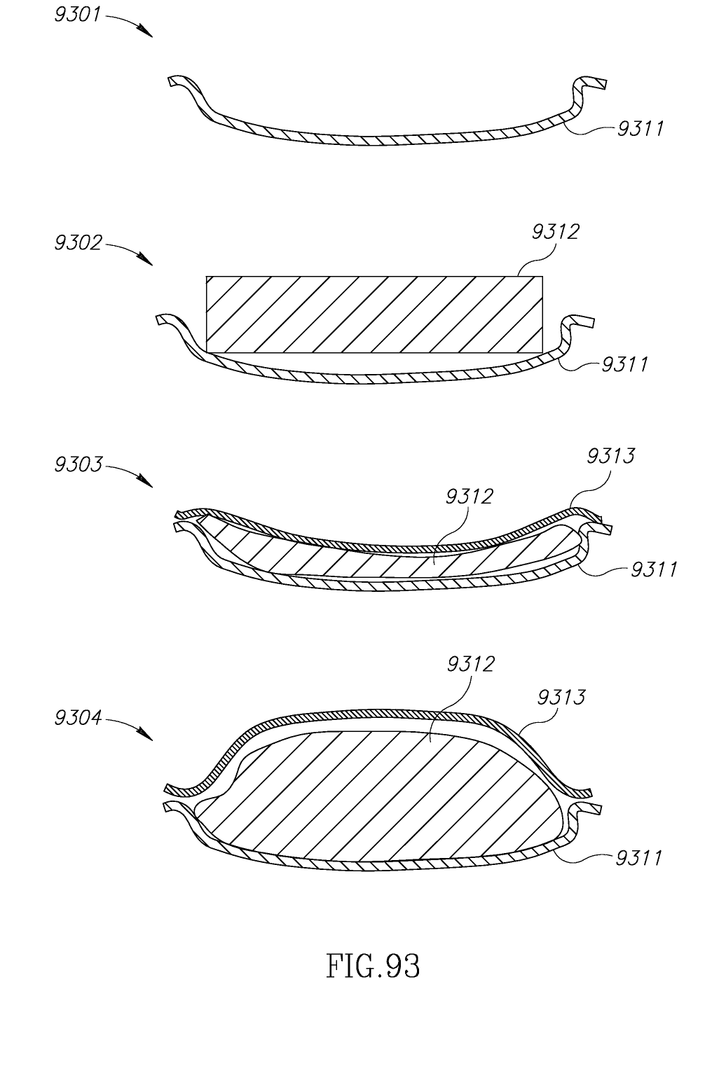

Reference is made to FIG. 45B, which is a schematic illustration of an external joint 4592 or external welding arrangement (denoted “EX”), in accordance with some demonstrative embodiments; as well as to FIG. 45C, which is a schematic illustration of an internal joint 4593 or internal welding arrangement (denoted “IN”), in accordance with some demonstrative embodiments. In some embodiments, the welding of two members A and B may be achieved by utilizing double injection; for example, member A which is cold is placed in the mold; a foam or form-like material may be placed over member A; and member B is injected on the edges while facing one another; the material is melted locally allowing members A and B to bond. In other embodiments, members A and B are positioned in a welding device after injection, allowing them to cool after ejection from the mold. Other suitable processes may be used; for example, as demonstrated in FIG. 93 herein.

Reference is made to FIG. 46, which is a schematic exploded bottom-view illustration of a padding 4600 in accordance with some demonstrative embodiments; as well as to FIG. 47, which is a schematic exploded top-view illustration of the padding 4600. Padding 4600 may be, for example, a part of a furniture article. Padding 4600 may include, for example: a tray 4603 or other semi-flexible or flexible layer, from which multiple flexible ribs 4601 or tubes may protrude. The ribs 4601 may be flexible or semi-flexible, and may be arranged in a matrix or array of rows and columns. The ribs 4601 may optionally be interconnected using connecting members 4602, which may be, for example, “X”-shaped or cross-shaped. In some embodiments, the tray 4603 may be formed by injection molding of plastic material(s); and/or the ribs 4601 may be formed by injection molding of plastic material(s); and/or the connecting members 4602 may be formed by injection molding of plastic material(s).

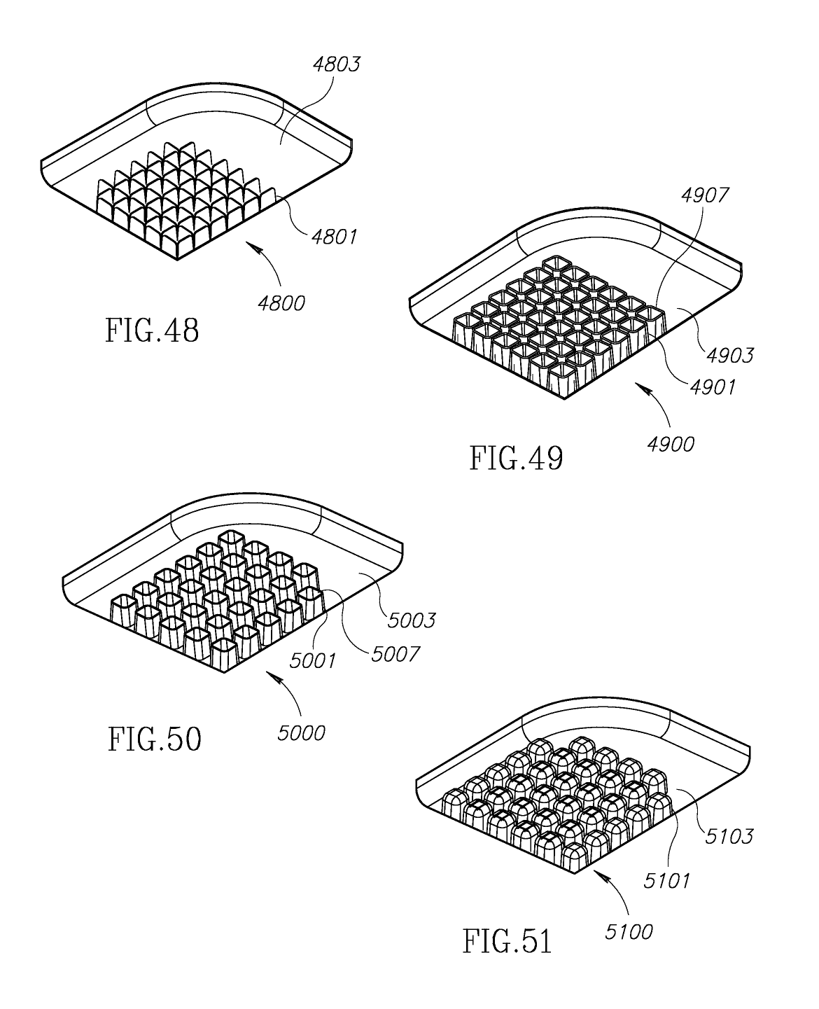

Reference is made to FIG. 48, which is a schematic exploded illustration of a padding 4800 in accordance with some demonstrative embodiments. Padding 4800 may be, for example, a part of a furniture article. Padding 4800 may include, for example: a tray 4803 or other semi-flexible or flexible layer, from which multiple flexible ribs 4801 may protrude. The ribs 4801 may be flexible or semi-flexible, and may be arranged in a matrix or array of rows and columns. The ribs 4801 may be, for example, “X”-shaped or cross-shaped. In some embodiments, the tray 4803 may be formed by injection molding of plastic material(s); and/or the ribs 4801 may be formed by injection molding of plastic material(s).

Reference is made to FIG. 49, which is a schematic exploded illustration of a padding 4900 in accordance with some demonstrative embodiments. Padding 4900 may be, for example, a part of a furniture article. Padding 4900 may include, for example: a tray 4903 or other semi-flexible or flexible layer, from which multiple flexible tubes 4901 may protrude. The tubes 4901 may be flexible or semi-flexible, and may be arranged in a matrix or array of rows and columns. The tubes 4901 may be, for example, hollow cylinders or pipes or frustums or pyramids or chopped-pyramids or chopped-frustums having a circular cross-section, a rectangular cross-section, an “O”-shaped cross-section, a square cross-section, or the like. In some embodiments, the tray 4903 may be formed by injection molding of plastic material(s); and/or the tubes 4901 may be formed by injection molding of plastic material(s). In some embodiments, the tubes 4901 may have a significant wall-thickness 4907 or relatively thick walls; e.g., having wall thickness of approximately 10 or 15 or 20 percent of the surface of the cross-section of tubes 4901.

Reference is made to FIG. 50, which is a schematic exploded illustration of a padding 5000 in accordance with some demonstrative embodiments. Padding 5000 may be, for example, a part of a furniture article. Padding 5000 may include, for example: a tray 5003 or other semi-flexible or flexible layer, from which multiple flexible tubes 5001 may protrude. The tubes 5001 may be flexible or semi-flexible, and may be arranged in a matrix or array of rows and columns. The tubes 5001 may be, for example, hollow cylinders or pipes or frustums or pyramids or chopped-pyramids or chopped-frustums having a circular cross-section, a rectangular cross-section, an “O”-shaped cross-section, a square cross-section, or the like. In some embodiments, the tray 5003 may be formed by injection molding of plastic material(s); and/or the tubes 5101 may be formed by injection molding of plastic material(s). In some embodiments, the tubes 5001 may have a minimal wall-thickness 5007 or relatively thin walls; e.g., having wall thickness of approximately 1 or 2 or 5 percent of the surface of the cross-section of tubes 5001.

Reference is made to FIG. 51, which is a schematic exploded illustration of a padding 5100 in accordance with some demonstrative embodiments. Padding 5100 may be, for example, a part of a furniture article. Padding 5100 may include, for example: a tray 5103 or other semi-flexible or flexible layer, from which multiple flexible domes 5101 may protrude. The domes 5101 may be flexible or semi-flexible, and may be arranged in a matrix or array of rows and columns. The domes 5101 may be, for example, hollow cylinders or pipes or frustums or pyramids or chopped-pyramids or chopped-frustums having a circular cross-section, a rectangular cross-section, an “O”-shaped cross-section, a square cross-section, or the like; which may be covered by a semi-sphere or a plain or other cover or lead. In some embodiments, the tray 5103 may be formed by injection molding of plastic material(s); and/or the domes 5101 may be formed by injection molding of plastic material(s). In some embodiments, the domes 5101 may have a minimal wall-thickness or relatively thin walls; e.g., having wall thickness of approximately 1 or 2 or 5 percent of the surface of the cross-section of domes 5101. In other embodiments, the domes 5101 may have a significant wall-thickness or relatively thick walls; e.g., having wall thickness of approximately 10 or 15 or 20 percent of the surface of the cross-section of domes 5101.

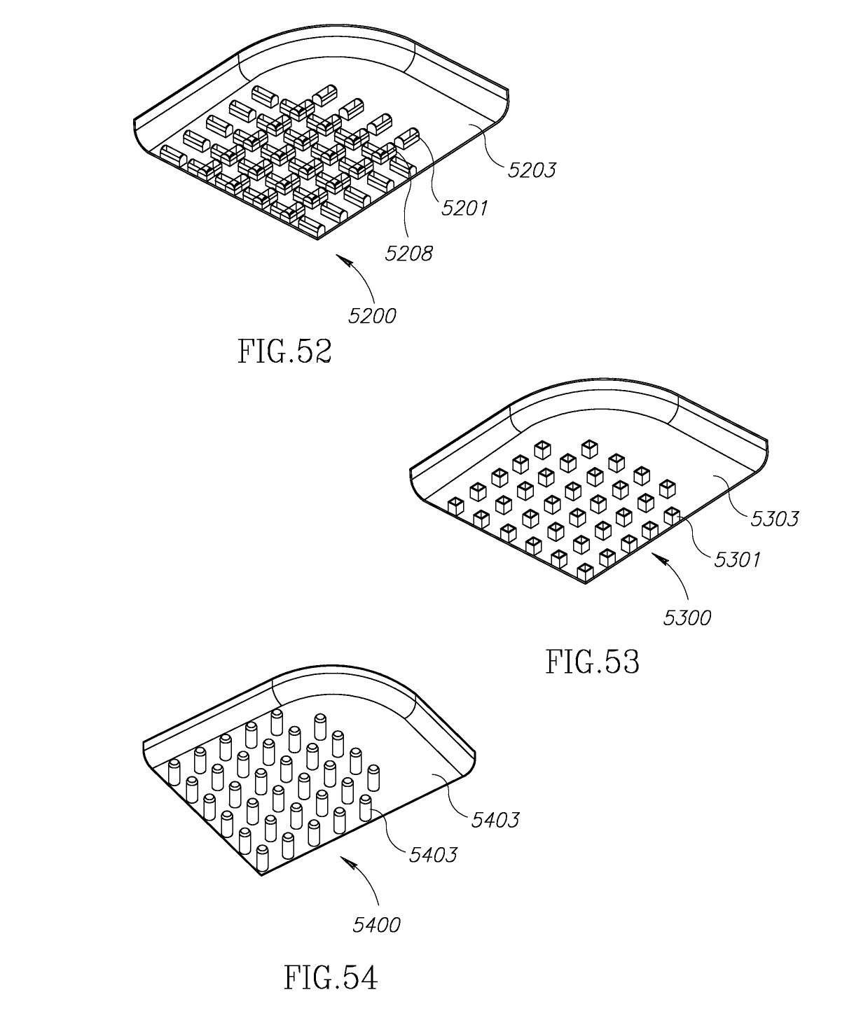

Reference is made to FIG. 52, which is a schematic exploded illustration of a padding 5200 in accordance with some demonstrative embodiments. Padding 5200 may be, for example, a part of a furniture article. Padding 5200 may include, for example: a tray 5203 or other semi-flexible or flexible layer, from which multiple flexible ribs or prisms 5201 may protrude. The prisms 5201 may be flexible or semi-flexible, and may be arranged in a matrix or array of rows and columns, or in an “L”-shaped formation 5208. The prisms 5201 may be, for example, hollow prisms or cylinders or pipes or frustums or pyramids or chopped-pyramids or chopped-frustums having a circular cross-section, a rectangular cross-section, an “O”-shaped cross-section, a square cross-section, or the like. In some embodiments, the tray 5203 may be formed by injection molding of plastic material(s); and/or the prisms 5201 may be formed by injection molding of plastic material(s). In some embodiments, the prisms 5201 may have a minimal wall-thickness or relatively thin walls; e.g., having wall thickness of approximately 1 or 2 or 5 percent of the surface of the cross-section of prisms 5201.

Reference is made to FIG. 53, which is a schematic exploded illustration of a padding 5300 in accordance with some demonstrative embodiments. Padding 5300 may be, for example, a part of a furniture article. Padding 5300 may include, for example: a tray 5303 or other semi-flexible or flexible layer, from which multiple flexible tubes 5301 may protrude. The tubes 5301 may be flexible or semi-flexible, and may be arranged in a matrix or array of rows and columns. The tubes 5301 may be spaced apart; such that a tube 5301 may not touch its neighboring or adjacent tube(s). The tubes 5301 may be, for example, hollow cylinders or pipes or frustums or pyramids or chopped-pyramids or chopped-frustums having a circular cross-section, a rectangular cross-section, an “O”-shaped cross-section, a square cross-section, or the like. In some embodiments, the tray 5303 may be formed by injection molding of plastic material(s); and/or the tubes 5301 may be formed by injection molding of plastic material(s). In some embodiments, the tubes 5301 may have a minimal wall-thickness or relatively thin walls; e.g., having wall thickness of approximately 1 or 2 or 5 percent of the surface of the cross-section of tubes 5301.

Reference is made to FIG. 54, which is a schematic exploded illustration of a padding 5400 in accordance with some demonstrative embodiments. Padding 5400 may be, for example, a part of a furniture article. Padding 5400 may include, for example: a tray 5403 or other semi-flexible or flexible layer, from which multiple flexible tubes 5401 may protrude. The tubes 5401 may be flexible or semi-flexible, and may be arranged in a matrix or array of rows and columns. The tubes 5401 may be spaced apart; such that a tube 5401 may not touch its neighboring or adjacent tube(s). The tubes 5401 may be open on one side, or may be closed (e.g., by a cover, a dome, or a plane). The tubes 5401 may be, for example, hollow cylinders or pipes or frustums or pyramids or chopped-pyramids or chopped-frustums having a circular cross-section, a rectangular cross-section, an “O”-shaped cross-section, a square cross-section, or the like. In some embodiments, the tray 5403 may be formed by injection molding of plastic material(s); and/or the tubes 5401 may be formed by injection molding of plastic material(s). In some embodiments, the tubes 5401 may have a minimal wall-thickness or relatively thin walls; e.g., having wall thickness of approximately 1 or 2 or 5 percent of the surface of the cross-section of tubes 5401.

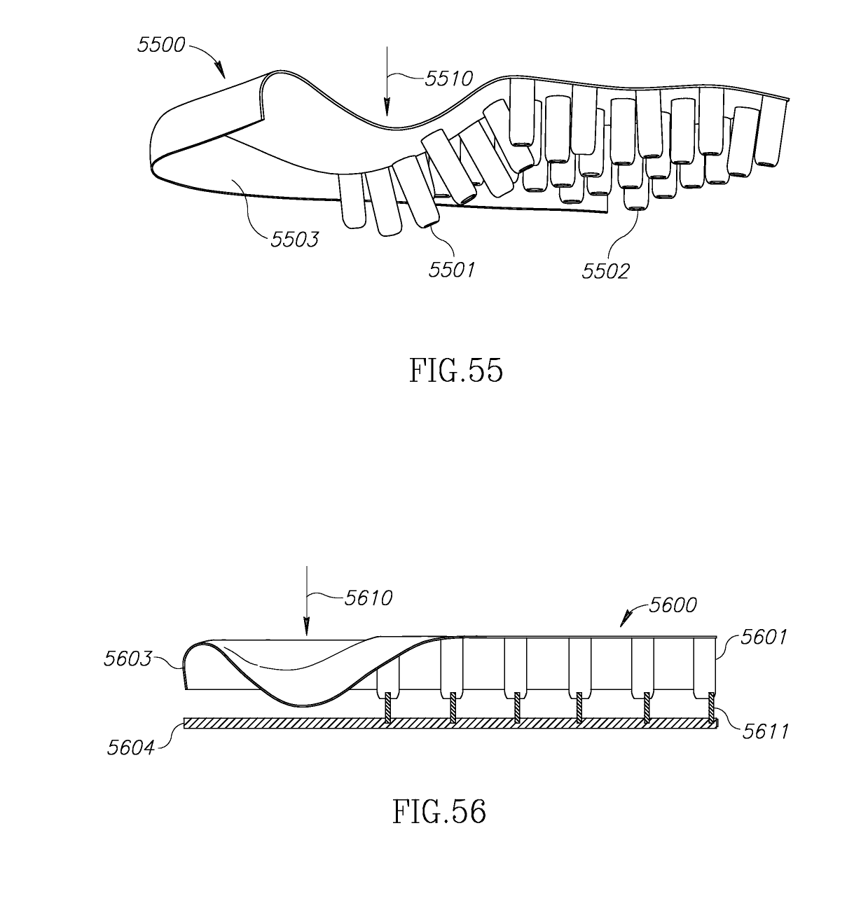

Reference is made to FIG. 55, which is a schematic exploded illustration of a padding 5500 in accordance with some demonstrative embodiments. Padding 5500 may be, for example, a part of a furniture article. Padding 5500 may include, for example: a tray 5503 or other semi-flexible or flexible layer, from which multiple flexible tubes 5501-5502 may protrude. The tubes 5501-5502 may be flexible or semi-flexible, and may be arranged in a matrix or array of rows and columns. The tubes 5501-5502 may be spaced apart; such that a tube 5401 may not touch its neighboring or adjacent tube(s). The tubes 5501-5502 may be open on one side, or may be closed (e.g., by a cover, a dome, or a plane). The tubes 5501-5502 may be, for example, hollow cylinders or pipes or frustums or pyramids or chopped-pyramids or chopped-frustums having a circular cross-section, a rectangular cross-section, an “O”-shaped cross-section, a square cross-section, or the like. In some embodiments, the tray 5503 may be formed by injection molding of plastic material(s); and/or the tubes 5501-5502 may be formed by injection molding of plastic material(s). A force, indicated by an arrow 5510, may be applied onto the padding 5500, for example, by a person seating on padding 5500. In some embodiments, the application of the force may cause one or more of the tubes (e.g., tube 5501) to change its orientation to be diagonal or slanted; whereas the application of the force may not affect one or more other tubes (e.g., tube 5502). In other embodiments, padding 5500 may be adapted to avoid, eliminate or reduce the change in orientation of one or more tubes 5501-5502 upon application of force thereto, for example, as discussed herein. In some embodiments, padding 5500 may include air cavities or air pockets (e.g., in the area adjacent to the upper end of the pointer denoted 5503), which may be used as softer regions, or to provide a softer feeling upon touching, or to accumulate air by inflation upon seating on another region of the padding 5500 (e.g., the central region of padding 5500), or for filling with another filler or foam (e.g., PU foam).

Reference is made to FIG. 56, which is a schematic exploded illustration of a padding 5600 in accordance with some demonstrative embodiments. Padding 5600 may be, for example, a part of a furniture article. Padding 5600 may include, for example: a first tray 5603 or other semi-flexible or flexible layer, from which multiple flexible tubes 5601 may protrude; and a second tray 5604 or other flexible or rigid layer from which multiple supporting members or stabilizers 5611 may protrude. The tubes 5601 may be flexible or semi-flexible, and may be arranged in a matrix or array of rows and columns; whereas the stabilizers may be rigid or substantially rigid, or may be flexible yet less flexible than the tubes 5601. In some embodiments, each stabilizer 5611 may support or hold a corresponding tube 5601; in other embodiments, a stabilizer 5611 may extend to support two or more tubes 5601, or a set of tubes 5601. The tubes 5601 may be spaced apart; such that a tube 5601 may not touch its neighboring or adjacent tube(s). The stabilizers 5611 may be spaced apart; such that a stabilizer 5611 may not touch its neighboring or adjacent stabilizer(s). The tubes 5601 may be, for example, hollow cylinders or pipes or frustums or pyramids or chopped-pyramids or chopped-frustums having a circular cross-section, a rectangular cross-section, an “O”-shaped cross-section, a square cross-section, or the like. The stabilizers 5611 may partially or slightly penetrate into the corresponding tubes 5601; or, the stabilizers 5611 may touch but not penetrate into the corresponding tubes 5601. In some embodiments, the tray 5603 and/or the tray 5604 may be formed by injection molding of plastic material(s); and/or the tubes 5601 may be formed by injection molding of plastic material(s); and/or the stabilizers 5611 may be formed by injection molding of plastic material(s). A force, indicated by an arrow 5610, may be applied onto the padding 5600, for example, by a person seating on padding 5600. In some embodiments, the application of the force may not cause one or more of the tubes 5601 to change its orientation to be diagonal or slanted. In some embodiments, for example, stabilizers 5611 may avoid, eliminate or reduce the change in orientation of one or more tubes 5601 upon application of force to the padding 5600, and may thus contribute to an enhanced feeling of support provided by the padding 5600 to a person seating thereon. In some embodiments, padding 5600 may include air cavities or air pockets (e.g., in the area adjacent to the lower end of arrow 5610), which may be used as softer regions, or to provide a softer feeling upon touching, or to accumulate air by inflation upon seating on another region of the padding 5600, or for filling with another filler or foam (e.g., PU foam).

Reference is made to FIGS. 57-59, which are schematic illustrations of a padding 5700 in accordance with some demonstrative embodiments. Padding 5700 may be, for example, a part of a furniture article. Padding 5700 may include, for example, a set of flexible springs or tubes 5701, which are illustrated only schematically and which may have other shapes or structures (e.g., conical, pyramid shape, cylinder shaper, helix(es) based springs, multi-layer springs, or the like). The springs or tubes 5701 be flexible or semi-flexible, and may be arranged in a matrix or array of rows and columns. The springs or tubes 5701 may optionally be spaced apart; such that a tube 5401 may not touch its neighboring or adjacent tube(s). Padding 5700 is shown in three positions. In FIG. 57, the padding 5700 is shown in a relaxed or rested position in which substantially no force is applied thereto, such that springs or tubes 5701 are relaxed and non-compressed. In FIG. 58, the padding 5700 is shown in a partially compressed position in which a slight force is applied thereto, such that springs or tubes 5701 are not compressed or are only slightly compressed; whereas padding 5700 may change its curvature or may bend in response to the applied force. In FIG. 59, the padding 5700 is shown in a compressed position in which a greater force is applied thereto, such that springs or tubes 5701 are compressed; as shown, various springs or tubes 5701 may compress more, or less, than neighboring springs or tubes 5701, in response to the application of force, and optionally as a function of their distance from the point or surface on which the force is applied. In some embodiments, edges or arcs of the padding 5700 may bend, curve, or otherwise change their position or curvature upon application of force to padding 5700.

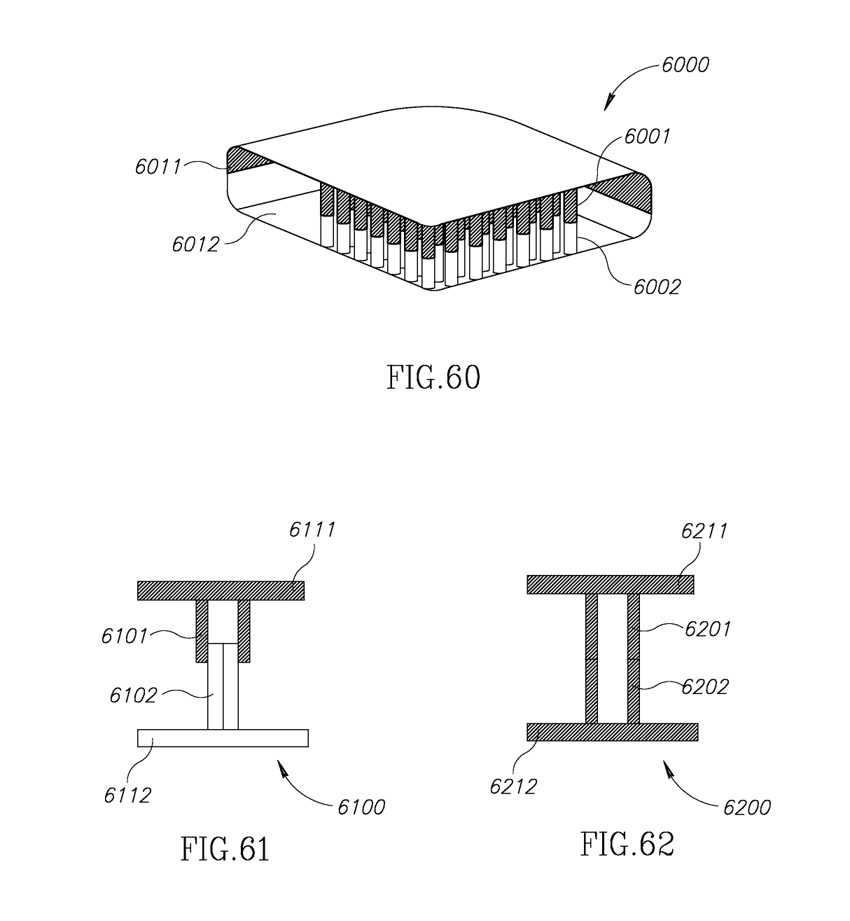

Reference is made to FIG. 60, which is a schematic exploded illustration of a padding 6000 in accordance with some demonstrative embodiments. Padding 6000 may be, for example, a part of a furniture article. Padding 6000 may include, for example: a first tray 6011 or other semi-flexible or flexible layer, from which multiple flexible tubes 6001 may protrude; and a second tray 6012 or other flexible or rigid layer from which multiple tubes 6002 may protrude. The tubes 6001-6002 may be flexible or semi-flexible, and may be arranged in a matrix or array of rows and columns. In some embodiments, each bottom-side tube 6002 may support or hold or touch or partially penetrate a corresponding top-side tube 6001. The tubes 6001 may optionally be spaced apart; such that a tube 6001 may not touch its neighboring or adjacent tube(s). The tubes 6002 may optionally be spaced apart; such that a tube 6002 may not touch its neighboring or adjacent tube(s). The tubes 6001-6002 may be, for example, hollow cylinders or pipes or frustums or pyramids or chopped-pyramids or chopped-frustums having a circular cross-section, a rectangular cross-section, an “O”-shaped cross-section, a square cross-section, or the like. In some embodiments, the tray 6011 and/or the tray 6012 may be formed by injection molding of plastic material(s); and/or the tubes 6001 may be formed by injection molding of plastic material(s); and/or the tubes 6002 may be formed by injection molding of plastic material(s). In some embodiments, the application of force onto the top-side tubes 6001 may not cause one or more of the tubes 6001 to change its orientation to be diagonal or slanted. In some embodiments, for example, the bottom-side tubes 6002 may avoid, eliminate or reduce the change in orientation of one or more tubes 6001 upon application of force to the padding 6000, and may thus contribute to an enhanced feeling of support provided by the padding 6000 to a person seating thereon. In some embodiments, padding 6000 may include air cavities or air pockets (e.g., in the area adjacent to the right end of the pointer denoted 6012), which may be used as softer regions, or to provide a softer feeling upon touching, or to accumulate air by inflation upon seating on another region of the padding 6000 (e.g., the central region of padding 6000), or for filling with another filler or foam (e.g., PU foam).

Reference is made to FIG. 61, which is a schematic side-view illustration of a portion of a padding 6100 in accordance with some demonstrative embodiments. Padding 6100 may be, for example, a part of a furniture article. Padding 6100 may include, for example: a first tray 6111 or other semi-flexible or flexible layer, from which multiple flexible tubes 6101 may protrude; and a second tray 6112 or other flexible or rigid layer from which multiple tubes 6102 may protrude. The tubes 6101-6102 may be flexible or semi-flexible, and may be arranged in a matrix or array of rows and columns. In some embodiments, each bottom-side tube 6102 may support or hold or touch (optionally using gluing or bonding or welding) and/or may partially penetrate a corresponding top-side tube 6101. The tubes 6101 may optionally be spaced apart; such that a tube 6101 may not touch its neighboring or adjacent tube(s). The tubes 6102 may optionally be spaced apart; such that a tube 6102 may not touch its neighboring or adjacent tube(s). The tubes 6101-6102 may be, for example, hollow cylinders or pipes or frustums or pyramids or chopped-pyramids or chopped-frustums having a circular cross-section, a rectangular cross-section, an “O”-shaped cross-section, a square cross-section, or the like. In some embodiments, the tray 6111 and/or the tray 6112 may be formed by injection molding of plastic material(s); and/or the tubes 6101 may be formed by injection molding of plastic material(s); and/or the tubes 6102 may be formed by injection molding of plastic material(s). In some embodiments, the application of force onto the top-side tubes 6101 may not cause one or more of the tubes 6101 to change its orientation to be diagonal or slanted. In some embodiments, for example, the bottom-side tubes 6102 may avoid, eliminate or reduce the change in orientation of one or more tubes 6101 upon application of force to the padding 6100, and may thus contribute to an enhanced feeling of support provided by the padding 6100 to a person seating thereon.

Reference is made to FIG. 62, which is a schematic side-view illustration of a portion of a padding 6200 in accordance with some demonstrative embodiments. Padding 6200 may be, for example, a part of a furniture article. Padding 6200 may include, for example: a first tray 6211 or other semi-flexible or flexible layer, from which multiple flexible tubes 6201 may protrude; and a second tray 6212 or other flexible or rigid layer from which multiple tubes 6202 may protrude. The tubes 6201-6202 may be flexible or semi-flexible, and may be arranged in a matrix or array of rows and columns. In some embodiments, each bottom-side tube 6202 may support or hold or touch (optionally using gluing or bonding or welding) but without penetrating a corresponding top-side tube 6201. The tubes 6201 may optionally be spaced apart; such that a tube 6201 may not touch its neighboring or adjacent tube(s). The tubes 6202 may optionally be spaced apart; such that a tube 6202 may not touch its neighboring or adjacent tube(s). The tubes 6201-6202 may be, for example, hollow cylinders or pipes or frustums or pyramids or chopped-pyramids or chopped-frustums having a circular cross-section, a rectangular cross-section, an “O”-shaped cross-section, a square cross-section, or the like. In some embodiments, the tray 6211 and/or the tray 6212 may be formed by injection molding of plastic material(s); and/or the tubes 6201 may be formed by injection molding of plastic material(s); and/or the tubes 6202 may be formed by injection molding of plastic material(s). In some embodiments, the application of force onto the top-side tubes 6201 may not cause one or more of the tubes 6201 to change its orientation to be diagonal or slanted. In some embodiments, for example, the bottom-side tubes 6202 may avoid, eliminate or reduce the change in orientation of one or more tubes 6201 upon application of force to the padding 6200, and may thus contribute to an enhanced feeling of support provided by the padding 6200 to a person seating thereon.

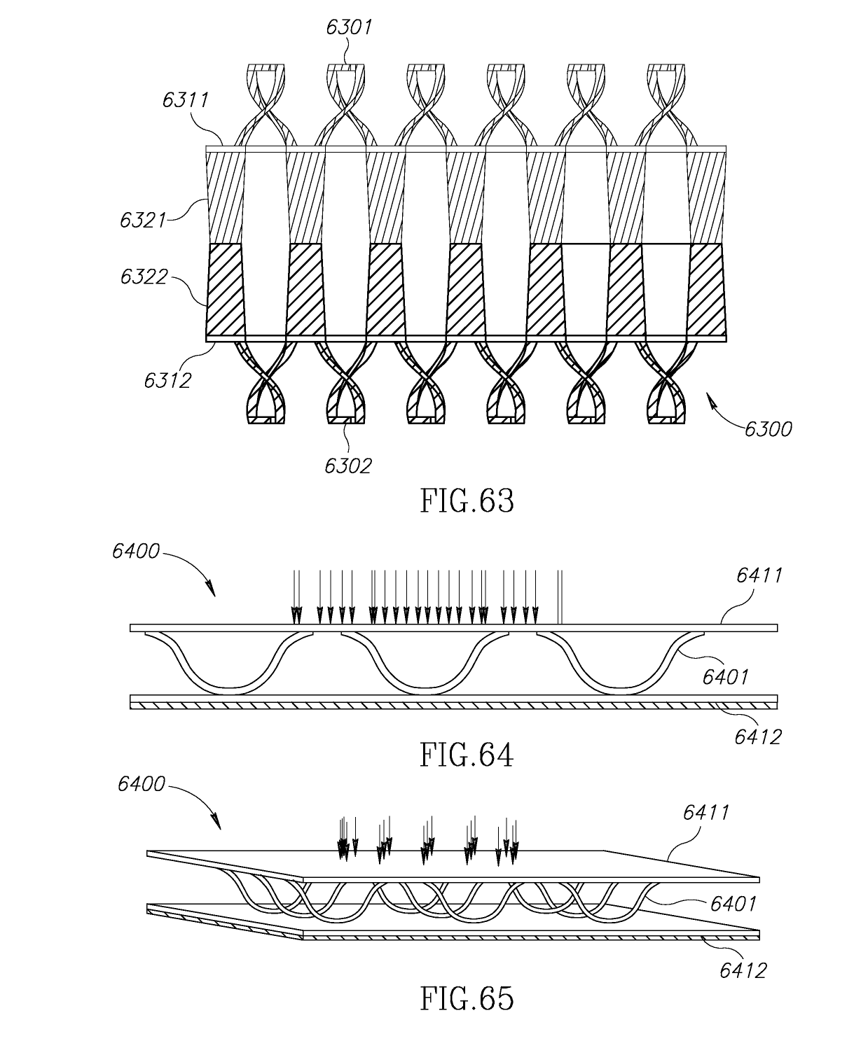

Reference is made to FIG. 63, which is a schematic side-view illustration of a portion of a padding 6300 in accordance with some demonstrative embodiments. Padding 6300 may be, for example, a part of a furniture article. Padding 6300 may include, for example: a first tray 6311 or other semi-flexible or flexible layer, from which multiple flexible springs 6301 may protrude upward; and a second tray 6312 or other flexible or rigid layer from which multiple flexible springs 6302 may protrude downward. The springs 6301-6302 may be flexible or semi-flexible, and may be arranged in a matrix or array of rows and columns. In some embodiments, each bottom-side spring 6302 may support or hold or touch (optionally using gluing or bonding or welding) but without penetrating a corresponding top-side spring 6301 using support member(s) 6321-6322, which may be flexible or semi-flexible or rigid. The springs 6301 may optionally be spaced apart; such that a spring 6301 may not touch its neighboring or adjacent spring(s). The springs 6302 may optionally be spaced apart; such that a spring 6302 may not touch its neighboring or adjacent spring(s). In some embodiments, the tray 6311 and/or the tray 6312 may be formed by injection molding of plastic material(s); and/or the springs 6301-6302 may be formed by injection molding of plastic material(s); and/or the supporting members 6321-6322 may be formed by injection molding of plastic material(s). In some embodiments, the application of force onto the top-side springs 6301 may not cause one or more of the tubes 6301 to change its orientation to be diagonal or slanted. In some embodiments, for example, the bottom-side springs 6302 (and/or the supporting member(s) 6321-6322) may avoid, eliminate or reduce the change in orientation of one or more springs 6301 upon application of force to the padding 6300, and may thus contribute to an enhanced feeling of support provided by the padding 6300 to a person seating thereon. It is noted that the supporting members 6321-6322 are illustrated only schematically, and may have other suitable shapes or structures; or they may be formed of other, non-plastic materials, for example, wood or metal.

Reference is made to FIG. 64, which is a schematic side-view illustration of a portion of a padding 6400 in accordance with some demonstrative embodiments; as well as to FIG. 65, which is a schematic perspective illustration of a portion of padding 6400 in accordance with some demonstrative embodiments. Padding 6400 may be, for example, a part of a furniture article. Padding 6400 may include, for example: a set of flexible or semi-flexible members 6401, which may be arc-shaped or curve-shaped or sinus-shaped or sinusoid; enclosed within a first tray 6411 and a second tray 6412 which may be semi-flexible or flexible or rigid. In some embodiments, the tray 6411 and/or the tray 6412 may be formed by injection molding of plastic material(s); and/or the flexible members 6401 may be formed by injection molding of plastic material(s). In some embodiments, the application of force onto the top tray 6411 may cause the flexible members 6401, or some of them, to compress.

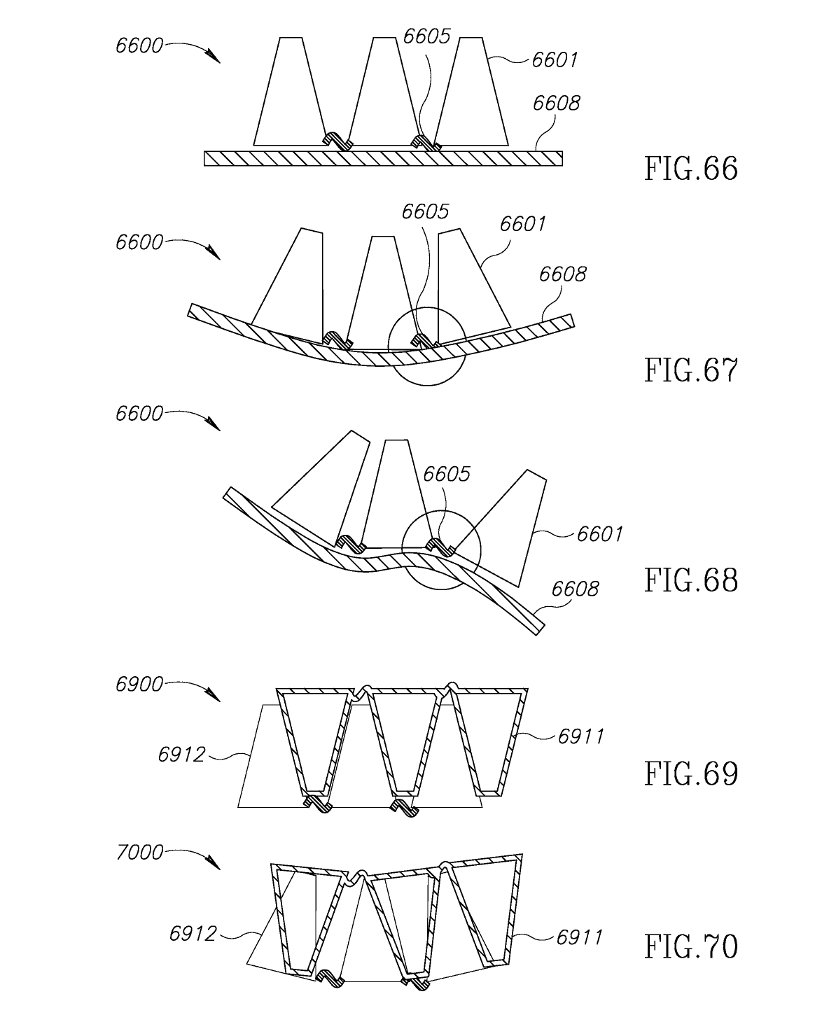

Reference is made to FIGS. 66-68, which are schematic side-view illustrations of a set 6600 of injection molding springs in accordance with some demonstrative embodiments. Set 6600 may include, for example, three springs 6601 (each one shown as a chopped cone representing the external resemblance of each spring) which may be inter-connected using flexible joints 6605 and which may optionally be connected to a flexible tray 6608. The flexible joints 6605 may be formed by injection molding of plastic material(s). The flexible joint 6605 may be, for example, “S”-shaped, “N”-shaped, “Z”-shaped, “W”-shaped, “U”-shaped, “n”-shaped, “V”-shaped, or may have other suitable shapes. In some embodiments, the flexible joint 6605 may contribute to stress reduction. In some embodiments, the flexible joints 6605 may be used when the set 6600 of springs is utilized in a non-leveled padding, for example, in a sofa or sunbed or tan-bed or “chaise longue” or other non-planar furniture items. In some embodiments, the flexible joints 6605 may be utilized instead of a dot-type connection. As shown, the set 6600 of springs with the flexible joints 6605 may be used in conjunction with a planar padding (FIG. 66), a valley-shaped or curved padding (FIG. 67), a valley-and-hill padding (FIG. 68), or other suitable types of padding or furniture. In some embodiments, the flexible joints 6605 may be, for example, similar to the joints shows in FIGS. 16D, 16E and/or 16F.

Reference is made to FIG. 69, which is a schematic side-view illustration of a portion of a padding 6900 in accordance with some demonstrative embodiments; as well as to FIG. 70, which is a schematic side-view illustration of a portion of a padding 7000 in accordance with some demonstrative embodiments. Each one of paddings 6900 or 7000 may include, for example, two sets of springs, e.g., a first set 6911 and a second set 6912 which may be positioned in opposite directions and which may occupy or share a common space. For example, each set of springs 6911-6912 may include, as shown, three springs interconnected through flexible joints, such that the springs and/or the joint may be formed by injection molding of plastic material(s). In some embodiments, springs of the first set 6911 may penetrate into complementing gaps among the springs of the second set 6912; and vice versa, namely, springs of the second set 6912 may penetrate into complementing gaps among the sprigs of the first set 6911. In some embodiments, the sets 6911-6912 may be substantially exactly complementary to each other (e.g., as shown in FIG. 69), such that springs of the first set 6911 occupy substantially the entire gap among springs of the second set 6912, and vice versa. In other embodiments, the sets 6911-6912 may be only partially complementary to each other (e.g., as shown in FIG. 70), such that springs of the first set 6911 occupy only part of the gap among springs of the second set 6912, and vice versa. In some embodiments, utilization of such face-to-face springs, or face-to-face spring nets, may contribute to stress reduction and/or to pressure absorption, e.g., from a person seating or from a rigid surface adjacent to the padding, or may otherwise reduce or eliminate pointed pressure from spring tops. Additionally or alternatively, this may allow a person, which may seat on such padding, to get a feeling of seating on an even or planar surface, instead of a feeling of seating on an array of springs or soft areas having gaps among them, and may further reduce or eliminate a feeling of “resolution” or movement or shaking of springs within the padding.

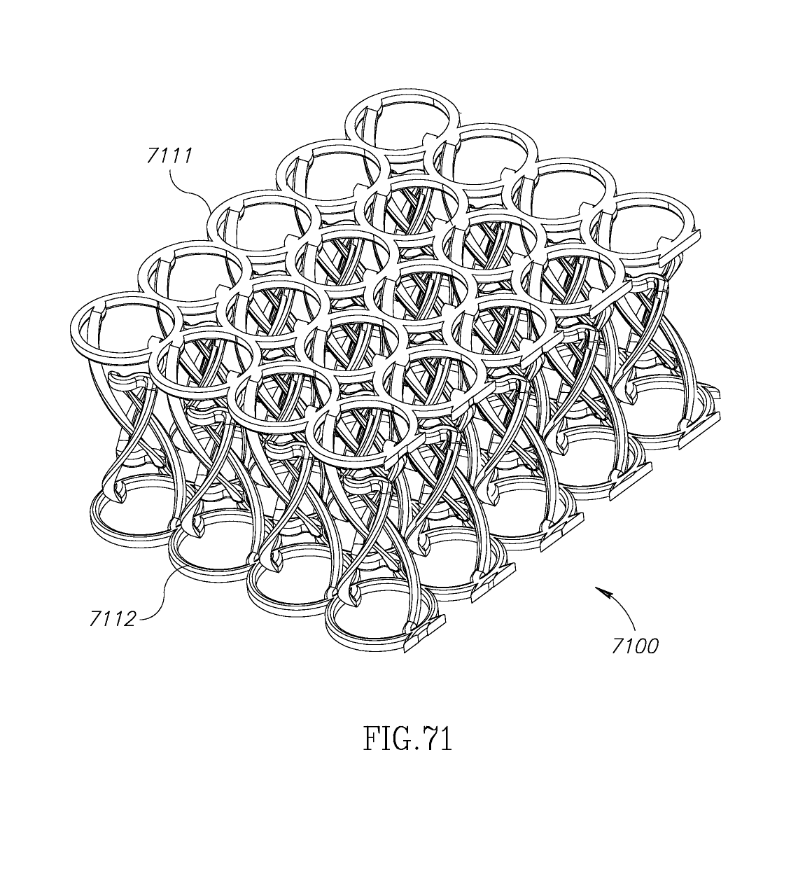

Reference is made to FIG. 71, which is a schematic perspective illustration of a padding 7100 in accordance with some demonstrative embodiments. Padding 7100 may include, for example, a first set of springs 7111 and a second set of springs 7112 positioned face-to-face in opposite directions, complementing each other entirely or partially. Each one of the sets of spring 7111-7112 may be formed by injection molding of plastic material(s).

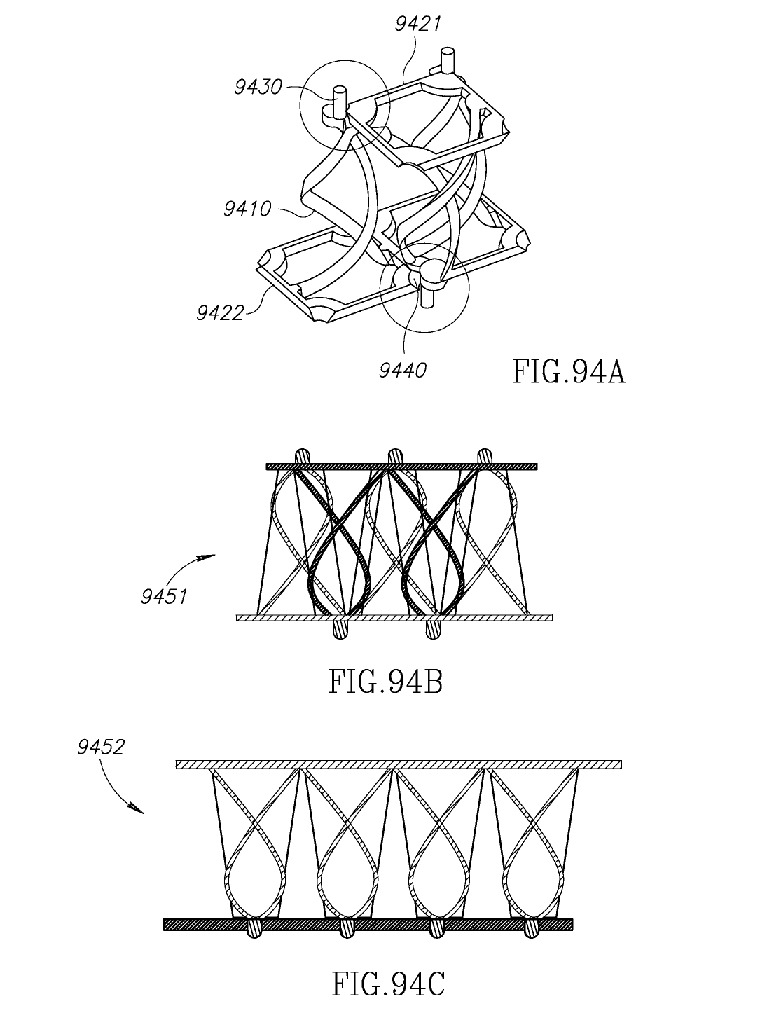

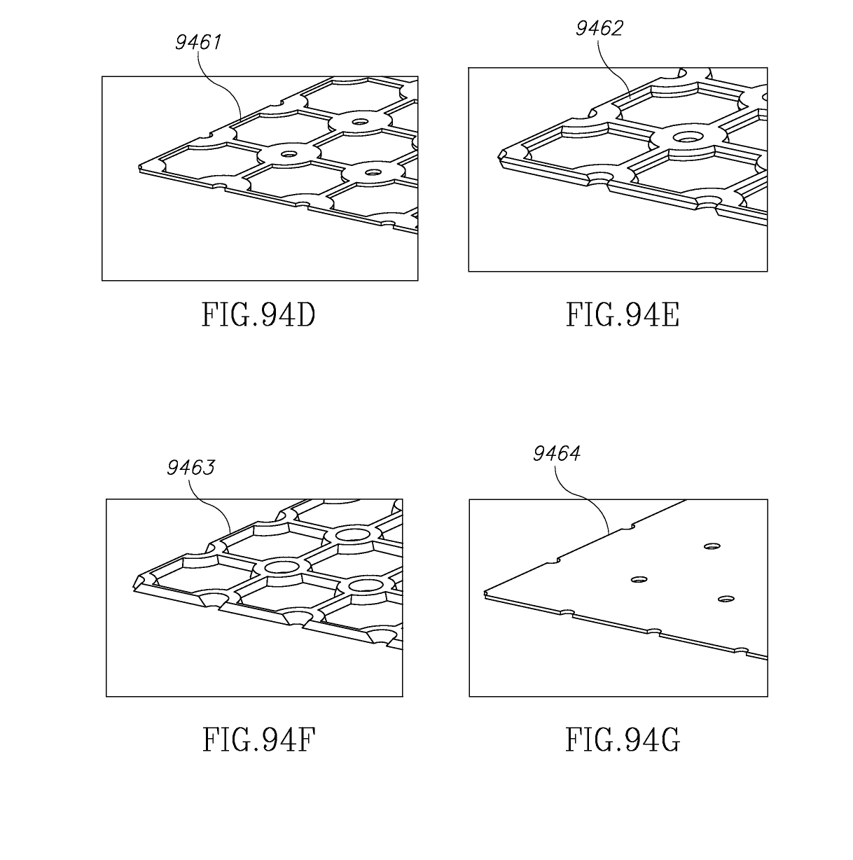

In some embodiments, two spring nets may be placed opposite one another, thereby creating padding. As reaction to local pressure, the joint spring nets returns to its original shape after pressure is removed. The spring net padding may adapt itself to external and internal pressures and return to its original shape; this includes pressing, rolling, bending, adopting surface curvatures, or other forces and pressures applied on spring net padding. In some embodiments, the affixation of the spring net(s) to a cover member or to a base member, may be performed by bonding or gluing or welding or other suitable methods, and may contribute to eliminate local dentures due to applied pressures. For example, the welding or the connection of an apex of a spring to a cover member or to a base member, may prevent the spring from twisting sideways or may reduce such sideway twisting in reaction to applied force(s). Reference is also made to FIG. 94C, which further demonstrates this matter.

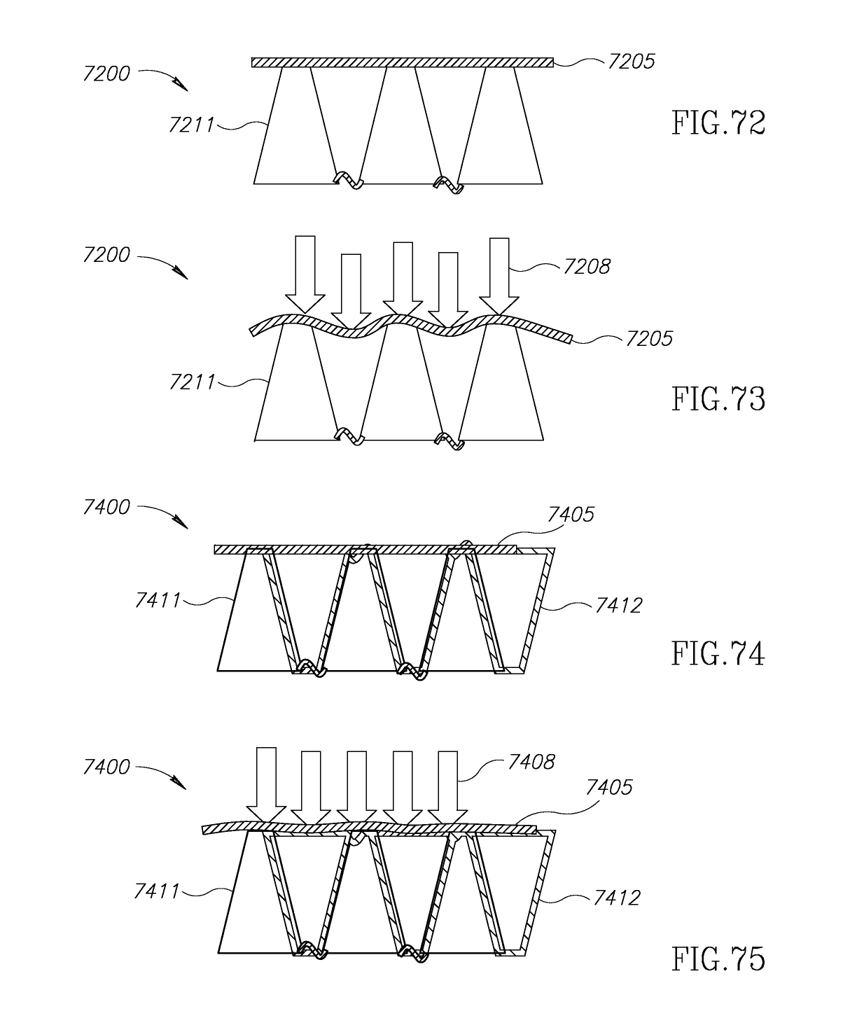

Reference is made to FIGS. 72 and 73, which are schematic side-view illustrations of a padding 7200 in accordance with some demonstrative embodiments. Padding 7200 may include, for example, a single set of springs 7211 (e.g., having three springs interconnected using two flexible joints) and attached to a flexible surface or tray 7205. Absent an application of force (e.g., as shown in FIG. 72), the tray 7205 may be substantially planar. Upon application of force (e.g., as shown in FIG. 73, the force applied indicated by arrows 7208), the tray 7205 may bend or may have valleys or curves, particularly in the portions of tray 7205 which are on top of a gap among two adjacent springs of set 7211. In some embodiments, such curves may be avoided, eliminated or reduced, for example, as discussed herein.

Reference is made to FIGS. 74 and 75, which are schematic side-view illustrations of a padding 7400 in accordance with some demonstrative embodiments. Padding 7400 may include, for example, a first set of springs 7411 positioned face-to-face and opposing a second, substantially complementing, set of springs 7412 (e.g., each set 7411-7412 having three springs interconnected using two flexible joints); and attached to a flexible surface or tray 7405. Absent an application of force (e.g., as shown in FIG. 74), the tray 7405 may be substantially planar. Upon application of force (e.g., as shown in FIG. 75, the force applied indicated by arrows 7408), the tray 7405 may only slightly bend or may have very small and insignificant valleys or curves, since substantially no portions of tray 7405 are on top of a gap among two adjacent springs of either set 7411 or set 7412.

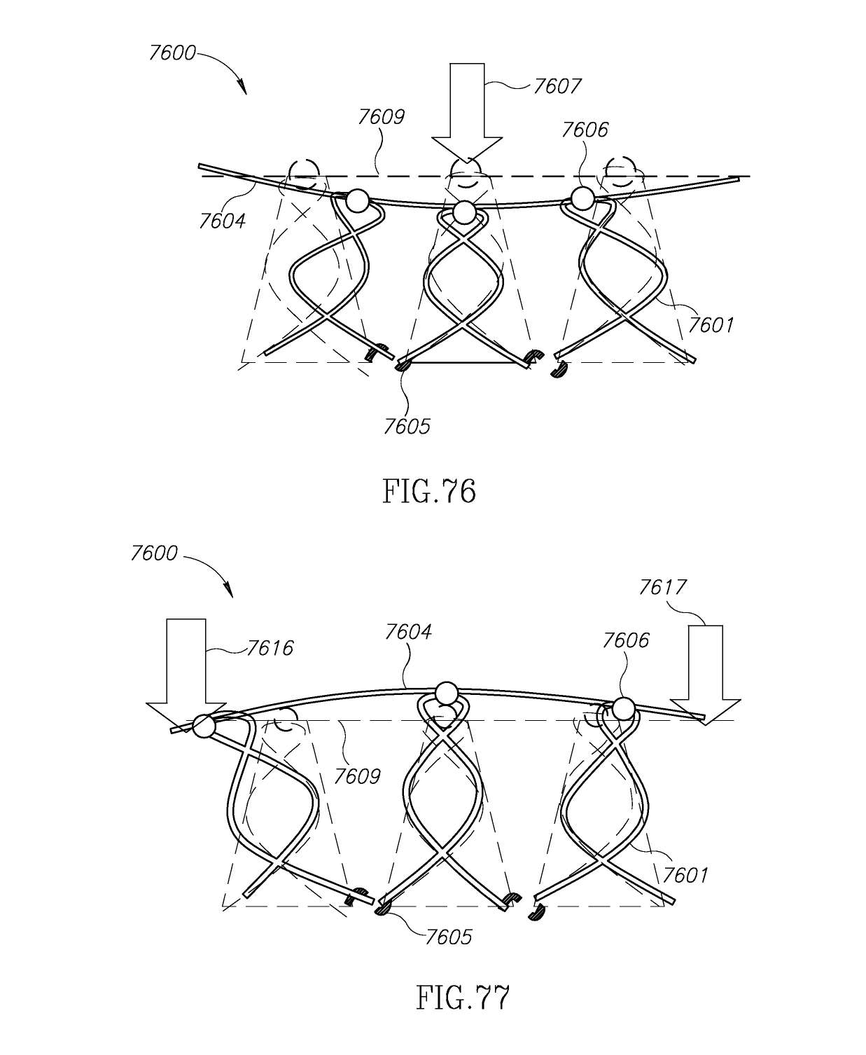

Reference is made to FIGS. 76 and 77, which are schematic side-view illustrations of a padding 7600 in accordance with some demonstrative embodiments. Padding 7600 may include, for example, a set of three springs 7601 which may optionally be interconnected using three flexible joints 7605. Each spring 7601 may have an apex 7606 which may be connected to a flexible tray 7604. Absent application of force, the flexible tray 7604 may be substantially planar and non-curved, and the three apexes 7606 of springs 7601 may be aligned along a straight line 7609; the non-tilted or non-slanted positioning of the springs 7601 is shown (in both FIGS. 76 and 77) in dashed lines. Upon application of a central force (indicated by an arrow 7607 in FIG. 76, indicating a “push”-type pressure), the three springs 7601 may become tilted or slanted, as shown in non-dashed lines in FIG. 76, such that the apexes 7606 of springs 7601 move close to the point at which the force is applied; and the tray 7604 bends or become curved accordingly. Alternatively, upon application of two forces (indicated by arrows 7616 and 7617 in FIG. 77, indicating a “pull”-type pressure), the three springs 7601 may become tilted or slanted, as shown in non-dashed lines in FIG. 77 such that the apexes 7606 of springs 7601 move close to the two points at which the force is applied; and the tray 7604 bends or become curved accordingly. Some embodiments may thus take into account the possibility that the tray 7604, when locked onto the springs 7601, may pull or push the springs 7601 to concentric position. Some embodiments may allow flexibility of each spring 7601 to move sideways and/or to absorb pressure from the top and/or to absorb pressure from the side(s). In some embodiments, the springs 7601 (or some of them) may be non-connected to the tray 7604, and may support the tray 7604, either with or without a clearance between the springs 7601 and the tray 7604. In other embodiments, the springs 7601 (or some of them) may be connected to the tray 7604, for example, using a snap mechanism, using friction ribs (e.g., near joint areas), using friction pins (e.g., rising from each spring 7601 into a corresponding hole or cavity in tray 7604), using welding or gluing or pinning, or using other suitable attachment mechanisms.

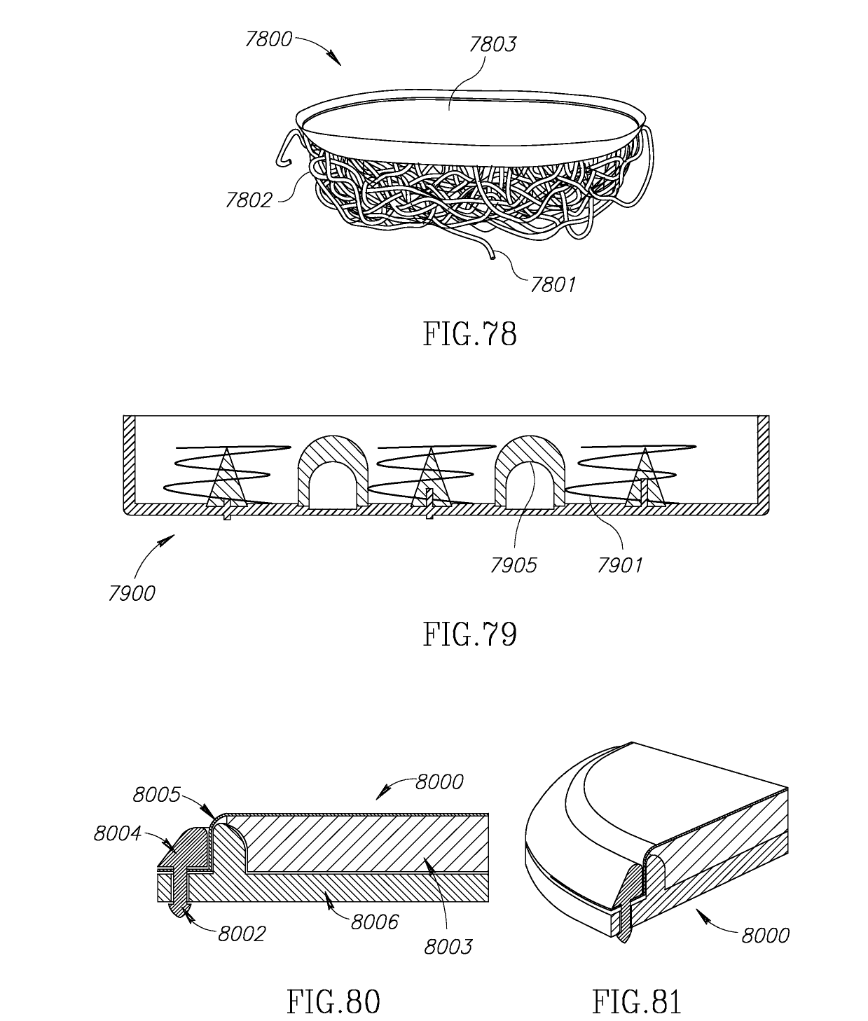

Reference is made to FIG. 78, which is a schematic illustration of a padding 7800 in accordance with some demonstrative embodiments. Padding 7800 may include, for example, one or more straws 7801 made of injection molding of plastic material(s), which may be “spaghetti-shaped”. The one or more straws 7801 may be folded or condensed or rolled or entangled, in order to form a soft or flexible padding layer 7802, which may optionally be covered by a tray 7803 or other soft of flexible or semi-flexible layer or cover.

Reference is made to FIG. 79, which is a schematic illustration of a padding 7900 in accordance with some demonstrative embodiments. Padding 7900 may include, for example, one or more springs 7901 made of injection molding of plastic material(s). Springs 7901 may be separated by one or more cones 7905 or other suitable members or mold cavities, which may optionally be formed of injection molding of plastic material(s), and/or which may be flexible or soft or semi-soft and which may provide a different level of softness and/or support from those provided by the springs 7901. In some embodiments, each one of springs 7901 may be formed by injection of spaghetti-like structures spirally around a cone or conical mold (e.g., indicated generally by the three triangles in this Figure).

In some embodiments, optionally, springs 7901 (or other springs described herein) may be formed of injection molding of plastic material(s); optionally by utilizing a predesigned channel which produces the velocity and shape for achieving the desired properties of softness after cooling down. In some embodiments, for example, an injection molding channel may be moved or rotated spirally or may otherwise acquire centrifugal velocity, and may accelerate or decelerate its rotational velocity, in order to produce the desired spring. In some embodiments, a rigid cone or other suitable member may be used as a base onto which the plastic material(s) may be injected and on which they may cool down, to achieve the desired spring.

Reference is made to FIG. 80, which is a schematic side-view illustration of a padding 8000 in accordance with some demonstrative embodiments; as well as to FIG. 81, which is a schematic exploded illustration of the padding 8000 in accordance with some demonstrative embodiments. Padding 8000 may include, for example, a rigid base 8006 having on top of it a shock-absorbing layer 8003 or other flexible layer(s) or soft layer(s); which in turn may be covered by an external soft-textured layer 8001 (e.g., fabric-like). A locking element 8004 may be used to penetrate through two or more components, optionally ending with a snap mechanism 8002 below the rigid base 8006.

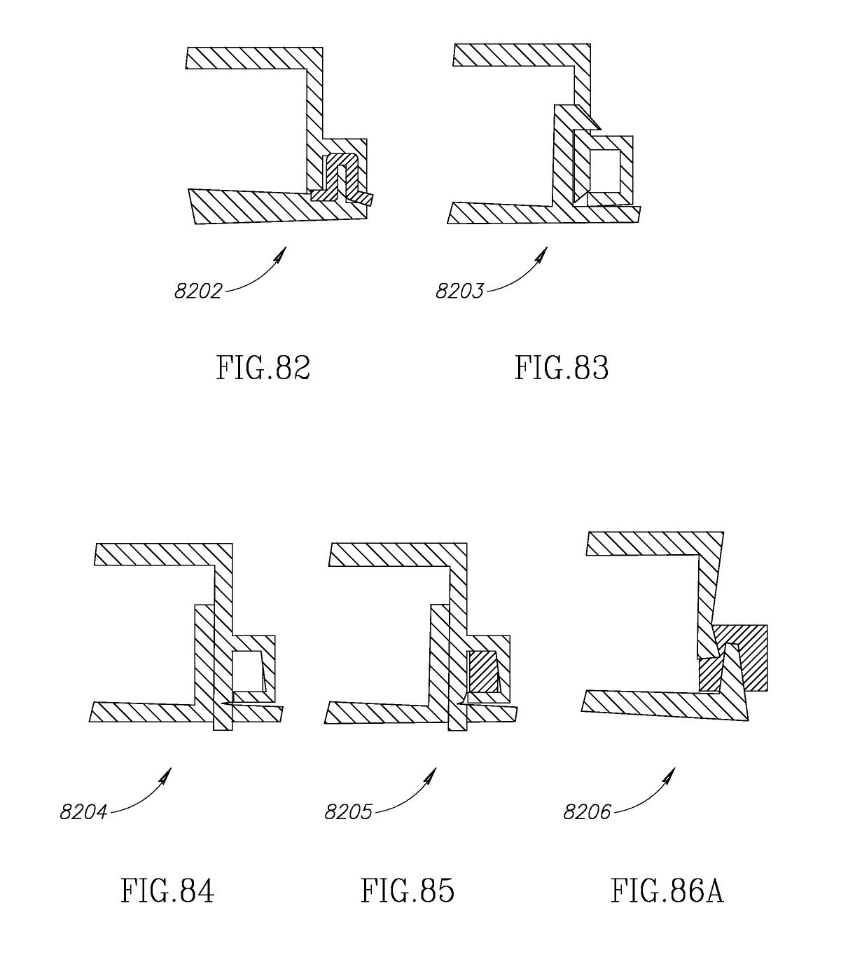

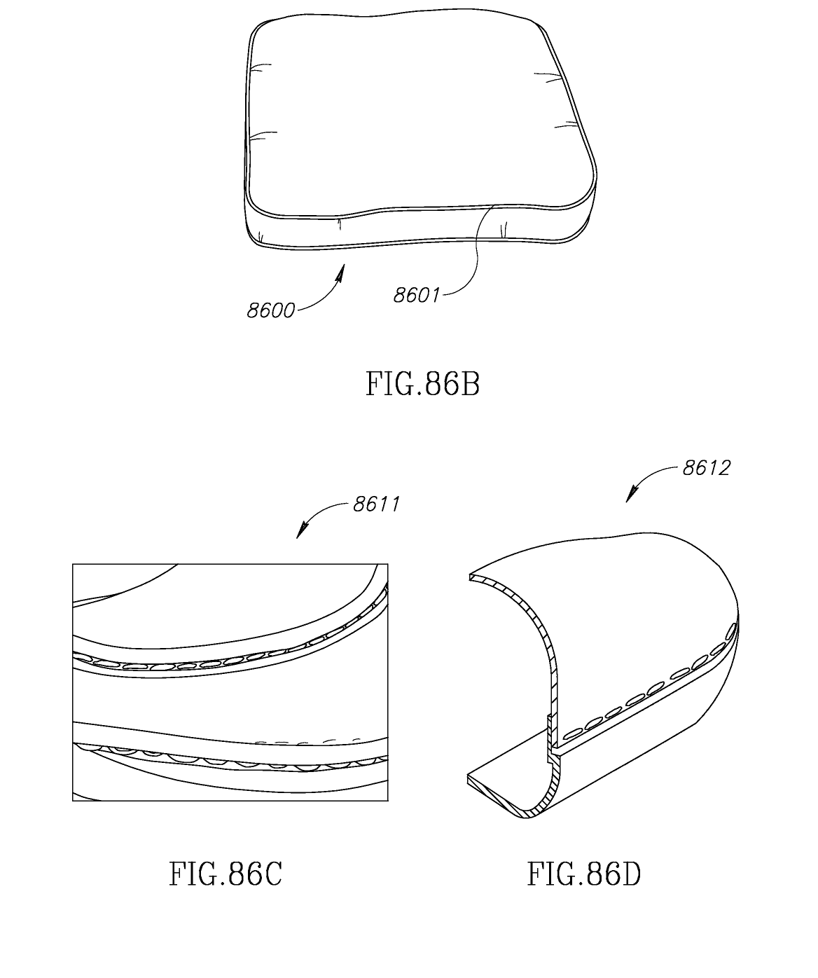

Reference is made to FIGS. 82-86A, which are schematic illustrations of connection mechanisms 8202-8206, respectively, in accordance with some demonstrative embodiments. In some embodiments, a hidden or visible or partly-visible or partly-hidden connection method may be used in order to achieve homogenous soft visual appeal. In some embodiments, the welt line of a soft padding cushion may be used for hiding or emphasizing welding and connection lines. For example, a “U”-shaped end may be used with welding or gluing to the welt line or by co-injection to the welt-line (FIG. 82); a gas channel weld line may be used (FIGS. 83 and 84); an in-mold insert may be used, for example, from soft materials or from rigid material (FIG. 85); or a visible co-injection may be used in order to emphasize color on the weld line (FIG. 86). Other suitable method may be used.

With regard to the technique demonstrated in FIG. 85, reference is further made to FIG. 86B, which is a schematic illustration of padding 8600 having a welt line 8601 formed by visually embossing of a stitch line, in accordance with some embodiments.

With regard to the technique demonstrated in FIG. 86A, reference is further made to FIGS. 86C and 86D, which are schematic illustrations of external portions 8611 and 8612, respectively, of a padding, in accordance with some embodiments. In some embodiments, the welding or bonding material serves a visual purpose imitating stitch lines.

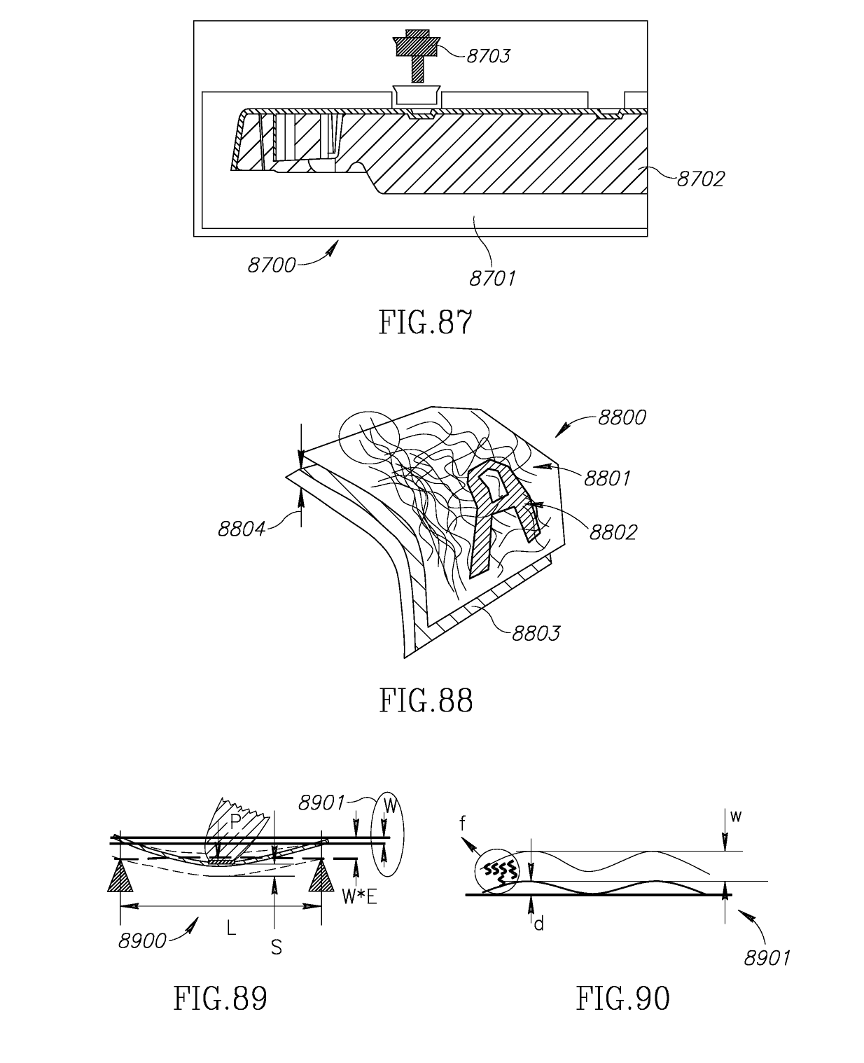

Reference is made to FIG. 87, which is a schematic illustration of a portion of a padding 8700 in accordance with some demonstrative embodiments. In some embodiments, padding 8700 may include, for example, a rigid or soft or rigid-soft interior layer 8702, which may be partially or wholly covered by or enclosed within or wrapped by a soft or flexible external layer 8701. A locking element 8703 may penetrate through both layers 8701-8702, for example, using one or more pins, slots, or other similar arrangements. In some embodiments, the interior layer 8702, and/or the external layer 8701, and/or the locking mechanism, may be formed by injection molding of plastic material(s). Other types of connectors or locking mechanisms may be used, for example, a mushroom-type connector (which may be hidden internally or partially-visible); a hidden pin mechanism; an injection mechanism; a snapping mechanism; a mechanism hidden partially or entirely by a cap; a snap member; a snap member used as a pin rising from a rigid member; an external pin which locks into an internal boss member (e.g., using glue, friction, weld, snapping); or other suitable mechanisms or members. In some embodiments, optionally, an external locking frame, or one or more external locking strips, may be used in order to surround or cover an internal member or set of members.

Reference is made to FIG. 88, which is a schematic illustration of a portion of a padding 8800 in accordance with some demonstrative embodiments. In some embodiments, padding 8800 may be fibrous and may include, for example: a non-woven sheet 8801, optionally having random or pseudo-random or patterned fiber orientations; an imprinted element 8802 (e.g., text, graphics, logo, label, branding element, image, single-color element, dual-color element, dual-color element, multi-color element); and a warp-and-weft layer 8803 (e.g., fabric-like, leather-like, or other replication of natural materials of fabric) or a layer which replicates or imitates warp and weft. In some embodiments, the sheet 8801, the imprinted element, and/or the layer 8803 may be formed, partially or entirely, by injection molding of plastic material(s). In some embodiments, the padding 8800 may cover or may include another injected materials or injected layer 8804.

Reference is made to FIG. 89, which is a schematic illustration of an application of pressure onto a padding layer 8900 in accordance with some demonstrative embodiments; as well as to FIG. 90, which is a schematic illustration of an enlarged portion 8901 of the padding layer 8900. In some embodiments, for example, padding 8900 may have an overall softness for application of a pressure (e.g., finger pressure) of 2.5 kilograms per 10 by 10 millimeters. In some embodiments, a greater value of the softness parameter S may correspond to a greater feeling of softness and/or fabric-resemblance; and/or to a reduced feeling of rigidity or rigidness or stiffness. In some embodiments, the softness parameter S may be a function of multiple other parameters, for example: a parameter W indicating nominal wall thickness before expansion or before application of pressure (e.g., typically ranging from 0.1 millimeter to 10 millimeters); a parameter D indicating top texture depth (e.g., typically ranging from 0.01 millimeter to 3 millimeter, but such that D may not be greater than 0.70 times W); a parameter Y indicating a material tensile modulus (e.g., Young's modulus divided by 100; typically ranging from 0.01 to 30); a parameter B indicating the bottom texture follow-up by offset (e.g., such that the value of B may be smaller than the value of W); a parameter E indicating an expansion ratio (e.g., a duplicator, typically ranging between 1.0 to 5.0, which may be integer or non-integer); a parameter L indicating a distance between locking points (e.g., typically ranging between 1 to 100 millimeters); a parameter F indicating the fibrous quality soft fiber additive flexibility viscose (e.g., ratio of volume in compound, ranging from 1.00 to 1.95); and/or a parameter P indicating a fixed pressure representing maximal finger pressure (e.g., such that a P value of one corresponds to finger pressure of 2.5 kilogram per one centimeter squared; the parameter P appears in the Figure in proximity to an illustration of a tip of a finger, pointing downward, indicating the applied pressure).

In some embodiments, for example, the value of S may be calculated or pre-determined by using the following equation:

S=E*W*D*L/((W−B)*(Y/100)*F) Equation 1

In some embodiments, the following equation may demonstrate the calculation of S (resulting a value of 2.59) for a thermoplastic elastomer (TPE) material having a Young's modulus of 150, used in conjunction with 10% viscose fibers, and no expansion:

S=1*1*0.3*10/((1−0.3)*(150/100)*1.1)=2.59 Equation 2

In some embodiments, the following equation may demonstrate the calculation of S (resulting a value of 1.46) for a copolymer polypropylene (PPH) material having a Young's modulus of 800, used in conjunction with 10% viscose fibers, and no expansion:

S=3*1*0.3*10/((1−0.3)*(800/100)*1.1)=1.46 Equation 3

Other suitable equations and values may be used.

Reference is made to FIG. 91, which is a schematic illustration of an injected plastic spring 9100 in accordance with some demonstrative embodiments. Spring 9100 may be formed of plastic material(s), and may be produced by injection molding of raw plastic material(s). Spring 9100 may be flexible and not entirely rigid, such that spring 9100 may compress, partially or entirely, upon application of force or pressure. Spring 9100 may include, for example, a first slope 9101 and a second slope 9102. The first slope 9101 and the second slope 9102 may be connected to each other at the top of spring 9100, optionally by utilizing a top 9105 or apex or vertex or other point or surface located at the top of spring 9100. Optionally, the first slope 9101 and the second slope 9102 may be connected to each other also at the base of spring 9100. Spring 9100 may be formed such that the two slopes 9101-9102 spiral, or rotate spirally, or converge to meet, as they extend upwards from opposite sides of the common base or surface towards the top 9105. In some embodiments, the two slopes 9101-9102 may be substantially identical to each other, e.g., in shape, weight, size, material, cross-section, or other characteristics. In some embodiments, spring 9100 may be substantially symmetrical. In some embodiments, each one of slopes 9101-9102 may include, for example, a first generally vertical member, connected to a generally horizontal or diagonal member, connected to a second generally vertical member, optionally forming a “Z” or “N” shape; or forming a two-dimensional or three-dimensional structure which may be ejected (e.g., from a mold or template) and which is based on a common line (or pattern) which begins at or near the bottom of the mold, and ends at or near the top of the mold.

Reference is made to FIG. 92, which is a schematic illustration of an injected plastic spring 9200 in accordance with some demonstrative embodiments. Spring 9200 may be formed of plastic material(s), and may be produced by injection molding of raw plastic material(s). Spring 9200 may be flexible and not entirely rigid, such that spring 9200 may compress, partially or entirely, upon application of force or pressure. Spring 9100 may include, for example, a first slope 9201 and a second slope 9202. The first slope 9201 and the second slope 9202 may be connected to each other at the top of spring 9100, optionally by utilizing a top 9205 or apex or vertex or other point or surface located at the top of spring 9200. Optionally, the first slope 9201 and the second slope 9202 may be connected to each other also at the base of spring 9200. In some embodiments, slope 9201 may gradually divide or split into two sub-slopes 9201A and 9201B; and similarly, slope 9202 may gradually divide or split into two sub-slopes 9202A and 9202B. In each slope 9201-9020, each sub-slope (9201A and 9201B; or 9202A and 9202B) may have different slanting angle, may have different shape or size or length, may elevate to reach a different portion of the spring 9200, and/or may have a different level of softness or rigidness. In some embodiments, two sub-slopes 9201A and 9202A may converge or meet at the top 9205; whereas two sub-slopes 9201B and 9202B may converge or meet at a plane which may be, for example, midway or two-third up along a central member 9207 of spring 9200. In some embodiments, the structure(s) shown in this Figure may correspond to multiple springs which may be entirely separate, or which may be partially combined or interconnected.

Reference is made to FIG. 93, which is a schematic illustration of four stages 9301-9304 in the manufacturing of an injected plastic padding in accordance with some demonstrative embodiments. In stage 9301, a bottom member 9311 may be injected as a rigid member, a soft member, or a semi-rigid member. In stage 9302, a polyurethane sponge 9312 may be inserted on top of the bottom member 9311, as shock absorber. In stage 9303, a top member 9313 may be injected on top, while an accessory mold may press on the sponge 9312 to compress it. In stage 9304, the accessory mold is removed, and the sponge 9312 may expand and may push the top part 9313 outwardly to form a pillow shape. The edges of the top member 9313 and the bottom member 9311 may be connected by using only the two steps of injection (of the bottom member 9311, and of the top member 9313) while the edges remain pressed; without a need for an additional injection or welding or stitching.

Reference is made to FIG. 94A, which is a schematic illustration of a portion of a spring net 9400 in accordance with some demonstrative embodiments. Spring net 9400 may include multiple slopes or threads or helixes or supporting members 9410 which connect a bottom frame 9422 and a top frame 9421, optionally having a set of pins 9430 and/or phases 9440, all of which may be formed by injection molding of plastic material(s). In some embodiments, optionally, adjacent threads org members 9410 may be mirrored or flipped or criss-crossed, for example, in order to reduce or eliminate rotation due to pressure. In some embodiments, the bottom frame 9422 or the top frame 9421 may be used as a base or ejector from which the spring jumps out due to is form, thereby allowing ejection of the spring net from the mold without needing a draft angle. Reference is also made to FIG. 94B, which is a schematic illustration of a side-view of an assembly 9451 of two spring-nets positioned face-to-face; as well as to FIG. 94C, which is a schematic illustration of a side-view of an assembly 9452 of two spring nets, utilizing a spring net with a simplified net having holes for centralizing and/or locking purposes (e.g., contributing to approximately half of the stiffness of the entire product). Reference is further made to FIGS. 94D-94G, which are schematic illustrations of such simplified nets, denoted 9461-9464, respectively, utilized for locking and/or centralizing purposes. In some embodiments, the nets may be used for positioning purposes prior to welding, bonding or otherwise connecting; and the nets may be implemented as a foil which may be partially perforated or pierced.

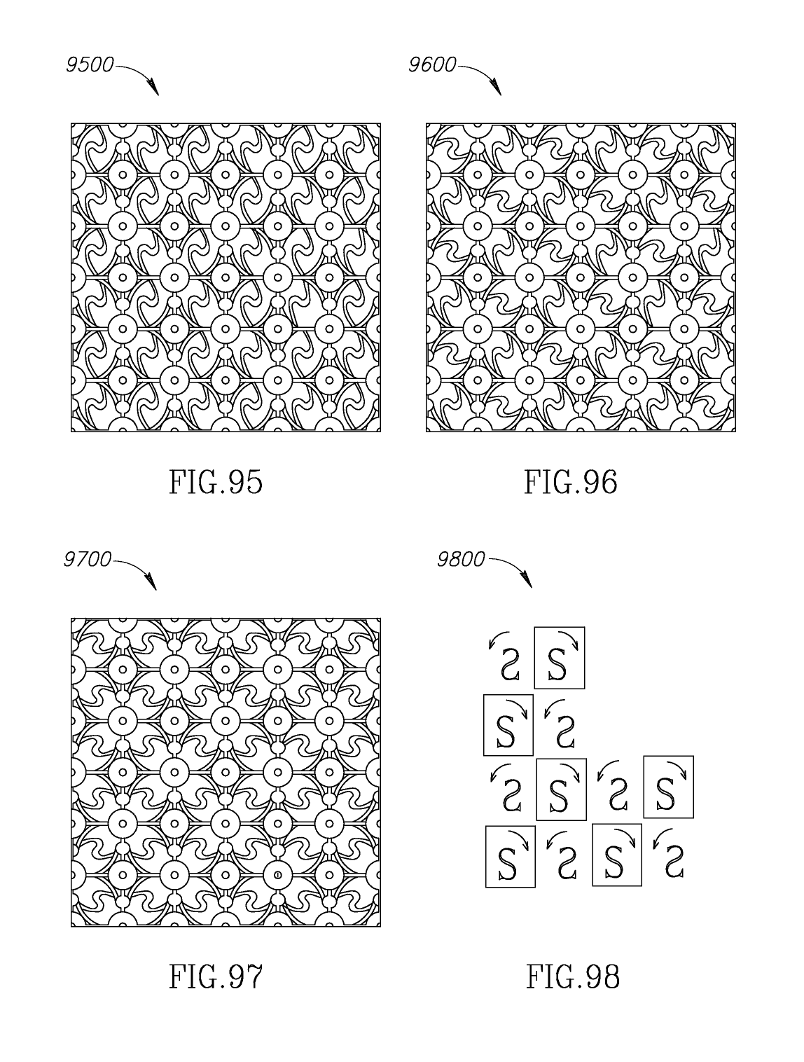

Reference is made to FIG. 95, which is a schematic illustration of a spring net 9500 in accordance with some demonstrative embodiments. Spring net 9500 may include multiple springs formed by injection molding of plastic material(s). In spring net 9500, adjacent springs may have the same orientation; for example, each spring may be “S” shaped.

Reference is made to FIG. 96, which is a schematic illustration of a spring net 9600 in accordance with some demonstrative embodiments. Spring net 9600 may include multiple springs formed by injection molding of plastic material(s). In spring net 9600, adjacent springs may have rotated orientation, perpendicular orientation, criss-cross orientation, mirror orientation, and/or flipped orientation; for example, a spring shaped as “S” may be surrounded with four neighboring springs that each one of them may be shaped as “S” turned by 90 degrees; and vice versa. The criss-cross orientation may reduce or eliminate rotation of the spring net 9600 upon application of pressure thereon.

Reference is made to FIG. 97, which is a schematic illustration of a spring net 9700 in accordance with some demonstrative embodiments. Spring net 9700 may include multiple springs formed by injection molding of plastic material(s). In spring net 9700, adjacent springs may have rotated orientation (e.g., rotated by a particular number of degrees, such as 45 degrees, in order to reduce local or general movement, or in order to allow partial entering of a leg of a first spring into the space of an adjacent spring), perpendicular orientation, criss-cross orientation, mirror orientation, and/or flipped orientation. In some embodiments, for example, each spring may have four neighboring springs which have mirrored orientation relative to it; and the springs may be aligned or ordered to create a criss-cross pattern. In some embodiments, the combination of mirroring with criss-cross pattern may reduce or eliminate rotation of the spring net 9700 upon application of pressure thereon. Reference is made to FIG. 98, which is a schematic illustration of a diagram 9800 representing the rotation, mirroring and/or criss-cross pattern of springs in a spring net, in accordance with some demonstrative embodiments; for example, corresponding to spring net 9700 of FIG. 97.

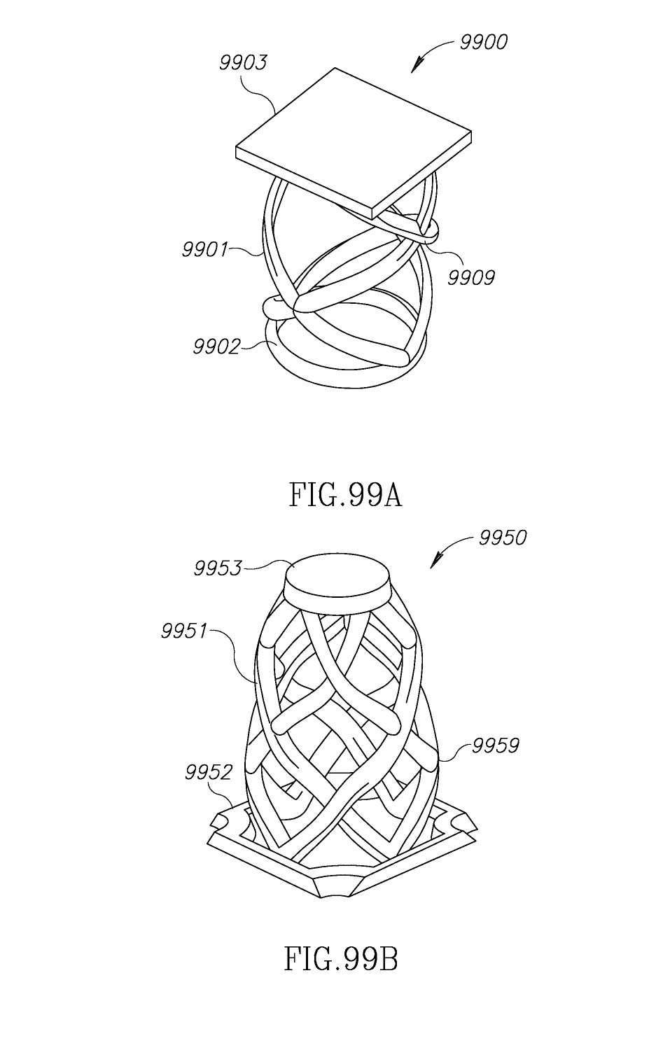

Reference is made to FIG. 99A, which is a schematic illustration of a spring 9900 in accordance with some demonstrative embodiments. Spring 9900 may be formed by injection molding of plastic material(s). Spring 9900 may include a top 9903; one or more flexible supporting members 9901 (e.g., legs, helixes, slopes, threads, pillars, or the like); and a bottom base 9902 (e.g., a ring, a square, a filled circle, or the like).

Reference is made to FIG. 99B, which is a schematic illustration of a spring 9950 in accordance with some demonstrative embodiments. Spring 9950 may be formed by injection molding of plastic material(s). Spring 9950 may include a top 9953; one or more flexible supporting members 9951 (e.g., legs, helixes, slopes, threads, pillars, or the like); and a bottom base 9952 (e.g., a ring, a square, a filled circle, or the like). Spring 9950 may have a shape similar generally to a net of a basketball hoop.

Each one of springs 9900 and 9950 may include ejecting junctions (for example, denoted by numerals 9909 and 9959, respectively). Some embodiments may have the ability to eject parts with negative drafts using “pop-up” flexibility, based on overall spring elasticity. Some embodiments may have the ability to reinforce a spring, by designing a spring joined to a “mirror” spring using opposite helixes (e.g., one or more rotating clockwise, and the other one or more rotating counter-clockwise). For example, the formed spring may eject from the mold by slightly opening or widening the spring itself, due to the spring elasticity or flexibility, thereby overcoming undercuts or sections with negative draft angles.

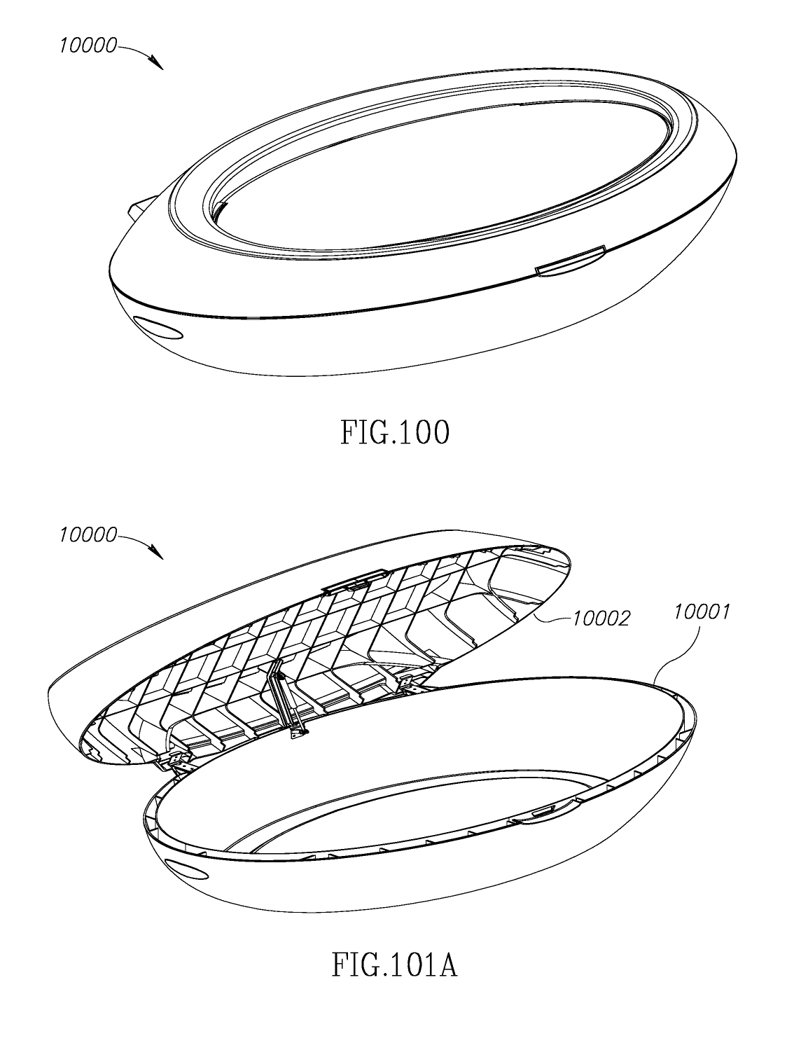

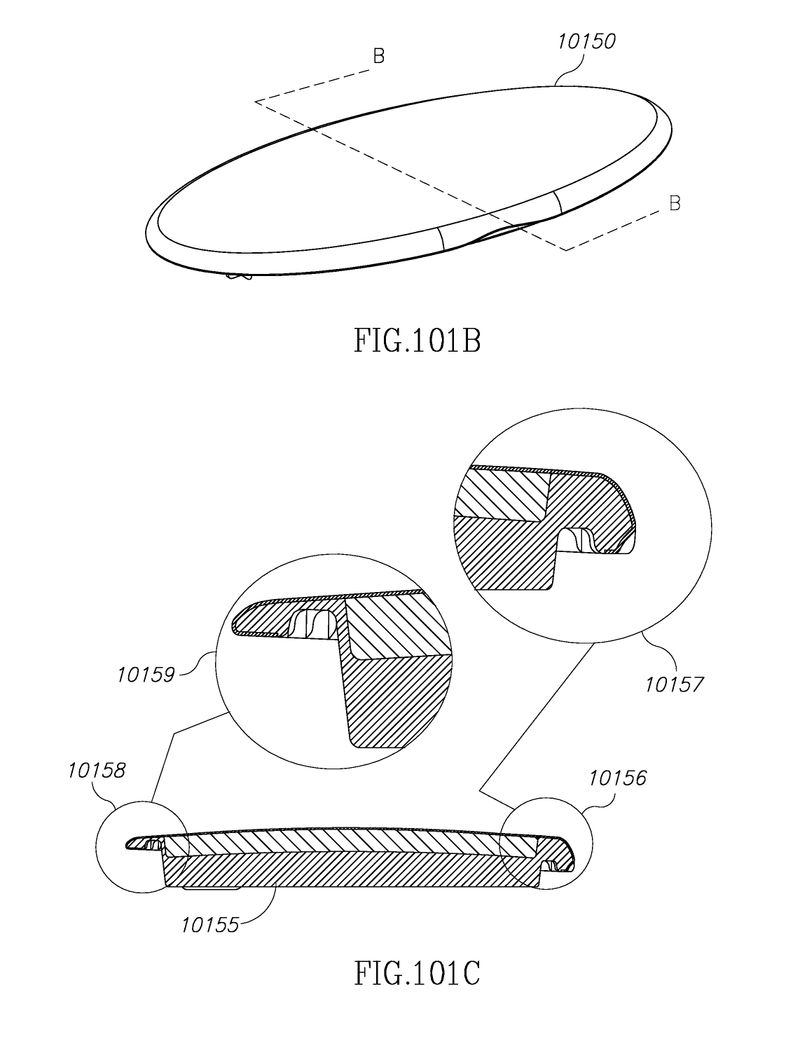

Reference is made to FIG. 100, which is a schematic illustration of a storage stool 10000 (or storage chest, or storage box) in a closed position, in accordance with some demonstrative embodiments; as well as to FIG. 101A, which shows the storage stool 10000 in an open position. Storage stool 10000 may be formed (e.g., entirely or substantially entirely) by injection molding of plastic material(s). Storage stool 10000 may include a bottom member 10001 which may be a base; and a top member 10001 which may be an openable cover, e.g., able to open via a connecting axis or other mechanism. In some embodiments, the top member 10001 may be moved or lifted in order to open the storage stool 10000; in other embodiments, the top member 10001 may be entirely separated from the bottom member 10002, such that the top member 10002 may be entirely removed from the bottom member 10001 and/or may then be placed back onto the bottom member 10001. In some embodiments, the top area of the top member 10001 may include a padding formed by injection molding of plastic material(s), to allow a person to sit on the storage stool 10000 in its closed position; and/or the top area of the top member 10001 may include a fabric-like surface formed by injection molding of plastic material(s). In some embodiments, padding which may be used may include, for example, PU foam, springs-on-fabric which may be injected as part of the upper layer, springs which are part of the bottom layer or base member, or the like. Reference is also made to FIG. 120, which demonstrates a mold which may be utilized for manufacturing, for example, of the edge regions or margin regions that are folded inwardly.

Reference is further made to FIG. 101B, which is a schematic illustration of an injected, soft-padding, cover 10150 of a storage stool in accordance with some demonstrative embodiments. Reference is also made to FIG. 101C, which is a schematic illustration of a cross section (along line BB) of the cover 10150 on top of padding (e.g., foam or foam-like material) and a base. Region 10157 is a close-up view of region 10156; and region 10159 is a close-up view of region 10158.

Some embodiments may be implemented using fully-automatic or semi-automatic systems, methods or processes, for example, utilizing a production line, a manufacturing system, a computerized or machine-based system, a robotic system, or the like. In some embodiments, a computer may be used to automate, control and/or monitor some or all of the operations of the process. Such computer may include, for example, a processor, a memory unit, a storage unit, an input unit (e.g., keyboard and mouse), an output unit (e.g., a display unit), a communication unit (e.g., a wired or wireless network interface card), an Operating System (OS), software application(s), and/or other suitable hardware components and/or software modules.

Some embodiments may utilize injection molding which is different from, for example, low-pressure polyurethane (PU) molds. For example, injection molding may utilize a cavity and core closed together as a mold (e.g., metal mold, or non-metal mold), which may be filled with plastic material(s). In some embodiments, low or very low wall thickness, as well as short cycle time, may be utilized; and may thus allow cost reduction via mass production while maintaining and repeating precision and engineering factors. Some embodiments may be used to produce a complete product, which may be formed and produced in its final shape and form, or may be formed “as is” (e.g., a mono-block chair), thereby saving or reducing assembly costs and efforts, transportation costs and efforts, or the like. Some embodiments may utilize injection molding which is different from, for example, extrusion techniques, vacuum forming, low pressure techniques, rotation techniques, or blow molding technologies.

In some embodiments, an automated or semi-automated production line or production system may include one or more units of an injection molding system, for example, hopper, heater, reciprocating screw, mold, mold cavity, movable platen, barrel, nozzle, injection parts, clamping parts, or the like. Some embodiments may optionally include one or more units, systems, method and/or operations which may be used in, or in conjunction with: Co-injection (sandwich) molding; Fusible (lost, soluble) core injection molding; Gas-assisted injection molding; In-mold decoration and in mold lamination; Injection-compression molding; Insert and outsert molding; Lamellar (microlayer) injection molding; Low-pressure injection molding; Microinjection molding; Microcellular molding; Multicomponent injection molding (overmolding); Multiple live-feed injection molding; Powder injection molding; Push-Pull injection molding; Reaction injection molding; Resin transfer molding; Rheomolding; Structural foam injection molding; Structural reaction injection molding; Thin-wall molding; Vibration gas injection molding; Water assisted injection molding; Rubber injection; Injection molding of liquid silicone rubber; or the like.

Some embodiments may include systems and methods for manufacturing of springs, or nets of springs, or padding made of springs or nets of springs, by utilizing injection molding of raw plastic material(s). For example, an injector or an extruder injects raw plastic material(s) into a template or mold, which may be formed of metal. High-pressure may allow production of items having a thin wall-width or panel-width, allowing a shorter production time and efficient or reduced consumption of raw plastic material(s).

Some embodiments may utilize a first injection molding process to manufacture internal components of the padding which absorb pressures and support the human body, but do not come in direct contact with the human body; and may utilize a second, different, injection molding process to manufacture external component (e.g., fabric-like cover or layer) which comes in direct contact with the human body.

Some embodiments may utilize an injection molding process in which the produced item is ejected without utilizing additional forces, except for filling the mold or template with the raw plastic material(s) and opening the template or the mold after an optional short-term cooling-down of the produced item. In other embodiments, one or more forces or methods may be utilized to eject the formed item from the mold or template; for example, by (a) moving, or sliding, or modifying the position or location or angle, of one or more components or internal components of the mold or template; or (b) applying a particular force or pressure or motion in order to eject the produced item, together with opening the template or afterward.

Some embodiments may avoid a time-consuming ejection process, and may avoid utilization of electro-erosion, in order to allow efficient ejection of a high number of produced springs; for example, to eject dozens, or hundreds, of injection molding springs, which may be required or desired in order to provide higher resolution, improved ergonomic support, and improved pressure absorption.

In some embodiments, ejection of springs or spring-net may utilize the integrated flexibility or elasticity of the produced injection molding spring or spring-net, in order to allow the item to eject itself (entirely or partially) from the mold or template. For example, multiple conical pins may be provided or manufactured, optionally by utilizing machining and/or shaving and/or Computer Numerical Control (CNC) machining; such that an undercut or a negative draft angle may be formed (e.g., thereby causing a formed item, which may not be sufficiently elastic or flexible, to remain held within the mold). In some embodiments, the spring or the spring-net may be ejected from the mold or template, for example, by utilizing a pull operation (e.g., robotic pull, automatic pull, machine-based pull, manual pull, gravitational free-fall, or a combination thereof) in which the spring or spring-net is delicately pulled from the mold or template. Due to the elasticity and flexibility of the spring or spring-net, the pulling does not tear or rip the formed item, and the spring or spring-net may return to its non-pulled or non-stretched position after the ejection; as long as the pull operation does not utilize force beyond the elasticity threshold. In some embodiments, the spring or spring-net may thus be caused to “jump” (entirely or partially) out of, or from, the mold or template, and may self-return to their normal state after such “jumping” occurs.

In some embodiments, the manufacturing may include pins produced through machining and/or shaving and/or Computer Numerical Control (CNC) machining, performed on a cylinder or on multiple cylinders. Optionally, the edges or the tops of such pins may be interconnected using a ring, which may be implemented as a channel or slit in the mold or template. After the pins are removed from their original position, the formed item may remain held within small holes, and a pull operation may be used to slightly deform the produced item until it ejects completely and then assumes again its normal state (e.g., non-compressed and non-stretched).

In some embodiments, double-injection-molding may be used in order to achieve stitching or welding between an upper part or member (e.g., of the fabric-like unit or cover) and a lower part or member (e.g., of the fabric-like unit or cover), wherein sponge or other soft material is between the upper and lower members. For example, the lower member may be formed by injection molding; and then, after being formed, may be placed within a template. Within or over the lower member, a sponge or other material is placed or bonded or attached; such sponge or material may have a cover or a sealing, to ensure that liquid material which enters in the second injection molding does not penetrate the pores or perforations of the sponge (or other material). Such sealing may include, for example, a micron sheet of Polysterene, or of other suitable plastic material which is not affected by heat. In some embodiments, the sponge itself may be self-sealing, for example, if a top layer in Polyurethane sponge is manufactured as a sealing layer in its production process; or by utilizing a chemical material which closes or seals the external pores of the sponge in order to block entrance of the hot, liquid material into the sponge. Such blocking or sealing may allow the sponge to retain its properties (e.g., its ability to compress and then expand back), even though the sponge is now used within an assembly that undergoes injection molding.

Upon placement of the sponge, the second injection molding may be performed. The raw plastic material, which is liquid and hot, may connect or bond to the edges of the previously-injected (previously-formed) member (e.g., the bottom member). The process may cause the sponge to significantly compress (e.g., the compressed sponge may have a height of approximately 10 percent of its non-compressed height). After the second injection molding is complete, and the template or mold is opened, the sponge gradually decompresses and stretches back to its original height, thereby providing a pillow-like structure to the produced item. The gradual assumption of un-compressed state of the sponge is possible due to the utilization of flexible or elastic materials for the bottom member and/or the top member.

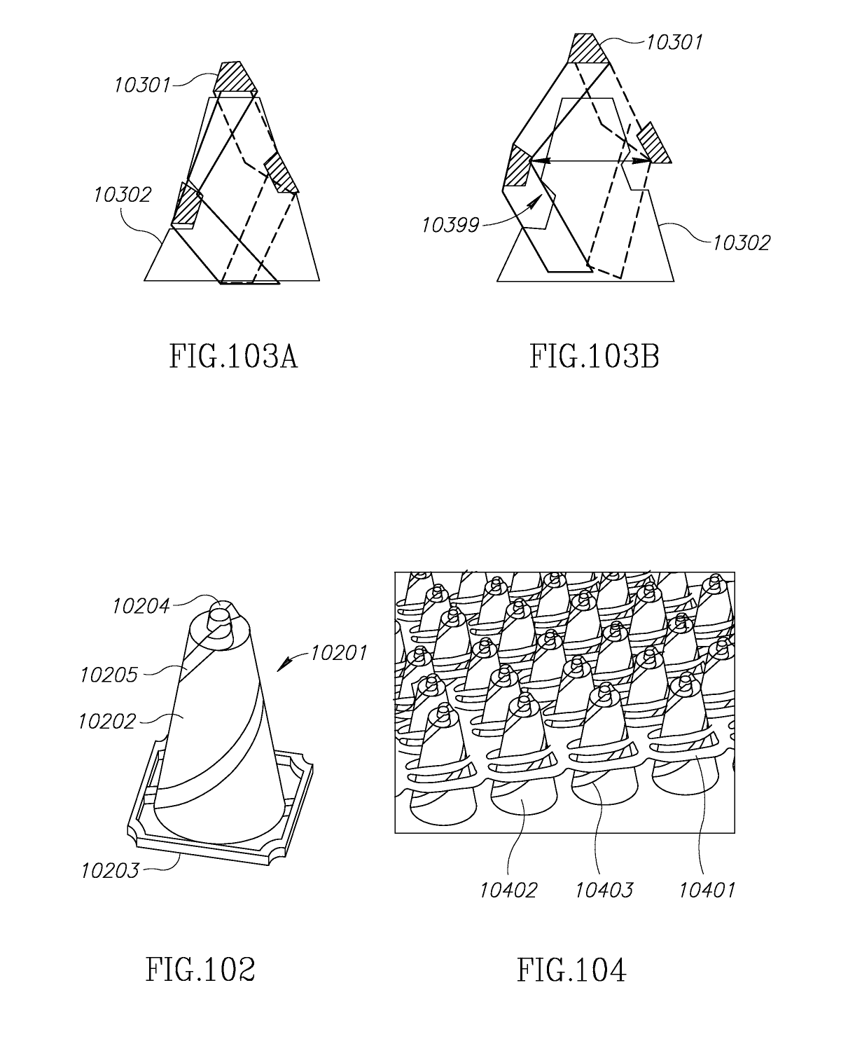

Reference is made to FIG. 102, which is a schematic illustration of an injection molding spring 10201 wrapped around a generally conical mold 10202, in accordance with some demonstrative embodiments. The spring 10201 may include one or more spiral helixes 10205 or other types of legs or supporting members, extending from a base 10203 to an apex 10204. In some embodiments, the spiral helixes 10205 may be formed on, or within, respective grooves or slits or channels which may be milled or engraved into the mold 10202.

Reference is made to FIGS. 103A and 103B which are schematic illustrations of two states of an injection molding spring 10301 and a generally conical mold 10302, in accordance with some demonstrative embodiments. For demonstrative purposes, lines of spring 10301 indicate a side or a helix or a leg visible in this side view (namely, are in front of the mold 10302); whereas dotted lines of the spring 10301 indicate a side or a helix or a leg which are hidden in this side view (namely, are behind the mold 10302). As demonstrated in FIG. 103A, upon its manufacturing, the spring 10301 may be wrapped around the mold 10302, and may be retained in its place due to undercuts or negative draft angles (such as undercut 10399). As demonstrated in FIG. 103B, pulling upward the top portion of the spring 10301, together with the elasticity or flexibility of the spring 10301, may cause the spring 10301 to overcome the undercuts and to eject out of the mold 10302.

Reference is made to FIG. 104, which is a schematic illustration of a net of springs 10401 wrapped around a mold of multiple conical pins 10402 having slits or channels 10403 milled or grooved thereon, in accordance with some embodiments. The net of springs 10401 may be ejected from the mold as described above.

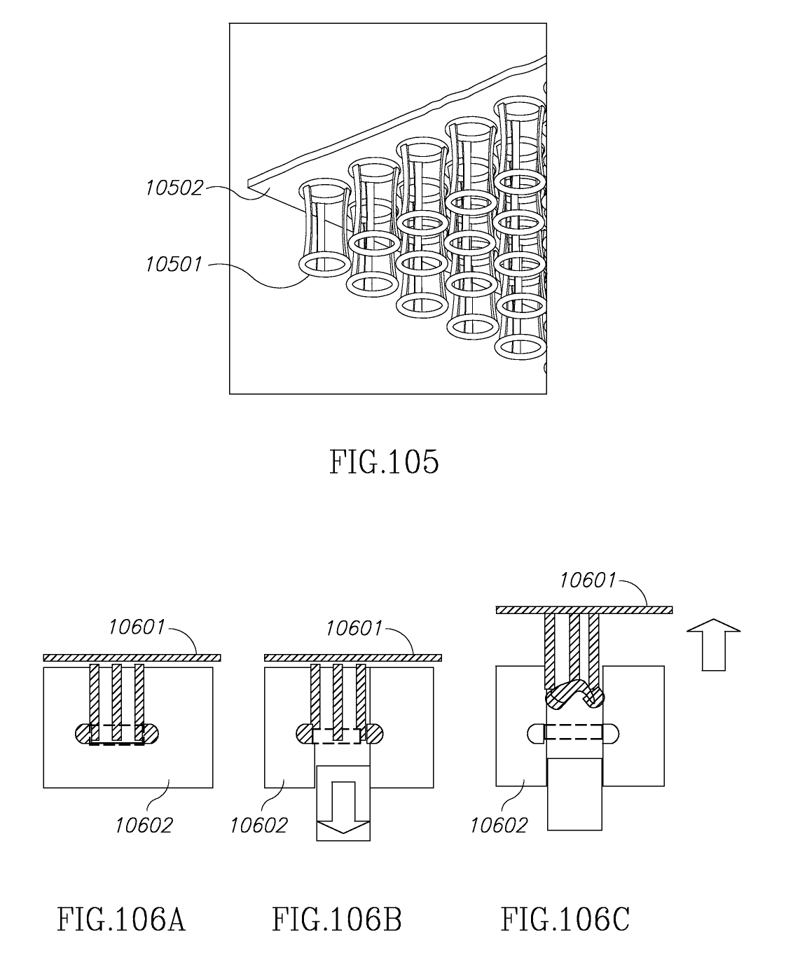

Reference is made to FIG. 105, which is a schematic illustration of a net of injected molding springs 10501 connected to an injected molding fabric-imitation 10502, in accordance with some embodiments. The net of springs 10502 may be ejected from an injection mold as described above. Each spring 10501 is shown, for demonstrative purposes, as a generally cylindrical structure having three legs or supporting members; however, other suitable structures or shapes may be used (e.g., conical, pyramid shape, square based, prism), as long as they provide the desired properties or behavior (e.g., flexibility or rigidness, ejection ability).

Reference is made to FIGS. 106A-106C, which demonstrate three states in a process of ejecting a spring 10601 (or a spring net) from a mold 10602. As demonstrated in FIG. 106A, the spring 10601 may be formed such that at least a portion thereof may be trapped or held internally within the mold 10602. As demonstrated in FIG. 106B, at least a portion of the mold 10602 may be removed or may be pulled away from the spring 10601. As demonstrated in FIG. 106C, the spring 10601 may be pulled up, away from the mold 10602, and the elasticity or flexibility of the spring 10601 may allow the portion of the spring 10601 which is within the mold 10602 to temporarily compress, to overcome any undercut(s) in the mold 10602 and to allow the spring 10601 to eject out of the mold 10602 and then, subsequently, to retain its non-compressed state. In some embodiments, components shown (or some of them) may be moved or pulled or pushed in other direction(s); for example, instead of a central portion moving downward as shown in FIG. 106B, portions of the mold 10602 may move upward. Other suitable movements or directions may be used.

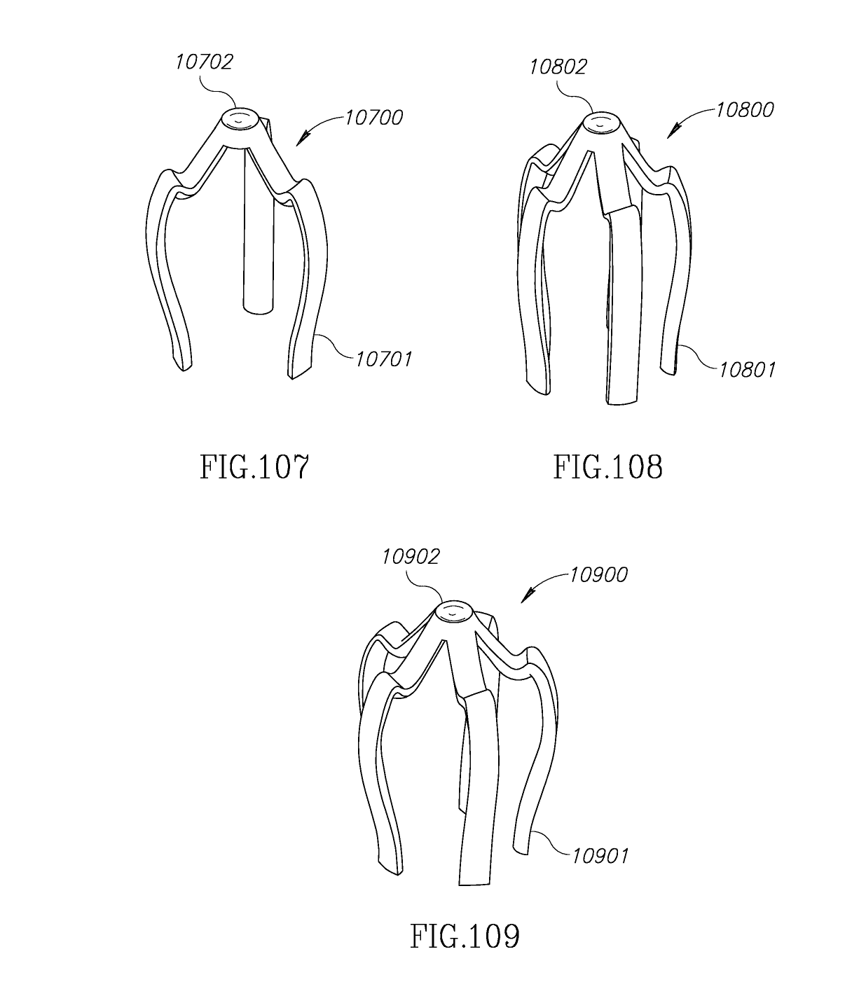

Reference is made to FIG. 107, which is a schematic illustration of a spring 10700 in accordance with some demonstrative embodiments. Spring 10700 may have multiple legs 10701 or supporting members, converging at an apex 10702.

Reference is made to FIG. 108, which is a schematic illustration of a spring 10700 in accordance with some demonstrative embodiments. Spring 10800 may have multiple legs 10801 or supporting members, converging at an apex 10802.

Reference is made to FIG. 109, which is a schematic illustration of a spring 10900 in accordance with some demonstrative embodiments. Spring 10900 may have multiple legs 10901 or supporting members, converging at an apex 10902.

Some embodiments may include springs, or sets or nets of springs, formed by injection molding of raw plastic material(s), which imitate structure and/or behavior and/or properties of foam, or a network or micro-network of foam, e.g., multiple chains and bridges having negative drafts.

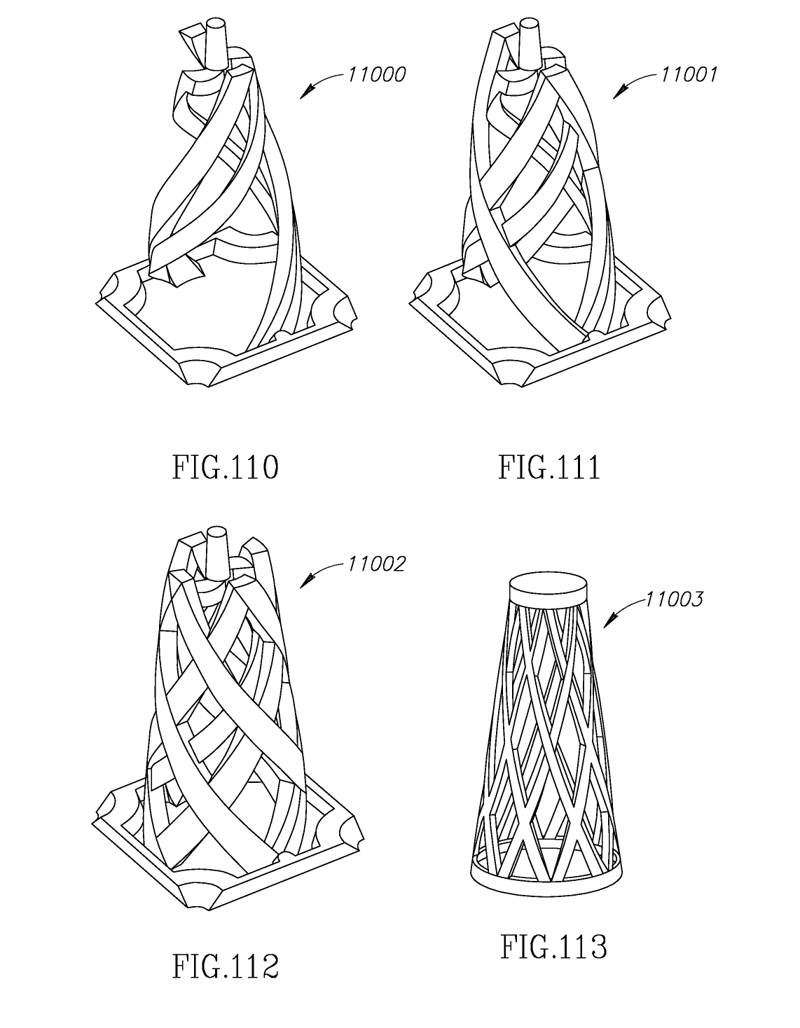

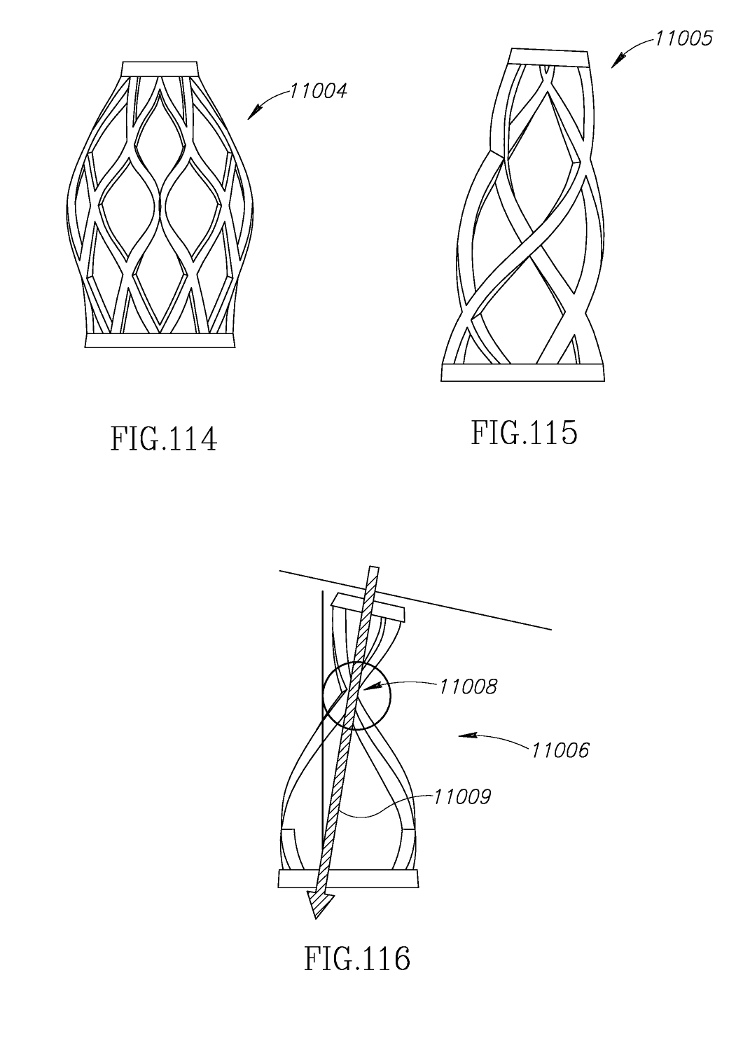

Reference is made to FIGS. 110-116, which are schematic illustrations of springs denoted respectively 11001-11006, in accordance with some embodiments. For example, a helix springs may be reinforced in order to enhance stability and to achieve more homogenized reaction to pressure, e.g., by forming mirror helix “legs”. In some embodiments, one or more joints 11008 may be utilized, for example, in order to allow degree-of-freedom to adopt to various pressure direction vector(s) (e.g., pressure vector 11009).

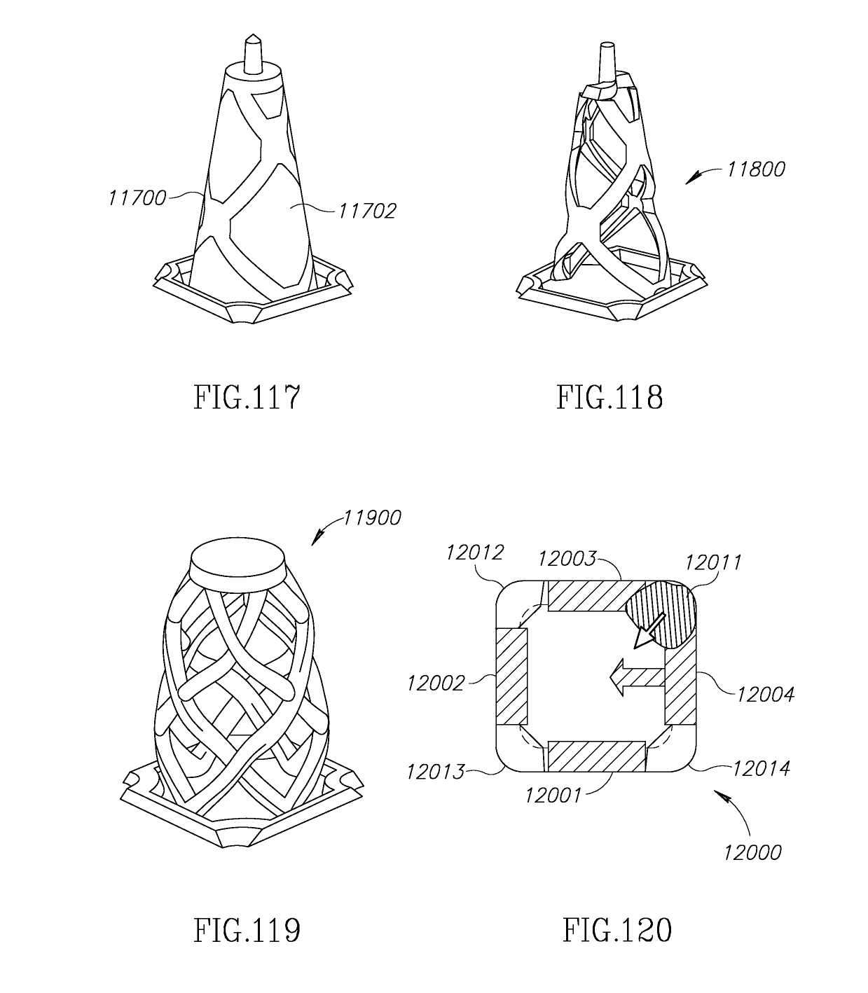

Reference is made to FIG. 117, which is a schematic illustration of an injection molding spring 11700 wrapped around a conical pin or mold 11702, in accordance with some demonstrative embodiments. Some embodiments may utilize minimal or no undercuts, or limited undercuts, to allow ejection or popping of the formed spring, from an engraved conical pin or mold or template.

Reference is further made to FIG. 118, which is a schematic illustration of a similar injection molding spring 11800, without the conical mold or template, in accordance with some demonstrative embodiments. Optionally, negative draft angle (and ejection problems which may be associated with it) may be eliminated, for example, by adding a local draft on joint intersection.

Reference is made to FIG. 119, which is a schematic illustration of an injected molding spring 11900, shaped as a net of a basketball hoop, in accordance with some embodiments.

Reference is made to FIG. 120, which is a schematic illustration of a collapsible mold 12000, in accordance with some embodiments. The mold 12000 may include for movable walls 12001-12004, as well as four movable corners 12011-12014 or movable rounded corners. In some embodiments, the movable corners 12011-12014 may move towards the center (e.g., as demonstrated by the diagonal arrow), and then the movable walls 12001-12004 may move towards the center (e.g., as demonstrated by the horizontal arrow). In some embodiments, the movable or collapsible mold may be used, for example, for producing an elliptic cover for the product shown in FIG. 101.

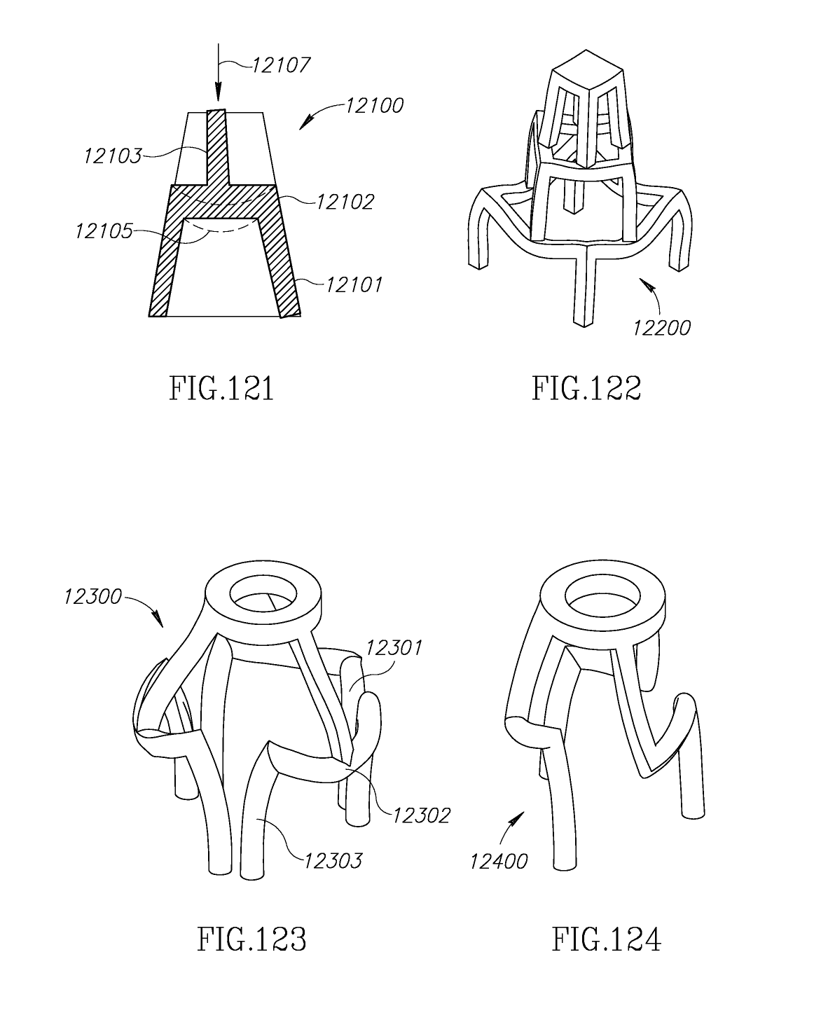

Reference is made to FIG. 121, which is a schematic illustration of a bridge-like structure 12100 formed by injection molding of raw plastic material(s), in accordance with some demonstrative embodiments. Structure 12100 may be part of, for example, a spring, a spring net, a supporting member of a spring, a leg of a spring, or the like. Structure 12100 may include, for example, two (or more) legs 12101, which may be vertical or diagonal or slanted; and which may be interconnected by a generally horizontal or a diagonal bridging member 12102, from which an extension 12103 may extend upward, optionally being used as a leg or a support for an upper layer or structure. The structure 12100 may absorb, for example, a vertical force directed downward (arrow 12107), which may cause the structure 12100 to slightly or temporarily bend or become curved, as indicated by curves 12105. Structure 12100 may be, or may be part of, a multi-leveled absorber; and may be based, for example, on conical shape or a pyramid-like shape.

Reference is made to FIG. 122, which is a schematic illustration of a multi-level spring 12100 formed by injection molding of raw plastic material(s), in accordance with some demonstrative embodiments. In the example shown, spring 12100 may be tri-level, namely, may include three levels of absorbers; for example, each level may include horizontal members resting on four (or other number of) vertical or slanted legs, such that each level may include individual absorber(s). Some embodiments may thus utilize such structures and suspension systems combine both spring stability and simplification of mold production.

Reference is made to FIG. 123, which is a schematic illustration of a support structure 12300 formed by injection molding of raw plastic material(s), in accordance with some demonstrative embodiments. Structure 12300 may absorb forces applied thereto by utilizing one or more material properties, for example, bending (e.g., at point 12301) and/or torsion (e.g., at points 12302 and 12303). In some embodiments, the combination of torsion and bending may be used to control the gradual movement of the spring or the support structure 12300. In some embodiments, such control may be further achieved by using controlled collision of a first spring with a second, adjacent, spring (or with portions thereof).

Reference is made to FIG. 124, which is a schematic illustration of a support structure 12400 formed by injection molding of raw plastic material(s), in accordance with some demonstrative embodiments.

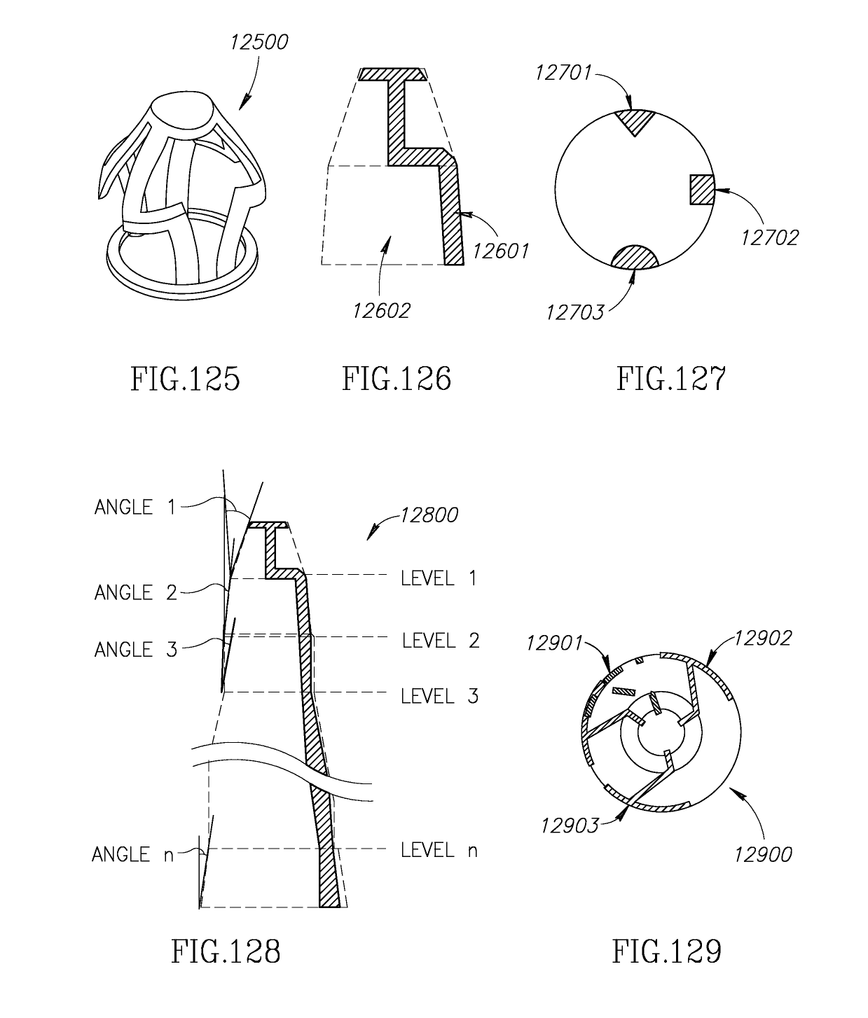

Reference is made to FIG. 125, which is a schematic illustration of a support structure 12500 formed by injection molding of raw plastic material(s), in accordance with some demonstrative embodiments.

Reference is made to FIG. 126, which is a schematic illustration of a side-view of a support structure 12601 relative to a conical pin 12602 which may be used as a mold, in accordance with some embodiments. Reference is further made to FIG. 127, which is a schematic illustration of three alternate sections 12701 (V groove), 12702 (straight U), and 12703 (ball cutter) which may correspond to section(s) of a leg or supporting member, in accordance with some embodiments. Accordingly, some embodiments may utilize rotation tools, instead of electro-erosion which may be slower and time consuming.

In some embodiments, the conical pin element may include N (an integer) number of legs, and/or N or K (the same or another integer) number of levels or layers. Each layer may be formed with draft angle which may vary between 0.01 degrees to 89.99 degrees. The wall thickness of each leg may vary between, for example, 0.01 millimeter up to the maximum of the engraving tooling (e.g., 100 millimeters for large suspension). Each level shoulder may define the shape and size of the horizontal absorber which transfers the pressure from each leg to the other level. The size, shape and number of each leg or shoulder may vary, depending on the amount of absorption required from each level and from the entire structure. In this regard, reference is made to FIG. 128, which is a schematic illustration of a multi-level leg in accordance with some demonstrative embodiments. Reference is further made to FIG. 129, which is a schematic illustration of a top-view of a support structure 12900, in accordance with some demonstrative embodiments; which demonstrates, for example, possible variations in number of legs 12901, level shoulders 12902, and/or mirrored legs 12903. It is noted that these are only demonstrative examples, and other suitable combinations, shapes, dimensions and/or elements may be used in accordance with some embodiments.

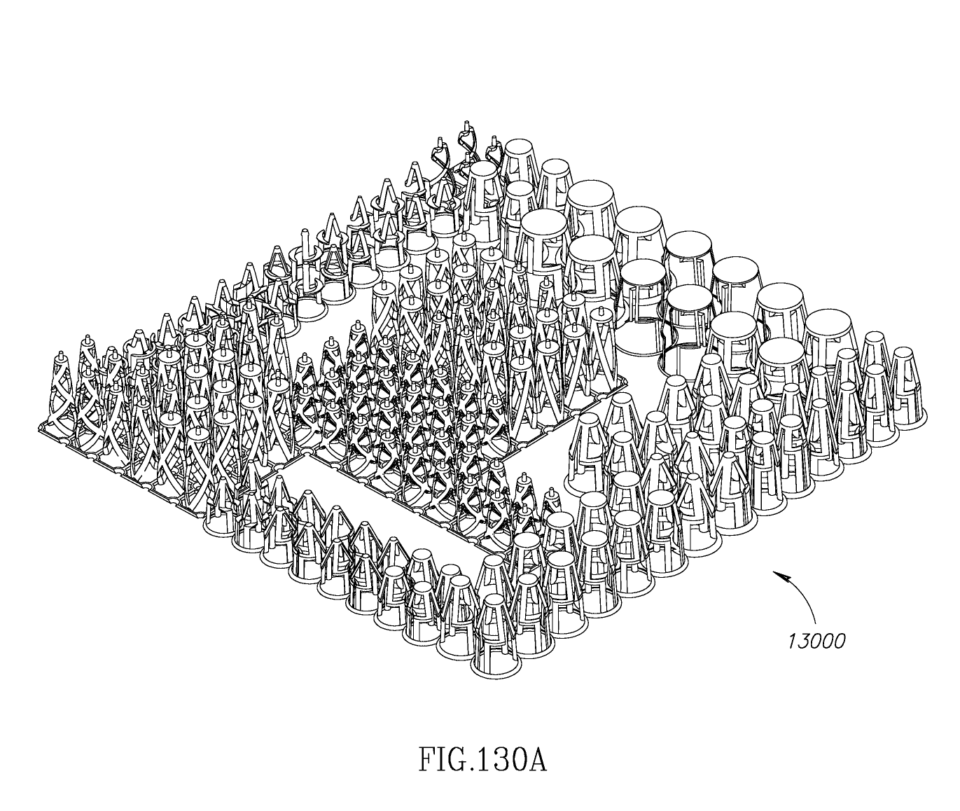

Reference is made to FIGS. 130A and 130B, which are schematic illustrations of a perspective view and a top view, respectively, of a set of springs 13000 in accordance with some embodiments. The set of springs 13000 may include, for example, various types of springs made by injection molding of raw plastic materials; for example, springs based on the conical multi-layer structure, and/or springs formed using pop-up pins or molds. Some embodiments may be able to combine, in one spring net, multiple springs of different types and/or shapes and/or heights, as well as springs having other different properties (e.g., rigidness, flexibility, number of legs, shape of legs, shape of base, number of layers per spring, dimensions, or the like); and this may optionally be used in order to accommodate or achieve ergonomic goals.

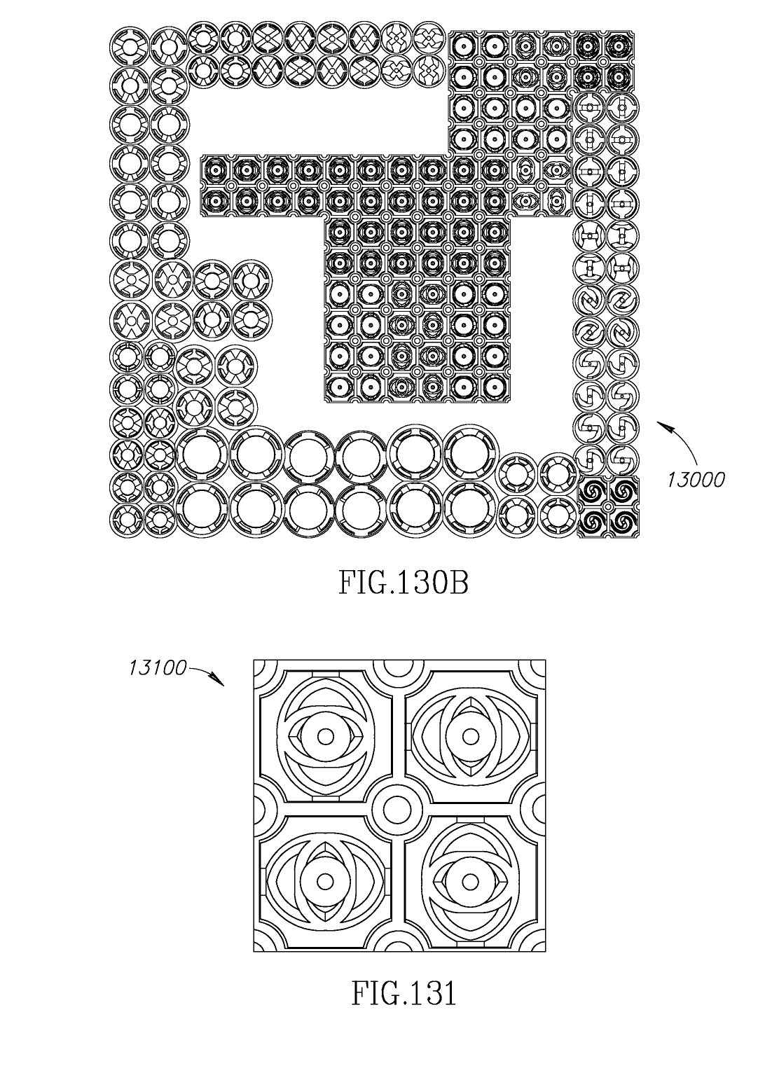

Reference is also made to FIG. 131, which is a schematic illustration of a set of springs 13100 in which spring orientation is modified among springs, in accordance with some demonstrative embodiments. The modification of spring orientation (e.g., varying between 0.1 degrees to 179.9 degrees) may allow improved stability.

Some embodiments may utilize other types of member repetition, member thickness, spatial movements, pressures, rotations, pushing (e.g., in a multi-layer spring). Some embodiments may utilize various shapes, ranging from a circle or an oval shape to a polygon; as well as springs formed by injection molding which may have unique shapes and structures, for example, “spider”-like spring, “wedding-cake” like spring, “basketball hoop” like spring, or the like. In some embodiments, different springs may have: different number of layers or levels; various heights of each layer; various thickness of each component; number of legs; width of each leg; method of connection among legs or among layers; different reaction to centralized pressure and to sideway pressure; different ejection properties or abilities; thickness of rings; distance among legs within a layer; inclusion or exclusion of a common ring to tie together multiple legs (e.g., inclusion of a common ring in an upper layer, and exclusion of a common ring in a lower layer; or vice versa); utilization of torsion and/or bending, based on elasticity properties of the material; controlled collision or touching or partial spatial penetration among adjacent springs due to application of pressure; or various other properties.

The terms “plurality” or “a plurality” as used herein include, for example, “multiple” or “two or more”. For example, “a plurality of items” includes two or more items.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments have been illustrated and described herein, many modifications, substitutions, changes, and equivalents may occur to those skilled in the art. Accordingly, the following claims are intended to cover all such modifications, substitutions, changes, and equivalents.

1-50. (canceled)

51. An apparatus comprising:
a spring formed by injected molding of one or more raw plastic materials,
wherein the spring is generally shaped as a chopped frustum, and wherein the spring is able to eject from a manufacturing mold by utilizing an elasticity of the spring.

52. The apparatus of claim 51, wherein the spring comprises two or more injected threads spiraling from a common injected base upwardly towards a spring apex,
wherein the one or more injected threads have a cross-section selected from the group consisting of:
“L”-shaped cross-section;
“U”-shaped cross section;
“V”-shaped cross section.

53. The apparatus of claim 51, wherein the spring comprises a single injected thread spiraling from a circular injected base upwardly towards a circular spring apex, wherein the spring is at least partially nestable within another, substantially identical, spring.

54. The apparatus of claim 51, comprising a matrix of injected springs arranged in rows,
wherein the matrix of injected springs comprises a padding for a furniture article.

55. A padding comprising:
an array of flexible members formed of injection molding of one or more raw plastic materials, wherein the flexible members comprise flexible injected prism-shaped protrusions rising from a common flexible injected tray; and
stabilizing members connected to at least some of the flexible members, to reduce angular disposition of said flexible members upon application of pressure thereon.

56. The padding of claim 55, wherein the stabilizing members comprise at least one of:
(a) injected molding members supporting the flexible members;
(b) another set of flexible members supporting said flexible members;
(c) another set of flexible members attached back-to-back with said flexible members, facing opposite directions.

57. The padding of claim 55, wherein the flexible members comprise flexible injected curve-shaped members forming a sinusoidal pattern,
wherein at least two adjacent flexible members are interconnected by a flexible injected joint.

58. The padding of claim 55, comprising another array of flexible members facing and interlocking said array of flexible members.

59. The padding of claim 55, further comprising:
a padding layer comprising one or more flexible threads of injected raw plastic material, wherein the one or more threads are intertwined.

60. The padding of claim 55, comprising:
a flexible cover;
a rigid base; and
a locking element to lock said array between the flexible cover and the rigid base;
wherein the flexible cover is formed by injection molding of one or more raw plastic materials,
wherein the flexible cover is fibrous and comprises fibers formed by injection molding of one or more raw plastic materials.

61. A method comprising:
injection molding of a raw plastic material, to produce an article comprising a fabric-like surface and a plurality of flexible pins protruding therefrom;
wherein the injection molding is performed by utilizing a generally cylindrical mold having a channel engraved on its external surface, into said channel the raw plastic material is injected;
wherein the integrated article is able to eject from the mold, at least partially, by utilizing an elasticity property of said article to temporarily expend and overcome one or more undercuts of the mold;
connecting the apexes of said pins to a common element, to eliminate side movement of said pins upon application of pressure thereon,
wherein the common element comprises an element selected from the group consisting of: a perforated foil; a net; a perforated surface.

62. A method comprising:
injection molding of a raw plastic material to produce a padding article which comprises a relatively flexible cover portion, an intermediary layer able to absorb pressure, and a relatively rigid base portion;

63. The method of claim 62, wherein the injection molding comprises a single injection molding process.

64. The method of claim 62, wherein the injection molding comprises a double injection molding process, which comprises:
(a) injecting the base portion;
(b) placing the intermediary layer on the base portion;
(c) compressing the intermediary layer;
(d) injecting the cover portion together with welding edges of the padding article;
(e) allowing the intermediary layer, trapped between the base portion welded to the cover portion, to gradually decompressed.

65. The method of claim 64, comprising, after step (b) and before step (c):
masking the intermediary layer to block entry of injected plastic material into cavities of the intermediary layer,
wherein the intermediary layer comprises Polyurethane foam.

66. The method of claim 62, comprising:
producing by injection molding a surface having fabric-like texture which is fibrous.

67. The method of claim 62, comprising:
producing by injection molding a surface having fabric-like texture with a fabric-like imprinted item thereon.

68. A method comprising:
producing a padded article in an injection molding process which utilizes Polyurethane foam, wherein a welding line of the padded article is produced concurrently with the injection molding and by the injection molding;

69. The method of claim 68, wherein the injection molding process is to produce an inwardly-folding edge of the padded article.
